(19) United States
(12) Patent Application Publication
(10) Pub. No.: US 2012/0064480 A1
(43) Pub. Date: Mar. 15, 2012

(54) Oral Irrigation and/or Brushing Devices and/or Methods

(76) Inventor: Kenneth J. Hegemann, Escondido, CA (US)

(21) Appl. No.: 13/232,964

(22) Filed: Sep. 14, 2011

Related U.S. Application Data
(63) Continuation-in-part of application No. 13/176,630, filed on Jul. 5, 2011.
Application No. 13/176,630 is a continuation of application No. 11/453,307, filed on Jun. 13, 2006, now Pat. No. 7,972,136.
Application No. 11/453,307 is a continuation of application No. 10/357,564, filed on Feb. 5, 2003, now Pat. No. 7,059,853.
(60) Provisional application No. 60/409,760, filed on Sep. 10, 2002.
(60) Provisional application No. 60/403,915, filed on Aug. 15, 2002.
(60) Provisional application No. 60/385,366, filed on Jun. 3, 2002.

(51) Int. Cl. A61C 17/02; A46B 9/04; A61C 17/00

(52) U.S. Cl. 433/82; 433/216; 15/167.1

(57) ABSTRACT

An integrated or combined oral care device having an oral cleaning device including a handle, and one or more cleaning head assemblies and a fluid irrigation assembly attached or attachable to the oral cleaning device.

### CROSS-REFERENCE TO RELATED APPLICATIONS

This application is a continuation-in-part of co-pending application U.S. application Ser. No. 13/176,630, filed Jul. 5, 2011, which is a continuation of co-pending U.S. application Ser. No. 11/453,307, filed on Jun. 13, 2006, which issued as U.S. Pat. No. 7,972,136 on Jul. 5, 2011, which is a continuation of co-pending U.S. application Ser. No. 10/357,564, filed on Feb. 5, 2003, which issued as U.S. Pat. No. 7,059,853 on Jun. 13, 2006 and is a non-provisional of Provisional Application Nos. 60/409,760, filed on Sep. 10, 2002; of 60/403,915, filed on Aug. 15, 2002; and of 60/385,366, filed on Jun. 3, 2002 each of which are hereby incorporated by reference for all that they disclose, teach and suggest.

### INTRODUCTION

The present developments relate generally to oral irrigation devices and/or power tooth and gum cleansing devices and/or power toothbrushes and more particularly, in some implementations, to a pressure pump for an oral irrigation device and/or to a method of using the same, and in other implementations, to a system for moving one or more cleaning (irrigation and/or brushing) heads during use. The general purpose may include providing one or more pressurized water streams that may pulsate and may be adaptable to having injected therein water and/or dentifrice, flavoring, or medicine or the like. Another purpose together with or in lieu of pulsatile action may be providing reciprocal cleaning head movement in the user's mouth. These implementations may be particularly useful with a toothbrush or like arrangement which assists in guiding the cleansing heads within the user's oral cavity to aid in proper cleansing and stimulation to enhance healthy teeth and gums.

### BACKGROUND

Over the years, a diverse array of manual and automated tooth cleansing devices have been developed including electric toothbrushes, oral irrigators and flossers and many have enjoyed widespread commercial success. These have been generally directed at the important basic need to clean the teeth, gums and certain parts or the whole of the mouth area.

Nonetheless, many deficiencies remain with various of these devices, and for many people and in many situations, they are inadequate or unsuitable. Manual brushes, for instance, require the user to have a minimum, moderate degree of manual dexterity and the ability to firmly grasp the brush while moving it against the dental surfaces. The tiresomeness, difficulty and repetitiveness of manual brushing leads many to do less than is necessary; as was reported in Consumer Reports, September 1992, page 611: “People tend to brush for less than a minute. You need two or three minutes of manual brushing to do the job right.” And thus, some teeth and gum surfaces may receive inadequate brushing or are missed altogether.

An intriguing note is that some statistics show that nearly 75% of the adult population suffers from some form of gum disease, which in turn can lead to tooth loss. The primary cause of gum disease may very well be inadequate gum brushing and massage. This conclusion may be supported in part by the fact that dental professionals (dentists and hygienists) are rarely affected by gum disease and/or tooth loss. Interestingly, they use the same toothbrushes as used by the general population. The reason for this vast difference in oral health can be attributed to the fact that dental professionals (as part of their training) are taught exactly how to brush teeth and gums and most importantly, they comply with these cleaning measures every day. A logical conclusion is that gum disease is likely caused by human error. Additionally, flossing can be mentioned in noting that it has often been found as a cumbersome, time demanding and sometimes painful way to remedy some of the deficiencies found in the other methods, such as brushing, particularly when attempting to reach areas between the teeth.

Conventional electric or “power” toothbrushes, while requiring less physical effort on the part of the user, still often require human skill and dexterity to achieve effective results. These are often more complicated than manual brushes and are more expensive and require more time in maintenance. Moreover, brushing too vigorously with electric brushes can irritate the gums or cause them to bleed excessively, possibly injuring the gums or eventually causing them to recede. Furthermore, bleeding can spread oral bacteria into the bloodstream, a risk for users with various health conditions including heart and immunity problems. Because of these problems and/or similar drawbacks, children must often be supervised when using electric toothbrushes, and many children probably should not use them at all.

Oral irrigators (often using pulsating jets of pressurized water) and oral syringes (often non-pulsating jets of pressurized water), while of benefit to many users, including those with crowns, implants, braces, or non-removable bridgework (for whom flossing or brushing may be impractical or not possible), can also be ineffective if the water jet is not correctly directed to the area where it may most be needed for oral irrigation and stimulation. This may be a particular problem for an unsuspecting user if there are higher pressures involved which can exacerbate gum or tooth ill health.

Power toothbrushes and oral irrigation devices have been developed in many forms in the art. As a primary example, the WaterPik® oral irrigation device (from WaterPik Technologies, Inc., formerly Teledyne WaterPik, Inc., Fort Collins, Colo., USA) uses a piston pump which generates a high frequency (from about 1000 to about 3000 pulses/minute) water jet. Such a high frequency pulse can be uncomfortable to the user. The B. Braun Company (Braun AG, Frankfurt, Germany) has also developed some successful commercial oral irrigation and/or toothbrush devices. Similarly, sonic or ultrasonic technologies have also been developed and implemented in the art of oral care. Examples are available from the Sonicare Company, also known as Philips Oral Healthcare, Inc., Snoqualmie, Wash., USA (a subsidiary of Royal Philips Electronics, N.V. of the Netherlands) or the Oral B Laboratories company of Boston Mass., USA (the Braun and Oral-B brands and companies being subsidiaries of the Gillette Co., Boston Mass., USA).

A major shortcoming of many conventional manual and electric toothbrushes, oral irrigators and flossing is that they may be dependent on accurate human manipulation in order to achieve effective disease preventing results. The high incidence of gum disease in the general population provides convincing evidence that present means of tooth and gum brushing may be inadequate for most users simply because they depend on human skill. The present developments substantially eliminate the need for human skill. Many prior means and methods are not simply capable of effective operation; hygienic, comfortable, and/or error-free use; easy and inexpensive maintenance; with a cost-effective purchase price, for most people in most situations. Thus, there is a need for improved devices and the present developments fill these needs by substantially overcoming one or more of the foregoing or other deficiencies.

The present developments are presented as remedies of one or more of the above-mentioned or other defects of past devices and/or methods with the provision of one or a variety of dental care devices which provide safe, fast, comfortable and effective means of dental care for substantially eliminating gum disease for people of all ages, including those with implants, crowns, braces and bridgework, as well as people of limited dexterity, or other handicaps.

### SUMMARY

The present developments provide dental cleaning appliances for cleaning teeth and gums having one or more jet nozzles on or forming one or more cleaning heads which is/are insertable into the user's mouth for the cleaning operation, the cleansing head or heads being attached to a handle, which is attachable via one or more fluid tubing lengths to a power pump module which activates either one or more jet nozzles by pumping water thereto. The tubes provide a connection from a fluid source to and/or through the pump and thence to the handle and nozzles. In yet another implementation, the present system can provide for simultaneously delivering a controllable supply of customized dentifrice and/or mouthwash and/or medicine as may be desired by the cleansing operation for any user's unique situation.

One or more peristaltic pumps may be used in one or more implementations herein and may be rotated at one or more of various discrete desirable speeds and thereby generate more desirable, in some instances, pulse frequencies (for example, at speeds which can generate approximately 250 pulses per minute) than a piston pump. Moreover, stacked peristaltic pumps with alternating rotors may be implemented to provide alternating water pressures, and alternating water jets. Still furthermore, a third stage peristaltic rotor can be stacked therewith to provide the injection pressure for delivering flavors, dentifrices, medicines and/or the like to the water stream or streams.

Thus disclosed herein are means, structures and methods for pressurizing water for an oral irrigation device which in some implementations involve one or more pressurized water jets, along with an optional means of or structure for injecting concentrated dentifrice and/or flavors and/or medicine into the pressurized water stream. As mentioned, a general purpose may be in providing a water stream to the oral feature to be cleaned that in some implementations may be disposed to pulsate and/or may be adaptable to have injected therein a dentifrice, flavoring, or medicine into the pressurized stream of water. In one or more implementations, this may be accomplished through use of a peristaltic pump or pumps to generate the pressure, flow, and desired pulsating action of one or more water jets. It may also include using a dentifrice peristaltic pump to meter in the correct amount of dentifrice, flavor, or medicine.

In a more detailed description of some of the many preferred options, a present cleansing device may have one or two water jet nozzles for the top teeth and/or, in a further implementation, one or two more jet nozzles for the bottom teeth which may provide definite discrete pulses for intermittently jetting water between teeth. In some implementations, this may include providing a first pulse in one direction, e.g., inwardly toward the tongue, and a second jet pulsating in a second, generally opposed direction, e.g., outwardly toward the cheek, and so on repetitively so that the jet action may remove matter from between teeth.

In many cases, a one stage peristaltic pump may be used. In others, a two stage peristaltic pump, in some implementations involving stacked peristaltic pumps with alternating rotors as yet unknown to oral hygiene devices, may be used to provide alternating intermittent pulsing of water jets. In some implementations, each peristaltic pump stage may have only a single roller so that each revolution of the pump may generate respective pulses, one for inward pressure and one pulse for outward pressure. The respective singular rollers may then also provide relative timing so that one pulse follows the other. This sort of pump may then provide pulsating water jets that are highly effective at removing debris yet remaining very comfortable to the user. As mentioned, some implementations of the present developments may involve “stacking” two such peristaltic water pumps in such a manner as to get the automatic alternating pulse action and have this provided in a relatively small package. Also, by stacking the pumps, this may assure a sort of a preferred pulse “timing” since the two pumps can be run on a common shaft and may then be powered by a common motor. Each pump in the “stack” can have a single roller. The respective singular rollers of the two pumps can then be positioned offset 180 degrees in relation to each other. When the common motor shaft makes one-half of a revolution, the first pump delivers one pulse of water to one of the delivery tubes. When the motor completes the other one-half revolution, the other pump delivers a pulse of water. This is one way in which the pulses can be “timed.” It should also be understood that the reason the water may desirably be delivered in pulses from each pump is that a single roller on the tube of each pump is in contact with the tube only during one-half of a complete revolution since the tube may be contained in a half circle raceway, not necessarily a complete circle. When the roller is not in contact with the tube, there can be a moment of water relaxation (no pressure) and as soon as the roller comes in contact with the tube, pressure may then be applied. Pressure can be a result of resistance, and resistance may be obtained by controlling the resilience of the tubing and by sizing the water jet nozzles in the cleansing head correctly (small enough to create enough resistance to obtain the desired water pressure).

Moreover, together with either the one stage or with the pulsing action provided by a two stage pump may be a novel means of automatically positioning the water jets advantageously or correctly in the oral cavity adjacent the teeth. This may take the form of one or more brush heads or other devices such as a bite block or like guide device.

Further in some other implementations, it may also be desirable to provide a structure and/or method of injecting flavor concentrate, dentifrice, or the like, into the water stream. To provide such optional flavor or dentifrice injection, a second or a third pump may be used simultaneously with the other water pump or two stage pumping, to inject this other substance (flavor, dentifrice, medicine or the like) into the water stream or streams. This sort of injection pump may deliver concentrate at a much lower rate than the water pump or pumps. It has been found that a favorable ratio may be about 100 to 1 (water to concentrate).

In still more detail of some other implementations hereof, an attached or attachable reservoir or a detached reservoir cup can be used to provide water for feeding to the pump. The water can be sucked to the pump, through a conduit. In some two stage implementations, this inlet conduit may then be split at a Y-connection (or the like) to feed the two discrete stages of the pump. Then, in the two stage pump examples, when the pump rotates, a one-half revolution may deliver one pulse or jet of water to the water jet/nozzle device pointing in a first direction (e.g., inwardly); and then a further one-half revolution of the two stage pump may then deliver another single pulse or jet of water to a second jet/nozzle device which is pointing in a second direction (e.g., outwardly). Then, with further rotations of the pump heads, this alternating intermittent pulsing can continue, first one jet in one direction, then a second jet in the second direction, and so on, as introduced above. The first and second directions may be generally opposed to each other, however, they need not be directly opposed. Rather, even if one jet is directed generally inwardly, and the other generally outwardly, the two corresponding jets may also be relatively angularly disposed (up or down or laterally or both) and thus not be directly opposed to each other.

The cleansing handle may include a cleansing head which may have one, two or more water jets, and in some implementations includes one or two or more jets fed by one or two or more discrete tubes and in still further implementations may include four or perhaps even more water jets that may be fed primarily by two tubes, which may be split into four water tubes. In the four tube example, they may receive water from two supply tubes that connect the power handle to the pump module. When one of the two tubes receives a pulse of water from the two stage pump, it can be delivered up to the handle where it would be split into two of the water tubes that feed two of the water jet nozzles. These two jets can then substantially simultaneously spray water from the one side, e.g., the outside (cheek side) toward the inside (tongue side). When the other tube receives a pulse of water from the two stage pump, it can be delivered up to the handle where it may be split into the other two water tubes to feed the other two water jet nozzles. These other two jets can then substantially simultaneously spray water from the other side, e.g., inside (tongue side) toward the outside (cheek side). There may be a very definitive pulse factor involved that provides first a pulse of water from the outside, then a pulse from the inside. It has been found that between about 100 and about 500 pulses, and in some implementations approximately 250 pulses per minute may provide the most effective results. The alternating pulse (out-to-in then in-to-out) etc. can be very desirable because in the alternative where the pulses may be at the same time, debris could get trapped between the coinciding pulses between the teeth essentially at the mid point between the teeth. Alternating pulses allows for the possibility of each pulse of water to flush debris completely away since the water stream may be allowed to go all the way through the tooth space before the opposing pulse of water squirts in the opposite direction. As mentioned, to get two streams of water that independently pulsate, two pumps or a two stage pump may be used. These two pumps or two stages may be located within the pump module, and as described, if “timed” accurately relative to each other they can ensure accurately alternating pulses of water.

A dentifrice injection pump may be “stacked” on the same shaft as the one or more of the water pumps or on the two stage peristaltic pump shaft to make everything compact and inexpensive but this third pump (the dentifrice injection pump) should be geared down in speed relative to the water pump or pumps or driven by a separate motor. A good reason for this may involve either the preferred much reduced rate of dentifrice injection (e.g., 100 to 1) as introduced above, and/or the more constant, less or non-pulsating injection potentially preferred for this flow. (Note, a single pulse pump may alternatively be used.) In any event, for the purpose of this specification, it could be understood as being either powered by the same motor as the water pump or pumps but with a substantial speed reduction and/or tube size reduction or both; or it could simply be powered with a discrete motor, whether or not or even if it may be made to reside on and/or revolve about the same axle.

Peristaltic pump advantages may include a complete flow through system, through which the flowing liquid does not come into contact with any moving parts, and if there is any contamination it flows right through the tube. Moreover, peristaltic pumps may provide for less required maintenance than a piston pump, with fewer moving parts, and less chance of hard water deposits to clog the tube.

In one implementation the cleansing head on/in which the nozzles may be disposed may further include one or more brushing heads and one or more brushing arms, the one or more brushing heads being reciprocable in some implementations, and also being disposed so as to include in other implementations a set of upper brushes and a set of lower brushes, each of said sets of upper and lower brushes being reciprocable in yet still further implementations in alternating opposing disposition to each other. Such brush heads could be used to definitively establish the position of the nozzles in the user's mouth and maintain this position so that it effectively directs the nozzles to jet the water directly at the gum line (or elsewhere, if desired) as may be most appropriate of cleaning and improving oral health. Similarly, a guide member or members such as one or more bite blocks could be used in addition to or in lieu of brush heads to align the nozzles to appropriately direct the water jets in the user's mouth.

In some further implementations the cleansing head or heads on/in which the nozzles may be disposed may further be movable, the one or more cleansing heads being reciprocable in some implementations. Moreover, the cleansing heads may include one or more brushing heads and one or more brushing arms, the one or more brushing heads being reciprocable in some implementations and in some being reciprocable with or counter the nozzle heads. These may also be disposed so as to include in some other implementations a set of upper brushes and a set of lower brushes, each of said sets of upper and lower brushes being in some implementations reciprocable, and in yet another implementation being reciprocable in alternating opposing disposition to each other. Such brush heads could be used to definitively establish the position of the nozzles in the user's mouth and maintain this position so that it effectively directs the nozzles to jet the water directly at the gum line (or elsewhere, if desired) as may be most appropriate of cleaning and improving oral health. Similarly, a guide member or members such as one or more bite blocks could be used in addition to or in lieu of brush heads to align the nozzles to appropriately direct the water jets in the user's mouth.

Accordingly, an aspect of the present developments is to provide a new and improved oral cleaning device including one or more jet nozzles which may be positioned by a cleansing head and spray assembly in a substantially pre-selected position and a pump module to induce water jetting for cleaning and massaging of the user's teeth and gums. Another aspect of the present developments may be to provide a new and improved oral cleaning device including one or more jet nozzles which are disposed on or adjacent a brush head assembly such that the nozzles may be accurately positioned by or with assistance of the brush head assembly in a pre-selected disposition and a pump module to provide for accurate brushing, cleaning and massaging of the user's teeth and gums.

Still another aspect of the present developments may be to provide a new and improved oral cleaning device including one or more jet nozzles which are disposed in adjacency with a guide or bite block assembly which provide assistance in accurately positioning the nozzles in a pre-selected disposition to induce accurate cleaning and massaging of the user's teeth and gums.

Another aspect of the present developments may be to provide a new and improved device in which the parameters of a user's brushing needs are substantially automatically accounted for any user such that jet nozzles selectively transmit water through the cleansing head to activate the tooth and gum cleansing process in a water jet pattern (direction and angle) meeting the needs of any user while substantially eliminating human error.

And yet another aspect of the present developments may be to provide a new and improved device in which one or more jet nozzles may be moved such that jet nozzles selectively transmit water through the cleansing head to activate the tooth and gum cleansing process in a moving water jet pattern (direction and angle) meeting the needs of any user while substantially eliminating human error.

Yet another aspect may be the provision of a peristaltic pump unit having at least one roller pump to provide pulsating water jet action for cleaning and massaging a user's teeth and gums.

Yet still another aspect may be the provision of a peristaltic pump unit having at least two roller pumps to provide alternating pulsating water jet action for cleaning and massaging a user's teeth and gums.

Yet still one further aspect may be the provision of a peristaltic pump unit having at least one roller pump to provide injection of a dentifrice, flavoring medicine or the like into a water stream pumped to a user's mouth for cleaning and massaging a user's teeth and gums.

A yet still further aspect may be the provision of an piston pump unit having at least one and in another implementation two chambers for receiving a fluid to be pumped to provide pulsating water jet action for cleaning and massaging a user's teeth and gums.

A still further aspect of the present developments may be the provision of a new and unique oral cleaning device which enables even the physically disabled to assure proper hygiene within his/her oral cavity including teeth, palates, gums, tongue and cheeks once the cleansing head is properly installed without further need of cumbersome hand manipulation.

These and still further aspects as shall hereinafter appear may be readily fulfilled by the present developments in one or more remarkably unexpected manners as will be readily discerned from the following detailed description of exemplary implementations thereof especially when read in conjunction with the accompanying drawings in which like parts bear like numerals throughout the several views.

### BRIEF DESCRIPTION OF THE DRAWINGS

In the drawings:

FIG. 1 is an isometric schematic view of an oral hygiene device according to the present developments;

FIG. 2A is a plan view of a cut-away portion of an oral hygiene device of the present developments;

FIG. 2B is a plan view of an alternative cut-away portion of an oral hygiene device of the present developments;

FIG. 2C is an elevational view of a cut-away portion of an oral hygiene device of the present developments;

FIG. 2D is another elevational view of a cut-away portion of an oral hygiene device of the present developments;

FIG. 3 is an isometric view of an alternative oral hygiene device also according to the present developments;

FIG. 4 is an isometric view of yet another alternative oral hygiene device also according to the present developments;

FIG. 5 is an isometric view of still one further alternative oral hygiene device like that in FIG. 4 also according to the present developments;

FIG. 6 is an enlarged isometric view of a pump module of the oral hygiene devices of FIGS. 4 and 5;

FIG. 7 is an isometric view of yet another alternative oral hygiene device also according to the present developments;

FIG. 8 is an isometric view of an alternative oral hygiene device like that in FIG. 7 also according to the present developments;

FIG. 9 is a schematic view of a pump alternative which may be used with the oral hygiene devices hereof;

FIG. 10 is an isometric schematic view of an alternative oral hygiene device according to the present developments;

FIG. 11 is an isometric schematic view of yet another oral hygiene device according to the present developments;

FIG. 12A is a plan view of a cut-away portion of an oral hygiene device of the present developments;

FIG. 12B is a plan view of a cut-away portion of an alternative oral hygiene device of the present developments;

FIG. 13A is an enlarged isometric view of a pump module of an oral hygiene device with like that in FIG. 10;

FIG. 13B is an enlarged isometric view of a pump module of an oral hygiene device like that in FIG. 11;

FIG. 14 is an isometric view of yet another alternative oral hygiene device also according to the present developments;

FIG. 15 is an isometric view of still one further alternative oral hygiene device like that in FIG. 14 also according to the present developments;

FIG. 16 is an isometric view of an alternative oral hygiene device also embodying the present developments;

FIG. 17 is a cut-away isometric view of an implementation of the present developments;

FIG. 18 is a cut-away isometric view of another implementation of the present developments;

FIG. 18A is an elevational view of some interior components of a device according to an implementation of the present developments;

FIG. 18B is an elevational view of some other interior components of a device according to an implementation of the present developments;

FIG. 19 is a plan view of a cut-away portion of an alternative oral hygiene device of the present developments;

FIG. 20 is an isometric schematic view of yet another alternative oral hygiene device also according to the present developments;

FIG. 20A is a side view of an alternative oral hygiene device like that in FIG. 20;

FIG. 21 is an isometric view of an alternative oral hygiene device like that in FIG. 20 also according to the present developments;

FIG. 22 is a schematic view of a pump alternative which may be used with the oral hygiene devices of FIGS. 20 and 21;

FIG. 23 is an isometric schematic view of an alternative oral hygiene device according to the present developments;

FIG. 24 is an enlarged broken-away isometric view of an oral hygiene device like that in FIG. 23;

FIG. 25 is an elevational view of a cut-away portion of an oral hygiene device like that in FIG. 23;

FIG. 26 is a frontal elevational view of an oral hygiene device like that in FIG. 23;

FIG. 27 is an enlarged frontal elevational view of an oral hygiene device like that in FIGS. 23 and 26;

FIG. 28 is a top plan view of a cut-away portion of an oral hygiene device like that in FIG. 23;

FIG. 29A is an enlarged broken-away side elevational view of an alternative oral hygiene device according to an implementation of the present development; and

FIG. 29B is a top plan view of a broken-away portion of an oral hygiene device like that in FIG. 29A.

FIG. 30, which includes sub-part FIGS. 30A and 30B, provides isometric views of an oral hygiene device according to the present developments;

FIG. 31, which includes sub-part FIGS. 31A and 31B, provides isometric and elevational views of an oral hygiene device according to the present developments;

FIG. 32, which includes sub-part FIGS. 32A, 32B and 32C, provides elevational and plan views of an oral hygiene device according to the present developments;

FIG. 33, which includes sub-part FIGS. 33A, 33B and 33C, provides elevational views of an oral hygiene device according to the present developments;

FIG. 34, which includes sub-part FIGS. 34A, 34B and 34C, provides isometric and elevational views of an oral hygiene device according to the present developments;

FIG. 35 is a cut-away isometric view of a component of an oral hygiene device like that in FIG. 30;

FIG. 36 is a schematic cross-sectional view of an oral hygiene device like that in FIG. 30;

FIG. 37, which includes sub-part FIGS. 37A, 37B, 37C, 37D, 37E and 37F, provide isometric and elevational views of an oral hygiene device according to the present developments;

FIG. 38, which includes sub-part FIGS. 38A, 38B, 38C, 38D, 38E, 38F and 38G, provides isometric and elevational views of portions of an oral hygiene device according to the present developments; and,

FIG. 39, which includes sub-part FIGS. 39A, 39B, 39C, 39D, and 39E, provides elevational and schematic views of portions of an oral hygiene device according to the present developments.

### DETAILED DESCRIPTION

The present developments relate in general to new and useful substantially automated oral cleaning devices comprising various unique coactive assemblages of several distinct sub-assemblies which will be herein described in some detail. More particularly, the present developments are directed to a plurality of elements which when considered as one or more ensembles, may provide comprehensive attainment and maintenance of oral cleanliness. Of these, there are several primary features; among which are alternative streaming and pulsing water jet actions which in several implementations may be peristaltically powered.

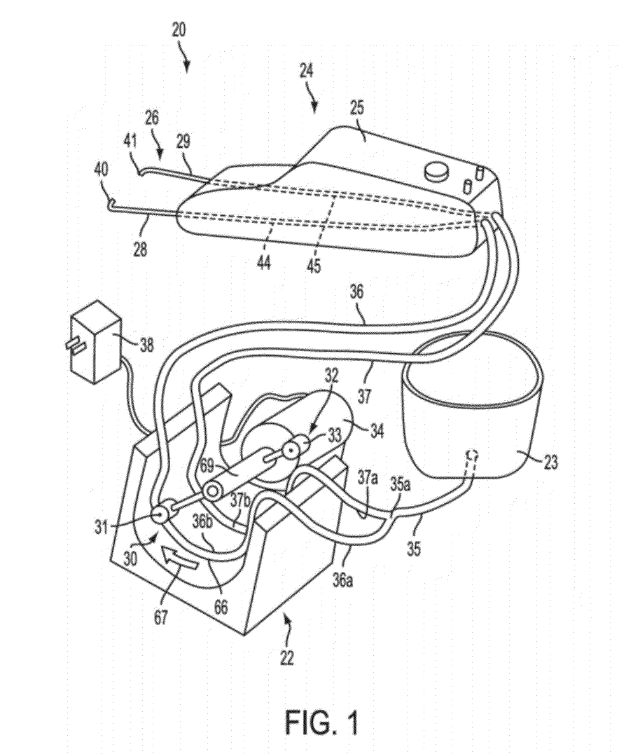

The present developments relate, as shown in the FIGS., see e.g., FIG. 1, et al., to automated tooth and gum cleaning devices 20 which include a pump module 22 and an irrigation unit 24 having a unique nozzle/spray head assembly 26 which may in one or more implementations also include an optional multiple directional brush head arrangement (herein generally referred to in any of these implementations as a “cleansing head assembly 26”), which positions the nozzles in operative disposition. The pump control module 22 then provides pumping of water for driving the jet action through the nozzle assembly 26 for cleaning and massaging of the user's teeth and gums. With the use of an optional toothbrush head assemblage, the present developments may further provide a totality of brushing, cleaning, massaging and flushing of a user's teeth and gums.

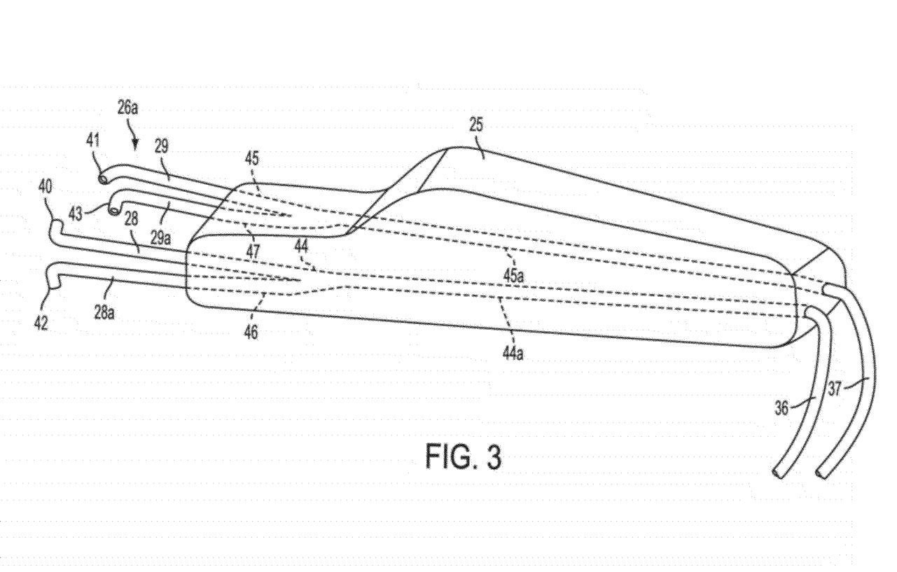

As will further appear from the below detailed description of the several sub-assemblies hereof in relation to the accompanying drawings, the device 20 may include an irrigation assembly 24 which has one or more jet arms, see e.g., arms 28, 29 in FIG. 1, emanating from the handle support 25, each such arm being capable of having one or more jet nozzles, see e.g., nozzles 40, 41, emanating therefrom. The details of the nozzle mounting and handle support assembly are shown in FIGS. 1 and 3, inter alia. The nozzle heads may be replaceable or interchangeable when and/or if desired.

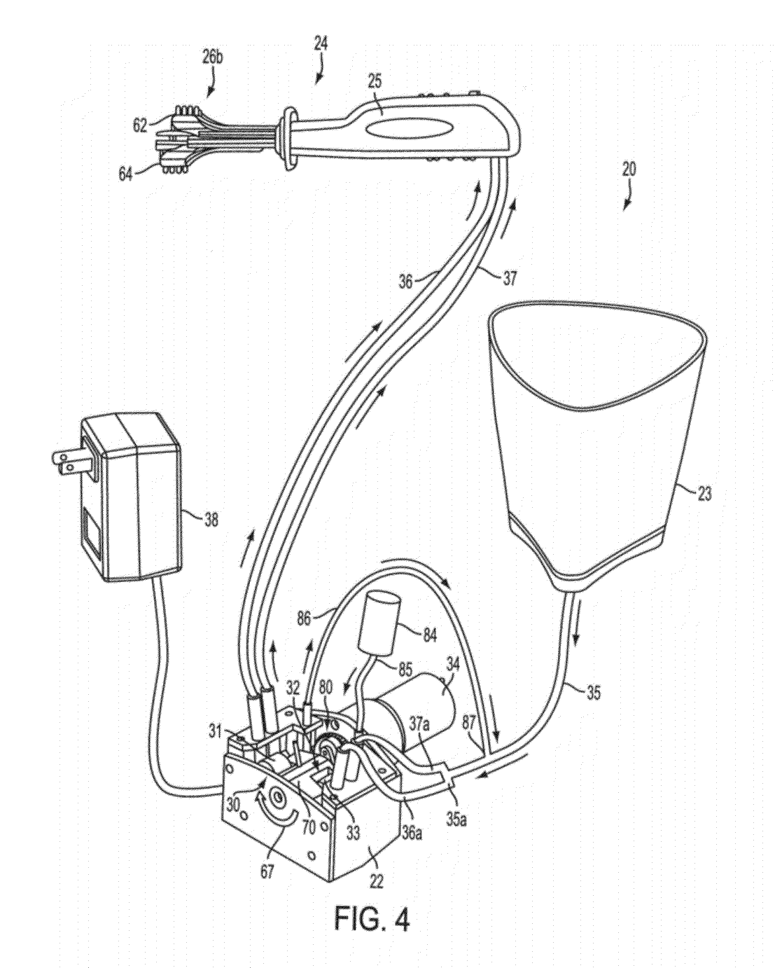

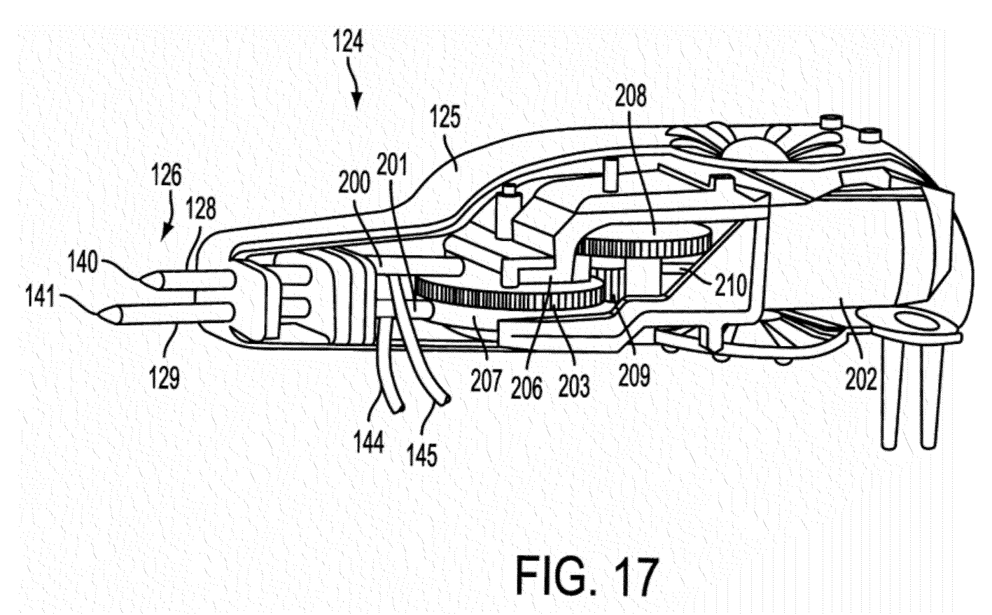

The action of the nozzle head or heads may be pulsing or merely streaming, and either of these may be delivered from a merely relatively stationary disposition of the nozzle arms and/or nozzle heads, or as is further described below in alternative implementations, the nozzle arms and/or heads may be reciprocated in and out (see e.g., FIGS. 17-20, inter alia) as for example could occur in conjunction with the brush heads of FIGS. 4, 5, 7 and 8, e.g. A controlled water stream, whether streaming or pulsing may be delivered at room or tap temperature or alternatively heated to about 90 degrees Fahrenheit, for example (heating not shown). The stream or jets may then be provided to and through the nozzles to wash away the plaque and/or debris dislodged from and between the teeth by the operation of the device as well as providing vital pulsating (or streaming) massage of the gums, particularly between the teeth. Each nozzle unit 24 may be fit for use in any user's mouth for water jet contact of every to-be-cleaned surface of the user's teeth and gums and may provide interproximal, gingival and sub-gingival contact while assuring that the jetting irrigation is not overly aggressive. If dentifrice is desired, it may be injected into and thus flow with the water stream or jets into the user's mouth (see description of FIGS. 4-6, below). In addition, or in alternative, each user may also have his/her own nozzle and/or brush heads for obvious sanitary reasons. As mentioned, and even if replaceable, the nozzle holders may further provide reciprocatable linear movement into and out of the oral cavity in order to adequately reach the rear most teeth and all of those in between.

The pulsing (or streaming) jets are provided by a pump assembly, herein also identified generally as “the pump control module 22” which may include conventional or unconventional pump hardware. When a pump, e.g., pump 30 of module 22 is activated, it provides a water jet spray to the nozzle head assembly 24 for the user. The nozzles are in some implementations disposed in preselected angular disposition to appropriately impact the teeth and gums and any gaps therebetween at the desired location, height, and width thereof.

Each device may further include a further pump (see e.g., FIGS. 4, 5 and 6, described below) for injecting a flavored dentifrice, medicine or the like into the pulsing jet water stream to enhance the effectiveness of the cleaning and health development and maintenance process.

Further, as introduced above, each device may also include one or more brush heads with the oral irrigator such that the jets may inject water through or adjacent the bristles during a brushing action. Combining brushing and oral irrigation may provide better simulation or replacement of interproximal brushing, flossing, and/or perio picking and/or using proxy brushes.

Positioning the nozzle jets properly may be provided by a guide means which might be one or more bite blocks or one or more brushes themselves that lock around the teeth and correctly position the jets. These alternatives are explored in more detail below.

These advantages and others may be compared to Sonicare and Oral-B/Braun irrigators and power toothbrushes against which devices of the present developments have been clinically tested for removal of plaque and gum tissue repair. Superior results are supported by clinical data as shown by a University of Tennessee study, the Health Science Center, 2002.

Each of the several sub-assemblies will now be described in more detail. Referring again to the drawings, an exemplary oral hygiene device utilizing features of the present developments are shown in FIG. 1 and is identified by the general reference numeral 20 therein. As introduced above, device 20 generally includes a pump module 22, an oral irrigation unit 24 with a handle 25 and an oral irrigation assembly 26. The total assemblage 20 further includes connected to the control module 22, a fluid source 23, first and second pumps 30, 32, a drive motor 34, inlet fluid conduit 35 and one or more outlet fluid conduit or conduits 36, 37 and a power source 38 with a power cord or other transmission connection 39.

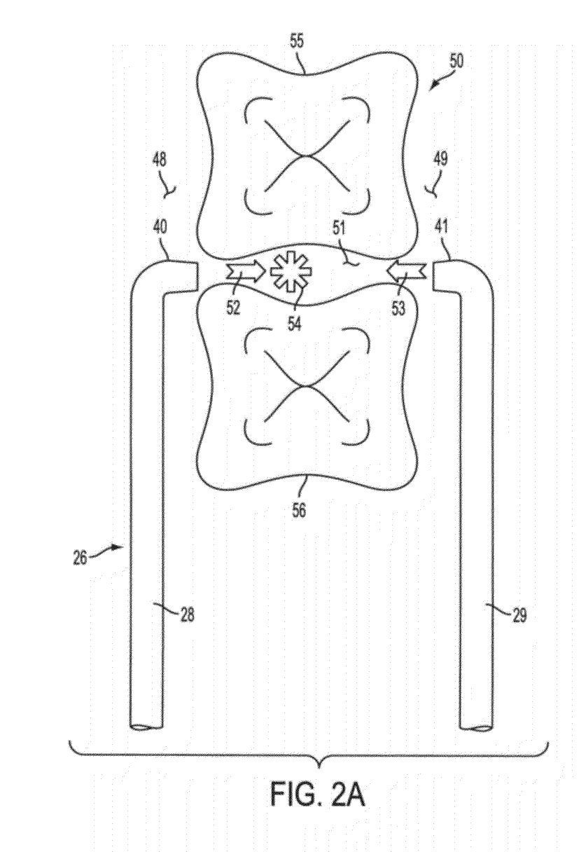

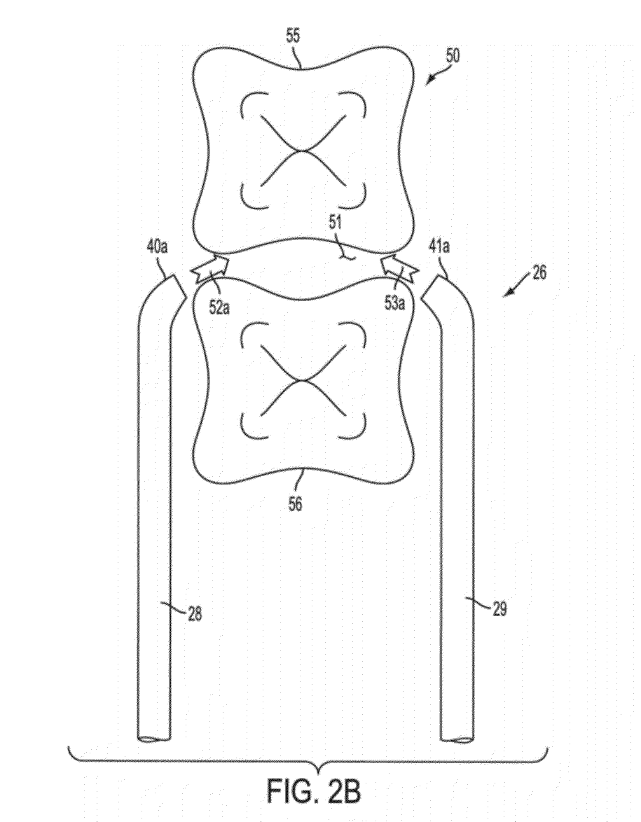

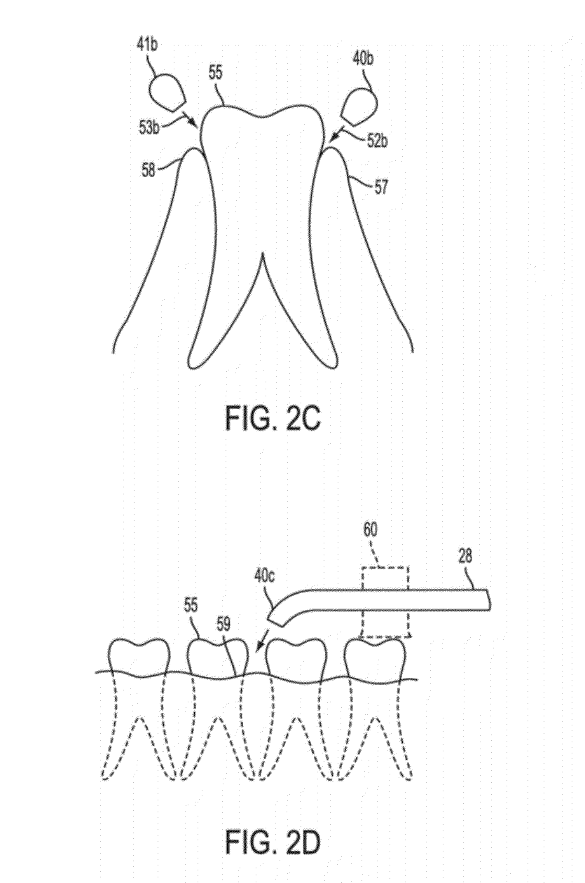

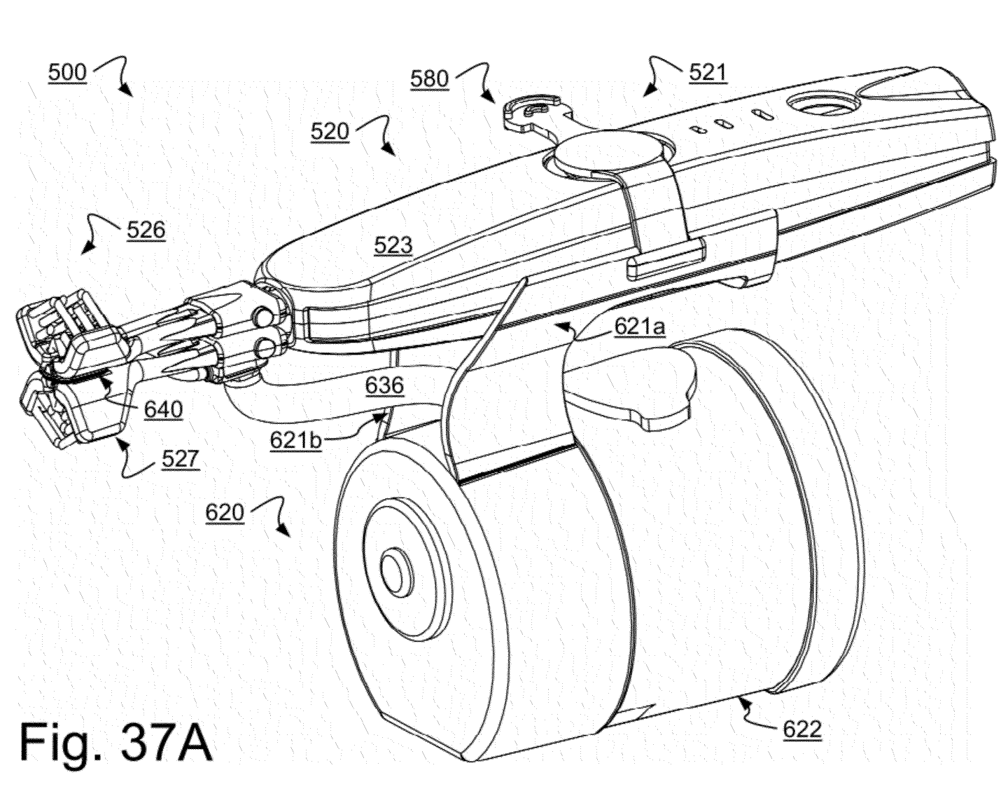

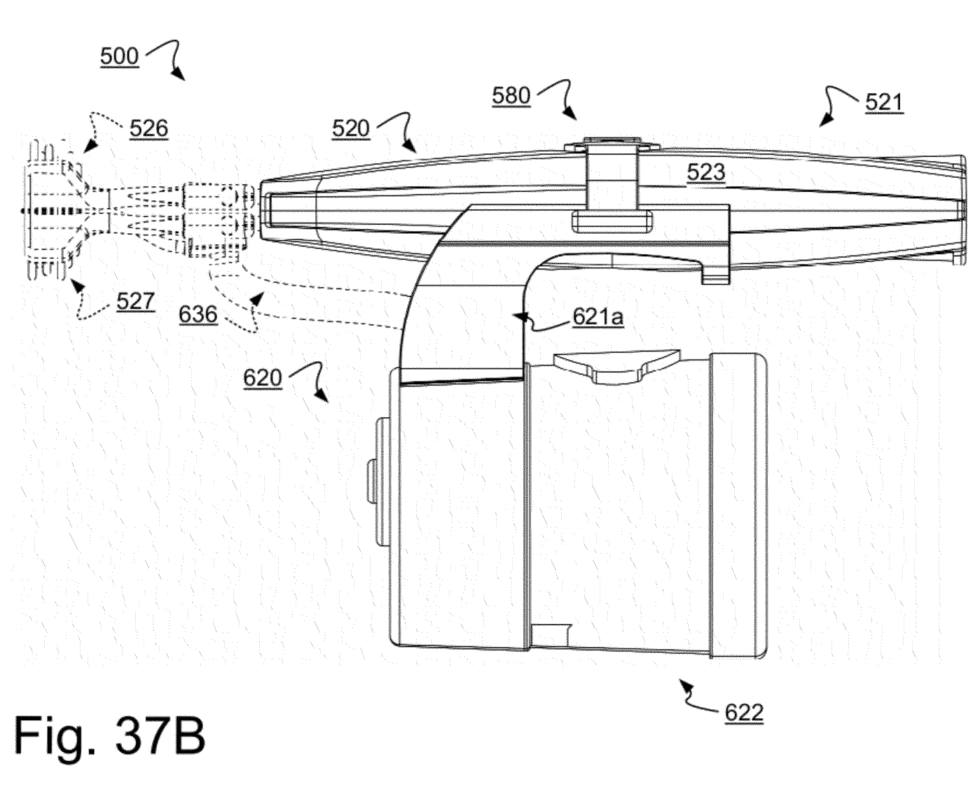

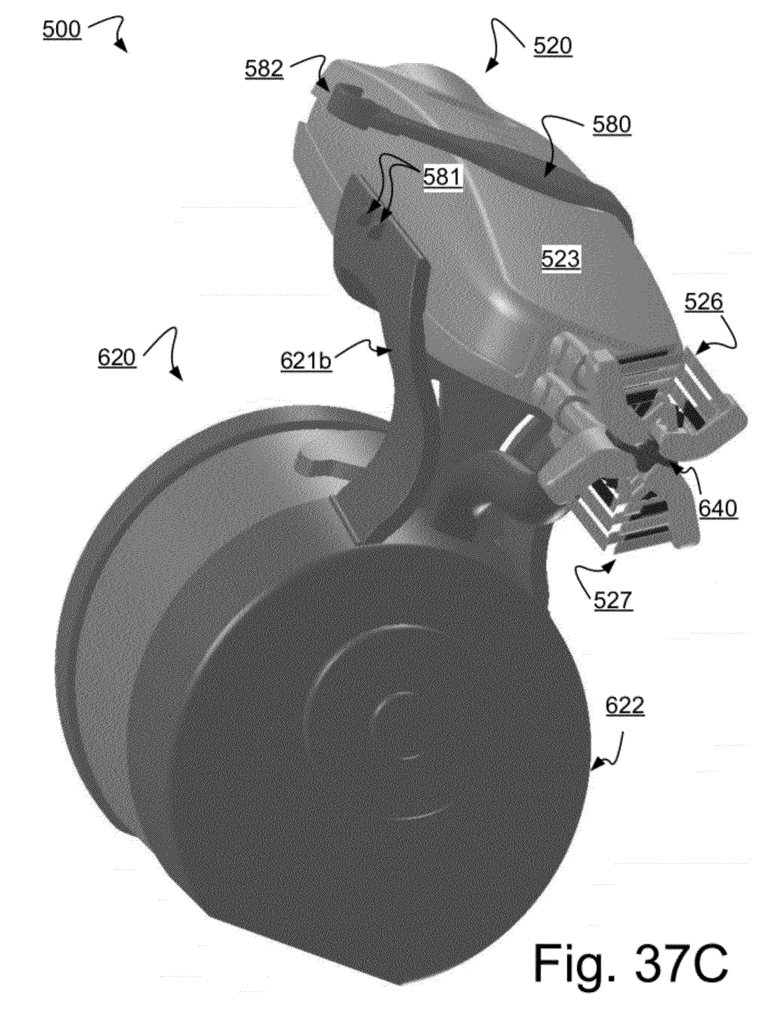

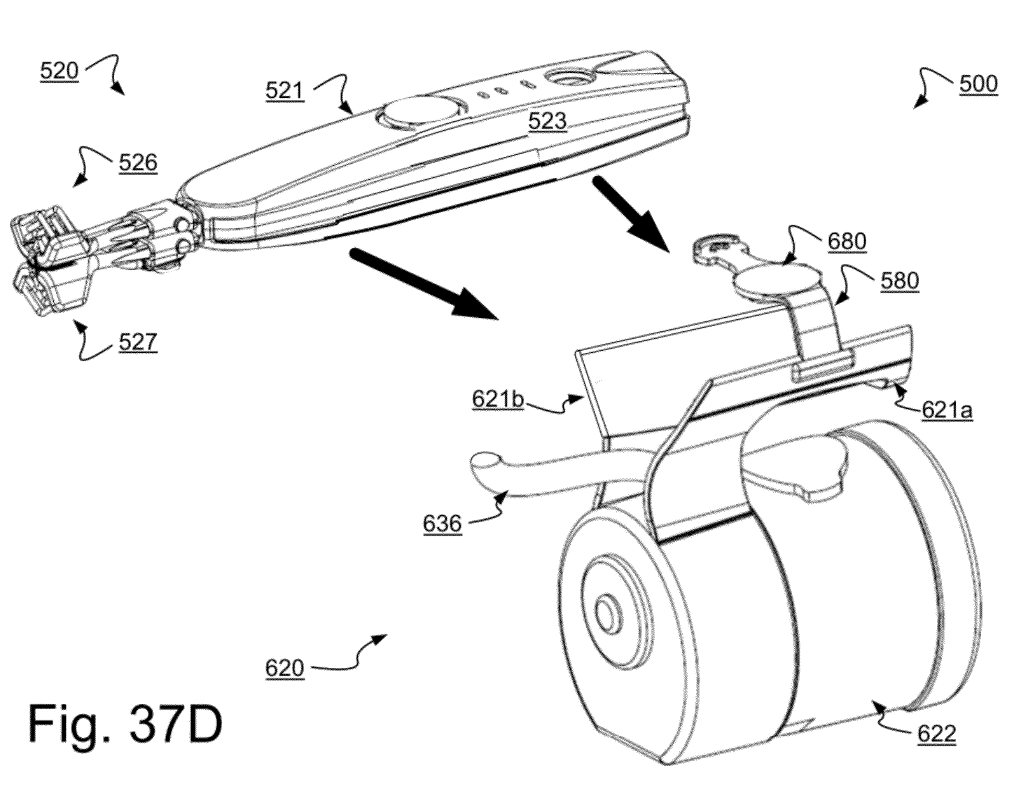

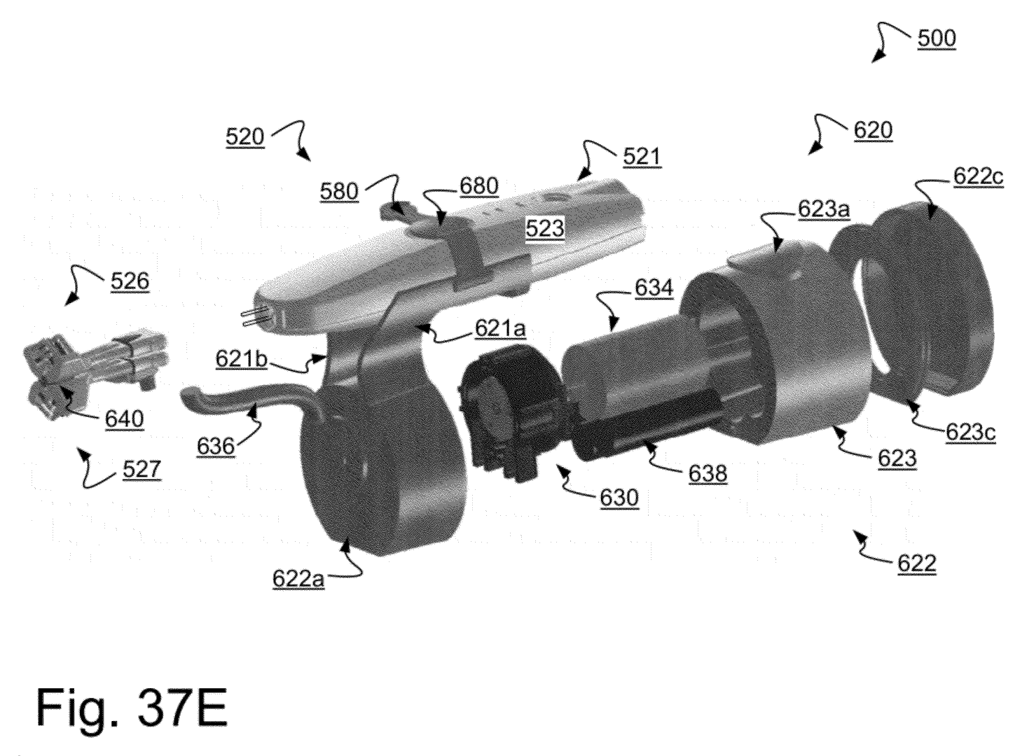

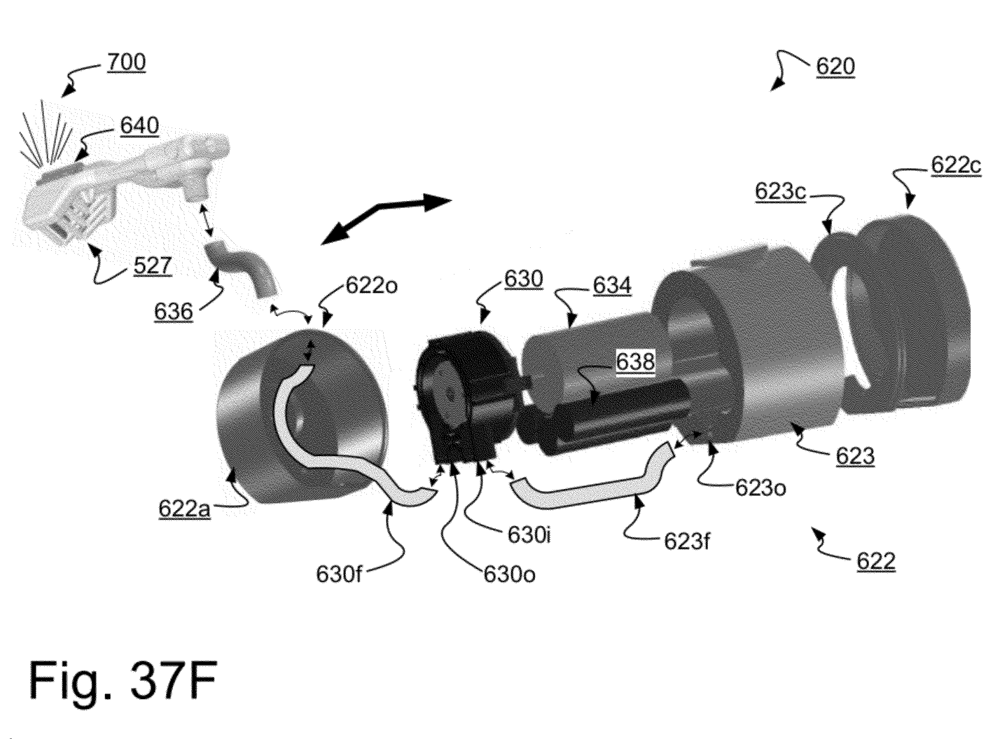

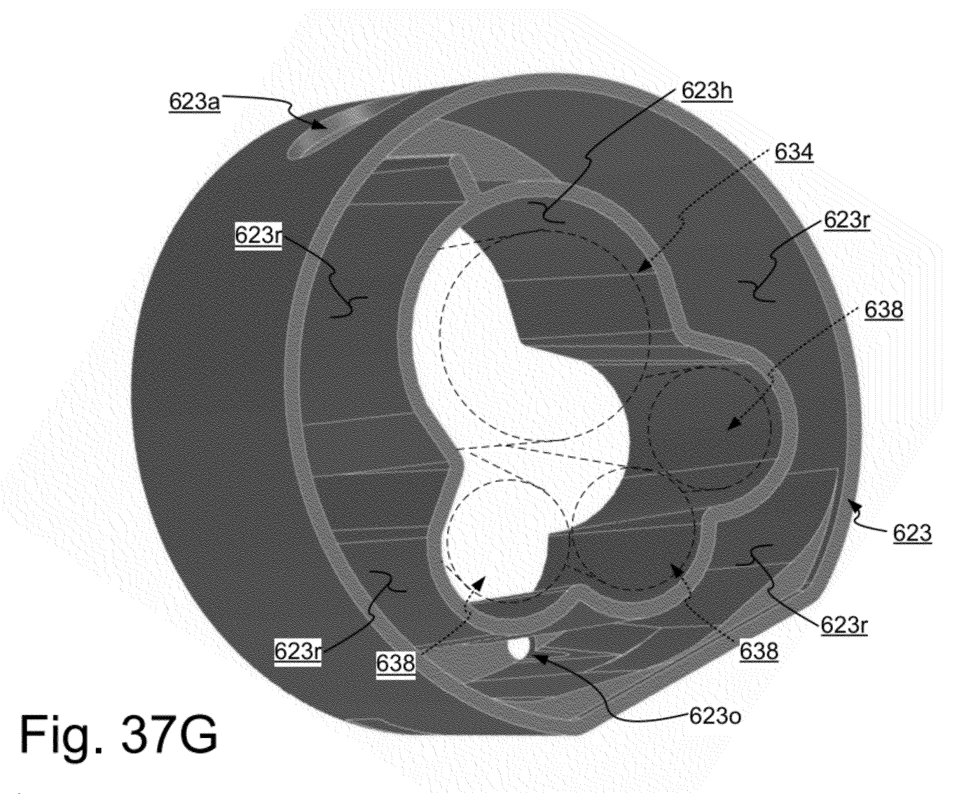

A reservoir source 23, shown generally in the implementations of FIGS. 1-22 as a cup 23 can be used to provide water for feeding to the pump or pumps, here pumps 30, 32. The water can be drained to the pump, first through a common conduit 35 which can then be split at a Y-connection 35a (or the like) to feed the two discrete stages of the pump module 22. Here, the Y-connection 35a connects to tube portions 36a, 37a which then feed into tube portions 36b, 37b which are as shown here disposed in operative position in respective pumps 30, 32 where they may be engaged by the respective rollers 31, 33 which pinch/obstruct the tubing portions 36b, 37b and then roll therealong to push fluid therein and therethrough as known in the art of peristaltic pumps generally. Then, as the two stage pumps rotate, a one-half revolution provides for delivering fluid in one tubing portion, e.g., portion 36b to water tubes 44, 45 (shown in dashed lines) disposed inside handle 25. These two tubes 44, 45 may have water supplied thereto from two supply tubes 36, 37 that connect the handle 25 to the pump module 22 that may be made to rest on the counter top or otherwise be disposed in an operative location (neither specifically shown), but see the alternative self-contained, portable implementations of FIGS. 37-39, described below. When one of the two tubes 36, 37, e.g., tube 36 receives a pulse of water from the corresponding pump, e.g., pump 30 here, of module 22, it is delivered up to the handle 25 where it is fed into the corresponding one of the water tubes, e.g., tube 44, that feeds the water jet nozzle 41 through nozzle arm 28. This jet can then spray water from one side of an array of teeth 50, e.g. the outside or cheek side 48 toward the other side, e.g., the inside or tongue side 49 of an array of teeth 50 as shown for example in FIG. 2A.

This corresponding delivery can be substantially simultaneous or alternating to first one conduit, e.g., conduit 36, and then, in a next half revolution of the pump rollers to provide for delivering fluid in and to the other tubing portion, e.g., portion 37b to the corresponding delivery conduit, e.g., conduit 37. From there, fluid is delivered to the alternate two water jet nozzles 40, 41, that are fed by the two nozzle arms 28, 29 in the handle 25 of the irrigation assembly 24.

Thus when the other extended tube, e.g., tube 37, receives a pulse of water from its corresponding pump, e.g., pump 32 of module 22, this pulse of water may be delivered up to the handle 25 where it can be delivered into the other water tube 45 in handle 25 to feed the other water jet nozzle 41 through arm 29. This jet can then spray water from the second side, e.g., the inside or tongue side 49 toward the other side, e.g., the outside or cheek side 48 relative to the array of teeth 50, see FIG. 2A.

In some implementations, the flow can be relatively continuous, and in others there can then be a very definite pulse factor involved that can provide an alternating arrangement of pulse jets, as shown in FIG. 2A, e.g., a first pulse of water 52 from the outside 48, then a second pulse 53 from the inside 49. It has been found that approximately 250 pulses per minute may provide the most effective results. The alternating pulse (out-to-in then in-to-out) etc. can be highly desirable because a non-alternating set of pulses, e.g., when the pulses are established at substantially the same time, the pulses may then strike substantially simultaneously at debris trapped in the space, e.g., space 51 between the teeth, see e.g., teeth 55, 56, which debris might then be trapped at or near the mid point. Alternating pulses, on the other hand, may allow each pulse of water to separately/independently impact the debris, see particle 54 in FIG. 2A, and thereby loosen the debris more efficiently with a back and forth action, rather than operating to maintain the debris locked in a location, and thus provide for flushing the debris more completely away. Thus also, in this first implementation, it can be seen that if timed appropriately, and after all debris is cleared therefrom, the water jet may also be allowed to go all the way through the tooth space before the opposing pulse of water squirts in the opposite direction.

In a slightly distinctive alternative, the nozzles may be disposed so as not to deliver a substantially perpendicular jet action. This is shown for example in FIG. 2B wherein the two nozzle arms 28, 29 have respective nozzles 40a, 41a which are shown delivering respective jets 52a and 53a into the space 51 between teeth 55 and 56. This angular disposition of the nozzle heads 40a, 41a and resultant jets 52a, 53a may provide a desirable jet cleaning action on the respective surfaces of the teeth with which the jets 52a, 53a may more effectively come into contact. A similar set of alternative angular jet dispositions are shown in FIGS. 2C and 2D. Two alternative nozzles 40b, 41b are shown relative to a tooth 55 whereby the respective jets 52b, 53b are shown angled slightly downward to provide a potentially desirable impact of the jets 52b, 53b with the gum line intersection of respective gums 57, 58 with tooth 55. Similarly, a further alternative angled orientation is shown in FIG. 2D wherein an alternative nozzle 40c is shown delivering a jet 52c to a gum line intersection of a tooth 55 with a gum 59. Note, any combination or none of these alternative angular dispositions may be used with the nozzles of the present developments.

In another implementation (not directly shown), the two tubes 44, 45 can be merged into one tube which can then feed one arm, e.g., arm 28 and thence one nozzle, e.g., nozzle 40, and thereby provide an alternating jet action (first from one tube 36, and then from the other tube 37) to and through one nozzle. Thus, an effective implementation using only one nozzle is available. Similarly, a single or the two peristaltic pumps could also feed through one or two feed conduits either a substantially continuous stream or pulsating jets to a single nozzle (or multiple nozzles).

As a further alternative implementation of the present developments, an alternative irrigation assembly 26a is shown in FIG. 3 including a similar handle 25 which here has four water jet nozzles 40, 41, 42, 43 that are fed by four arms 28, 28a, 29, 29a, and four water tubes 44, 45, 46, 47. These four tubes 44-47 may have water supplied thereto from two supply tubes 44a, 45a disposed in handle 25, the supply tubes 44a, 45a receiving water jets from respective conduits 36, 37 which connect the handle 25 to the pump module 22 in the same fashion as shown in FIG. 1 (though not shown in FIG. 3). When one of the two supply tubes, e.g., tube 36 receives a pulse of water from its respective pump 30 of module 22, the water jet is delivered up to the handle 25 where it first delivered to the tube 44a, and may then be split into two of the water tubes, e.g., tubes 44, 46, that feed two of the water jet nozzles 40, 42. These now split jets can then spray water from first one side, e.g. the outside (cheek side) 48 toward the other side, e.g., the inside (tongue side) 49 in the same fashion as was shown in FIGS. 2A-2C. However, here, the two jets would be delivered one to the upper set of teeth (e.g., from nozzle 40) and the other jet would be delivered to the user's lower set of teeth (e.g., from nozzle 42). These jets could thus be delivered substantially simultaneously (or alternatively, non-simultaneously, e.g., by cross connections of the inlet lines so that line 44a feeds one set of nozzles and the other line 45a feeds a discrete set such as both of the bottom sets 42, 43).

Then when the other tube, e.g., tube 37, receives a pulse of water from the pump 32 of module 22, it may be delivered up to the handle 25 where the jet first travels through tube 45a, and then may be split into the other two water tubes 45, 47, to feed the other two water jet nozzles 41, 43 via arms 29, 29a. These jets can then spray water from a first side, e.g., the inside (tongue side) 49 toward the other side, e.g., the outside (cheek side) 48, also as shown in FIGS. 2A-2C. Here also, the jets may be substantially simultaneously jetted from nozzles 41, 43 to the respective upper and lower sets of teeth, the jet from nozzle 41 to the upper teeth, e.g., and the jet from the nozzle 43 to the lower teeth.

In one alternative, either a combination of nozzles 40, 42 or a combination of nozzles 41, 43 could be used independently of the other set of nozzles to provide controlled jet action for top and bottom teeth but on only one side (inside or outside) at a time (with alternation available from the first side to the other side as desired). As above, such a singular side usage can provide a singular stream or jet action of water from a singular pump through a singular feed tube, e.g., tube 36, or as above, the two tubes 44a, 45a can be merged into one tube (not shown) which can then feed one set of arms, e.g., arms 28, 28a and thence one set of nozzles, e.g., nozzles 40, 42, and thereby provide an alternating jet action (first from one tube 36, and then from the other tube 37) to and through one set of nozzles. Thus, an effective implementation using only one side set of nozzles is available. Similarly, a single or the two peristaltic pumps could also feed through one or two feed conduits either a substantially continuous stream or pulsating jets to a single nozzle (or multiple nozzles).

One further alternative to mention which may be used with any of the herein-described alternative implementations includes a guide member or bite block 60 which is shown in FIG. 2D and which may be positioned on or adjacent any nozzle arm, such as the nozzle arm 28 shown in FIG. 2D (or any of the nozzle arms shown or described herein). The guide member or bite block 60 may used to position the respective nozzle arm or arms in a preferred pre-selected position relative to the teeth and gums so that the resulting jets are appropriately and/or most efficiently directed at the area of most preferred use, e.g., at or adjacent a gum line intersection of the tooth and gum. The guide member or bite block may take many forms, and may be attached to a nozzle arm or may be discrete therefrom. Singular bite blocks or guide members may be used for one or more nozzles, and/or these guide members or bite blocks may be disposed to rest on the crowns of the teeth (as suggested by the guide member 60 in FIG. 2D), or they may curve about and/or encase the tooth or teeth (not shown). Furthermore, they may be relatively stationary in use, or rather move from tooth to tooth with the corresponding nozzle or nozzles during ordinary operation.

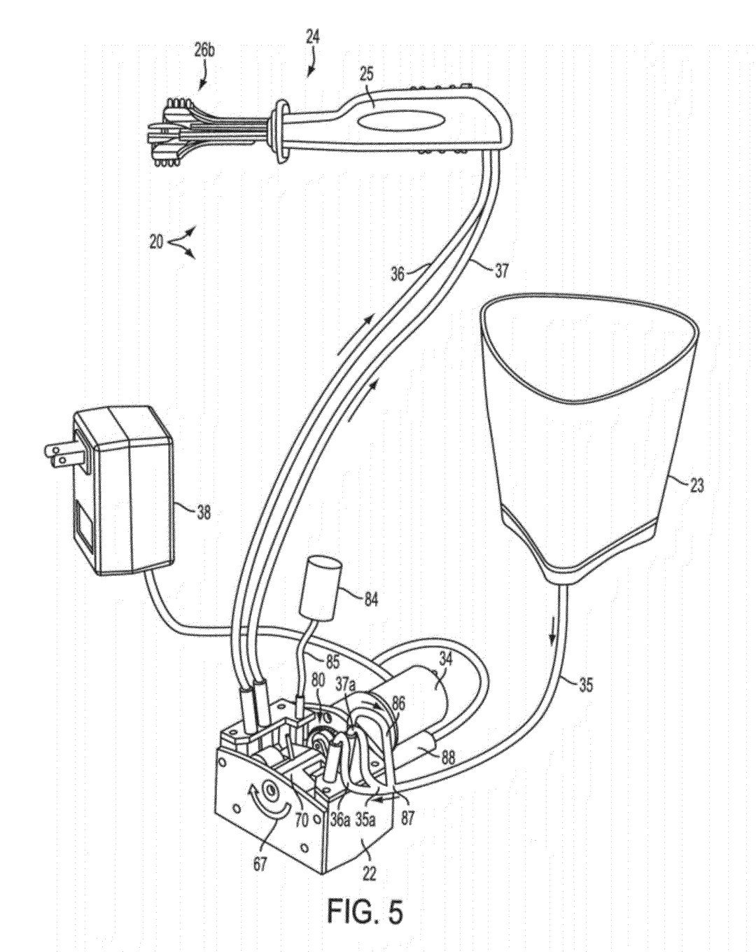

In further alternative implementations, see FIGS. 4 and 5, the irrigation unit 24 has an alternative irrigation sub-assembly 26b which here includes toothbrushes, see e.g., brushes 62, 64. Exemplary brush assemblies for use in alternative implementations like those shown here may be like those disclosed in co-pending U.S. patent application Ser. No. 60/385,366, filed Jun. 3, 2002, by the same inventor(s) as the present case. The disclosure of that application Ser. No. 60/385,366 is hereby incorporated herein by reference as if fully set forth here. Brushes like these can be used for brushing the teeth substantially simultaneously with the oral irrigation process, but may also be used to position the nozzles in operative position and guide the nozzles throughout the oral cavity for efficient usage. For example, a singular brush head (not directly shown, though could be hidden in the view of FIG. 4) could be used as the guide member like that optional guide member 60 shown in FIG. 2D. Alternatively or in addition thereto, one or more brush heads could be disposed for brushing the sides of the teeth, such as those brushes 62 and/or 64 shown in FIGS. 4 and 5, e.g. Note also that one or more set of brushes could be used with one or two nozzles such as nozzles 40 and/or 41 from FIGS. 1 and 2A-2D, so as to be used with either the top or bottom teeth at one time (alternately usable with the bottom or top teeth at a second or later time), or adjacent nozzles for use with top and bottom teeth at the same time as for example with nozzles 40, and 42, and/or 41, and 43 as shown in and/or described relative to FIG. 3.

Also as shown more particularly in FIGS. 4 and 5, the pumping module 22 can be efficiently packaged. In particular, it may be noted that in order to achieve two streams of water that independently pulsate, two pumps, see e.g., pumps 30, 32, may be used. These two pumps may be located within the pump module 22, and they may be timed, in one implementation substantially “perfectly timed” to each other to ensure accurate alternating pulses of water.

One type of pump for this application of providing one or more water jets for oral use may be a peristaltic pump. Peristaltic pumps have also been known in various fields of art, however, the use of peristaltic pumps in oral irrigation devices has apparently heretofore been unknown. Peristaltic pumps operate under the principle that a roller pinches or obstructs a flexible tube filled with fluid and then rolls the pinch or obstruction along the tube to thereby drive fluid through the tube. Commonly, peristaltic pumps are of rotational types. Thus, basically in a peristaltic pump, such as either of pumps 30, 32, see FIG. 1 for a more schematic view; a respective single flexible tube, see e.g., tube 36 and particularly the portion 36b disposed in the pump in FIG. 1, may be contained in such a manner that when a roller, see e.g., roller 31, is in rotational contact with the contained tube, e.g., tube portion 36b, the roller squeezes the tube, and in doing so, any liquid caught within the tube in front of or downstream of the roller may be pushed forward by the roller when the roller is moved in a rotational path, as for example along the curvature of the raceway 66 (depicted schematically in FIG. 1) in the direction indicated by the arrow 67 (also in FIG. 1). The fluid within the tube is then moved or pumped inside and along the tube, here e.g., tube 36 until the fluid is delivered to its destination, here e.g., to and through the nozzle 40, e.g.

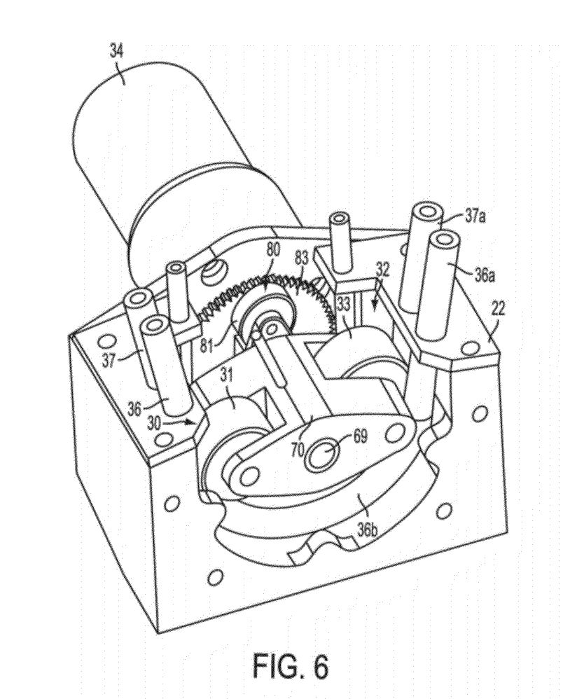

These types of pumps have been known in the art for some time. Even so, an implementation of the present developments is to “stack” the two water pumps 30, 32 on a common drive shaft, see shaft or axle 69 in FIGS. 1 and 6, in such a manner as to get the automatic pulse action and get it all done in a relatively small package. The axle could be stationary, or could be rotated to thereby rotate the pump arms or rotors and thereby move the rollers in revolution thereabout. Also, the pump stacking may be such that there are separate rotors on or about the axle 69 which could be moved separately though contiguously about the single axle, or as shown by the implementations of FIGS. 4, 5 and 6, a single rotor 70 could be used which includes all of the pump rollers thereon. Thus, by turning a single rotor 70, all of the pumps associated therewith will also be put in motion, and the rollers thereof put into operative contact with their respective tubes. By stacking the pumps, this assures a sort of perfect pulse “timing” since the two pumps run on a common shaft and are powered by a common motor. In the present incarnation, each pump in the “stack” may have a single roller, see e.g., rollers 31, 33 in FIGS. 1, 4, 5, and 6. The rollers of the two pumps may as shown here be positioned 180 degrees in relation to each other. When the motor shaft 69 makes one-half of a revolution, the first pump 30 delivers one pulse of water to the first one of the delivery tubes, tube 36. When the motor 34 completes the other one-half revolution, such that roller 33 rolls through contact with its tube, the other pump 32 then delivers a pulse of water to outlet conduit 37. This is how the pulses may be “timed.” It may also be understood that the reason the water is delivered in pulses from each pump is that a single roller on the tube of each pump is in contact with the tube only during one-half of a complete revolution since the tube in contained in a half circle, not a complete circle. When the roller in not in contact with the tube, there is a moment of water relaxation (no pressure) and as soon as the roller comes in contact with the tube, there is pressure. Pressure is always a result of resistance. Resistance may be obtained by sizing the water jet nozzles in the brushing head correctly (small enough to create enough resistance to obtain the desired water pressure).

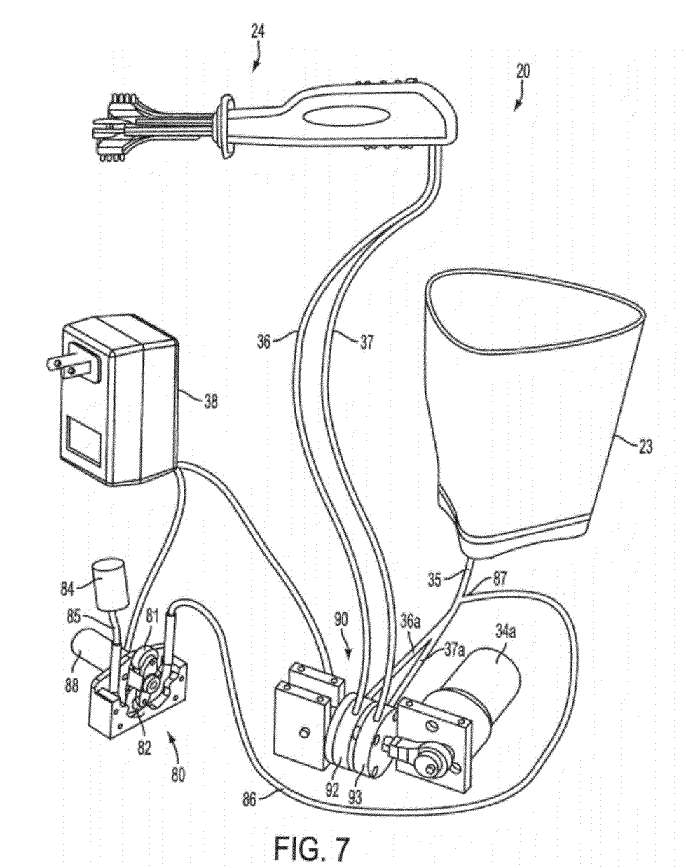

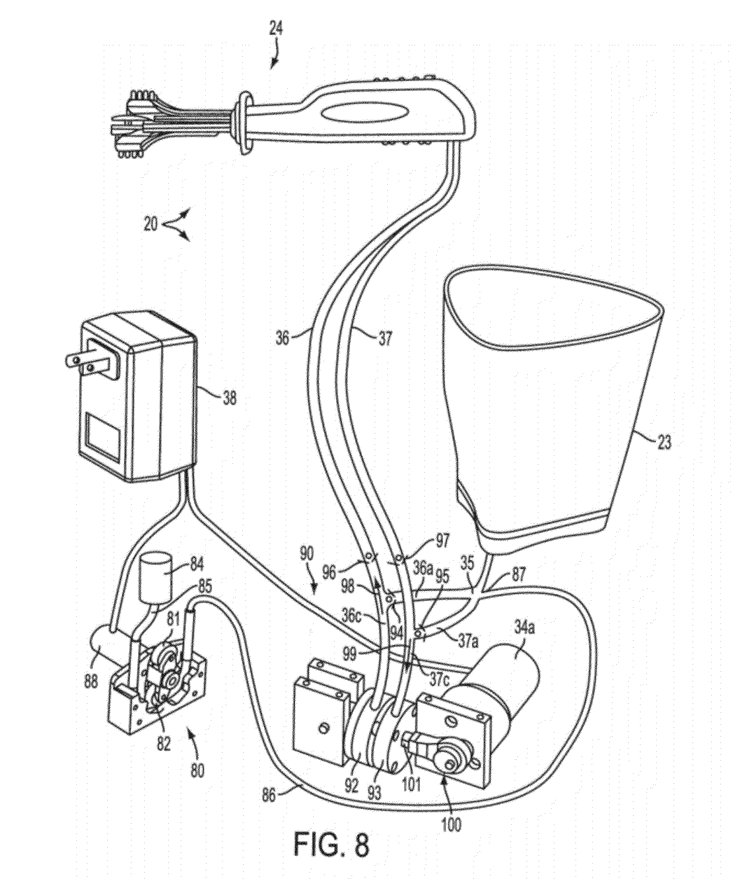

Also desirable is a method of injecting dentifrice, flavor concentrate etc. into the water stream. To do this, a third pump 80 may be used. This dentifrice pump 80 may inject/deliver concentrate at a much lower rate than the water pumps, e.g., pumps 30, 32. It has been found that a favorable ratio may be about 100 to 1, water to concentrate. As shown in the drawings, particularly FIGS. 4, 5 and 6, and FIGS. 7 and 8, the dentifrice pump 80 may include one or more rollers, see e.g., roller 81 in FIG. 6 and rollers 81 and 82 in the implementation of FIGS. 7 and 8. Pump 80 may operate in substantially the same fashion as the water pumps 30, 32, with the possible exception that the dentifrice pump 80 may have more than one roller (see e.g., FIGS. 7 and 8) so that the stream emanating from pump 80 may be substantially continuous instead of pulsating as may more likely be caused by a single roller pump (e.g., pumps 30, 32).

In one implementation, the third pump, the dentifrice pump 80 may as shown in FIG. 4 be disposed on the axle 69 and may in one implementation merely rotate thereabout, but be merely driven by motor 34 by a geared down or gear reduction from the driving speed of the other pumps 30, 32. A potential gear for this purpose may be identified in the drawings, see e.g., gear 83 in FIG. 6. (Note, gear 83 could alternatively represent a driving gear for driving the motors 30, 32.)

In any event, the dentifrice or other liquid to be injected into the main water stream may come from a source 84 and flow therefrom through a tube to the inlet of the pump 80. The roller(s) of pump 80 may then move the fluid in peristaltic fashion as described above to an outlet tube 86 which may then connect with the main inlet tube 35 at a T- or Y- (or like) connection 87. This general outline is the same for both of the implementations of FIGS. 4 and 5; however, in FIG. 5 the flow through the pump is in the opposite direction from that shown in FIG. 4. To achieve this, one implementation would include a separate pump motor 88. Pump motor 88 can then provide separate power to turn the pump rotor of pump 80 in the opposite direction of pumps 30, 32 even though the pump rotor of pump 80 may be disposed on the same axle 69. This can provide a relatively simple access of the dentifrice outlet tube 86 to the inlet line 35 as shown in FIG. 5.

In still further implementations, alternative pumping arrangements can be used. As shown in FIG. 7 for example, an injection pump 90 may also be used herein. As shown, the injection pump may be fed from a main inlet tubing line 35 from a fluid source 23 as above, and also as before, this main line 35 can be split into two portions 36a, 37a to feed two discrete chambers 92, 93 of the injection pump 90. As further described below, these chambers 92, 93 can then individually and alternately feed the separate feed conduits 36, 37 with streams or pulses of water which can then be used by and fed through the oral irrigation unit 24 in a fashion like that described above for FIGS. 1-6. Check valves (not shown in FIG. 7) like those known in the art may be used to control the flow of water into and out of the respective chambers 92, 93.

Alternatively, an arrangement of check valves (not unlike those which could be used with the implementation of FIG. 7) may look as shown schematically in FIG. 8. More particularly, a set of inlet check valves 94, 95 may be used to alternately allow flow from respective inlet lines 36a, 37a into the injection pump tubing portions 36c and 37c, and restrict backflow therefrom. Thus, when either chamber 92 or 93 is in the process of providing negative pressure to suck fluid therein from line 35 and source 23, then that suction force will pull open the respective check valve in the respective tubing portion 36a, 37a (see e.g., check valve 95 in line 37a which is shown with an open circle to designate an open condition; a flow arrow 99 also shows the respective flow). Since the typical implementation may include alternating pumping actions from the respective pump chambers 92, 93, the other check valve (here valve 94) should be in the opposite condition at any given time (this is why valve 94 is shown with a closed circle designating the closed condition of valve 94; a flow arrow 98 also demonstrates the corresponding flow). Substantially simultaneously herewith, a second set of check valves 96, 97 in corresponding outlet/feed conduits 36, 37 (and these also will be in opposite orientation, see valve 96 shown open corresponding to a closed valve 94 and flow arrow 98, while valve 97 is shown closed corresponding to an open valve 95 and a flow arrow 99).

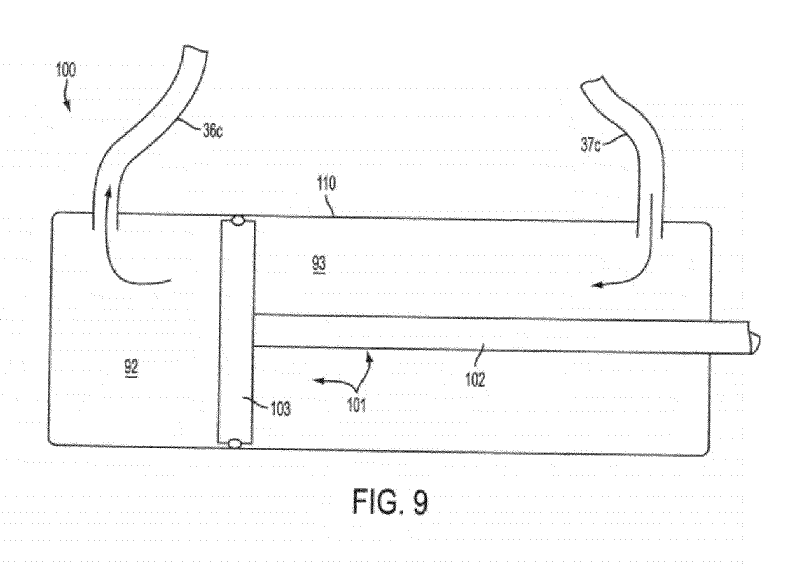

The operation of pump 90 in either of the implementations of FIG. 7 or 8 may take on the character of a driven piston pump, wherein a piston assembly 100 is driven by a pump motor 34a to drive a piston 101 alternately further in and further out of a piston chamber or chambers. As shown in FIG. 9, this piston 101 can be schematically depicted moving in an overall chamber 110 which includes two sub-chambers 92, 93. Piston 101 can include a rod 102 and head 103 which is movable to move a fluid in and out of each of the respective chambers 92, 93. As shown, the piston is being moved to the left into the sub-chamber 92 to force fluid out through tubing line 36c (which generally matches with the schematic of FIG. 8). At substantially the same time, a suction force is created in sub-chamber 93 by this same movement of piston 101 which draws a fluid into sub-chamber 93 through line 37c (also matching the schematic of FIG. 8). These respective forces cause the opening and closing of the respective check valves 94-97 (in FIG. 8, not shown in FIG. 7) to fill and empty the sub-chambers 92, 93. An alternating jet action of water is thereby delivered to the irrigation assembly 24 and the respective nozzles. Other alternative pumps may also be used here.

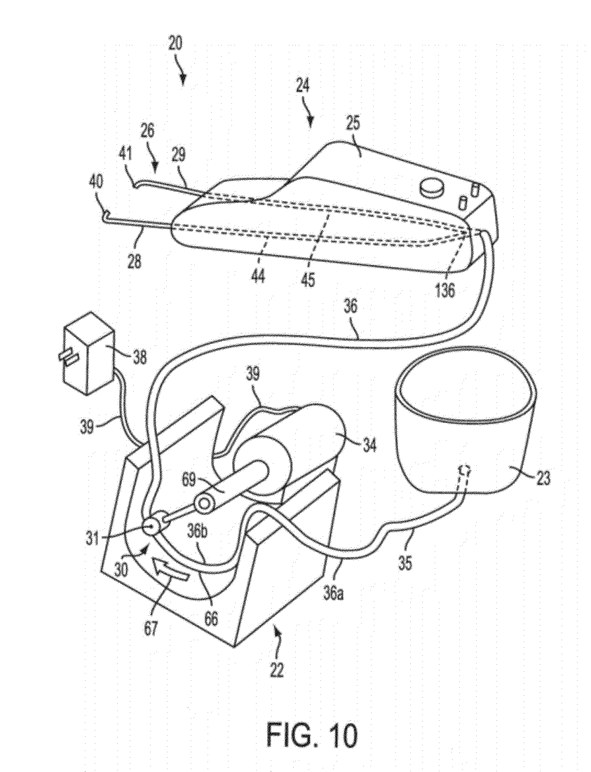

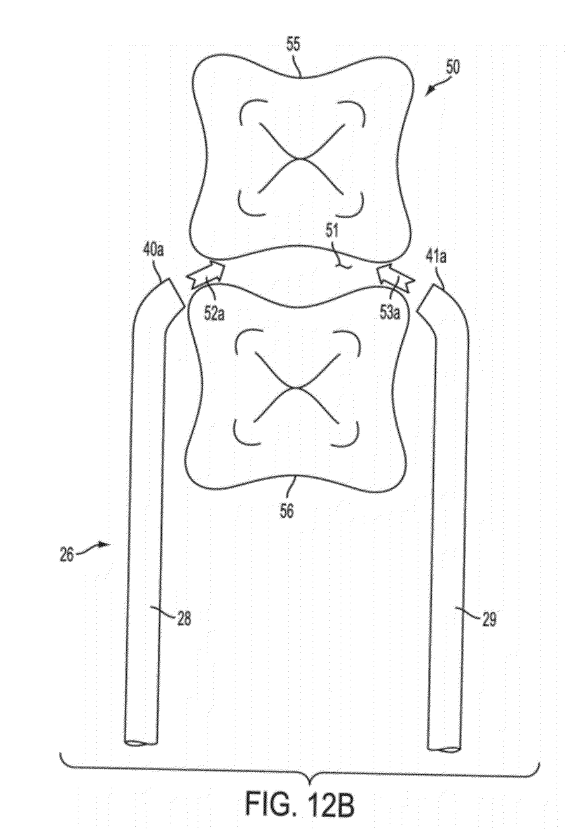

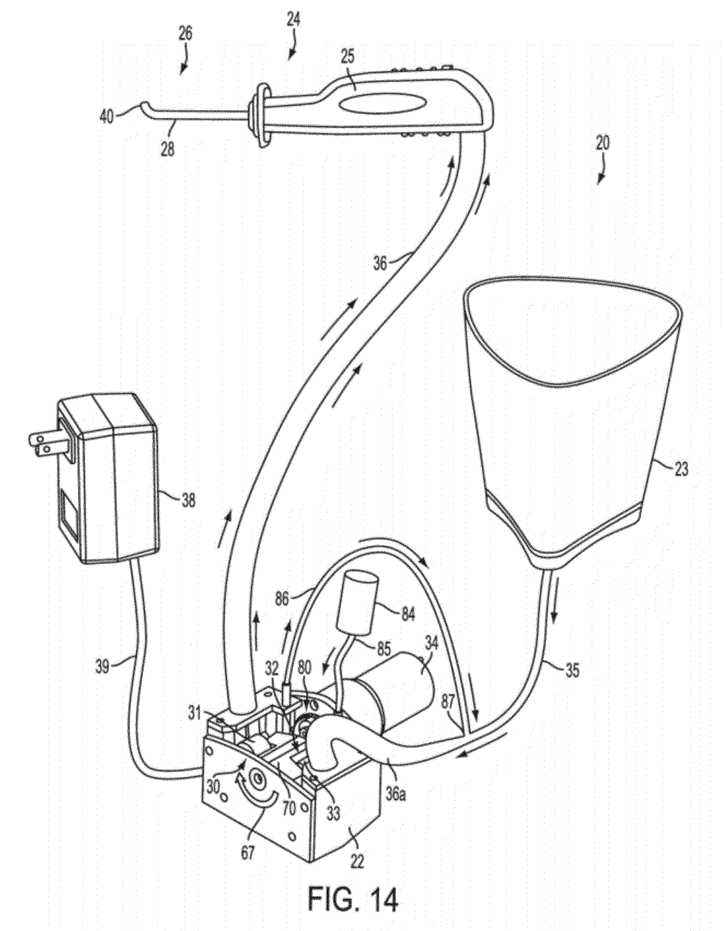

In the next set of implementations, alternative pumping and/or jetting arrangements will be further explored. For example, in FIG. 10, an alternative implementation involving only a single conduit 36 from the pump module 22 may be used. Here, a single nozzle 40 could be fed (not shown in singular form in FIG. 10, but see e.g., FIG. 14), or the flow in tube 36 could be split inside the handle 25 of irrigation unit 24 at a Y-split connection 136 into the two lines 44, 45 which lead to the two nozzles 40, 41 via arms 28, 29. In this case, a common line 36 will then feed the two nozzles substantially simultaneously. In the implementation of FIG. 10, this can involve pulsing jets produced by the single first pump assembly 30 with its single roller 31. As the roller 31 is only engaged part time with the tubing line 36/36b in the pump module, the fluid in the line 36 is allowed a certain amount of relaxation during the non-engaged period such that an alternating relaxation period, then a period of pressure application when the roller 31 then engages the tubing line 36b is experienced by the fluid in the line 36. A pulsating pressure jetting can be the effect. This pulsating jetting may then be provided to and split between the nozzles 40, 41 substantially simultaneously (see e.g., FIGS. 12A and 12B wherein the jets 52 and 53 are shown having left the respective nozzles 40, 41 substantially simultaneously).

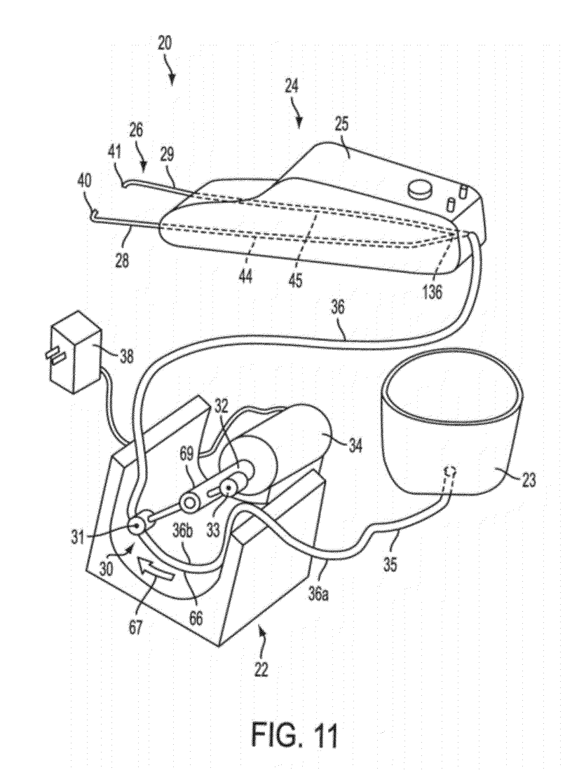

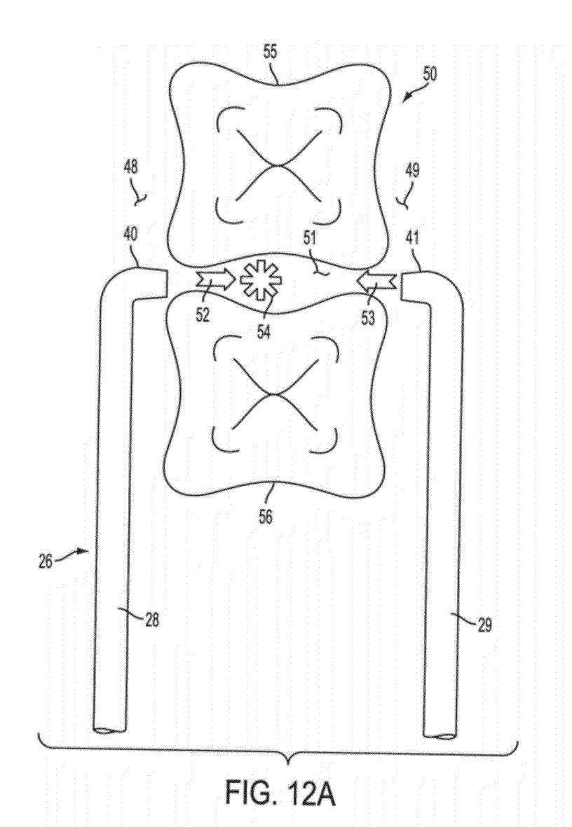

In a similar alternative, the pump module 22 shown in FIG. 11 shows a single feed tube 36 split in the handle 25 at a Y-split 136 as in FIG. 10, however, here there are two rollers 31, 33 of two pumping assemblies 30, 32 shown alternately engaging the tube 36/36b in the module. Note, pump assembly 32 has been relatively moved so as to also have its roller 33 be adapted to engage the tube 36/36b. Also, if as suggested here, at least one of these rollers will at substantially all times be in engagement with the tube 36/36a, then no (or little) relaxation will be allowed, and the fluid in the tube 36 will be placed under substantially continuous pressure and a relative non-jetting streaming of the fluid will be caused. These such streams may then be provided to and split between the nozzles 40, 41 (this also can be an interpretation of the schematic of FIGS. 12A and 12B). Peristaltic pumping could be effected with more than two rollers (not shown) to potentially further reduce the pulsatile effect. However, a discrete pulsatile effect could also be generated by two or more rollers when, for example, the tube portion 36b upon which the rollers act, would be disposed in a smaller arc than that shown, or even reduced to a substantially or nearly flat aspect. Thus, numerous or potentially extended relaxation periods could be generated thereby with any of one, two or more rollers.

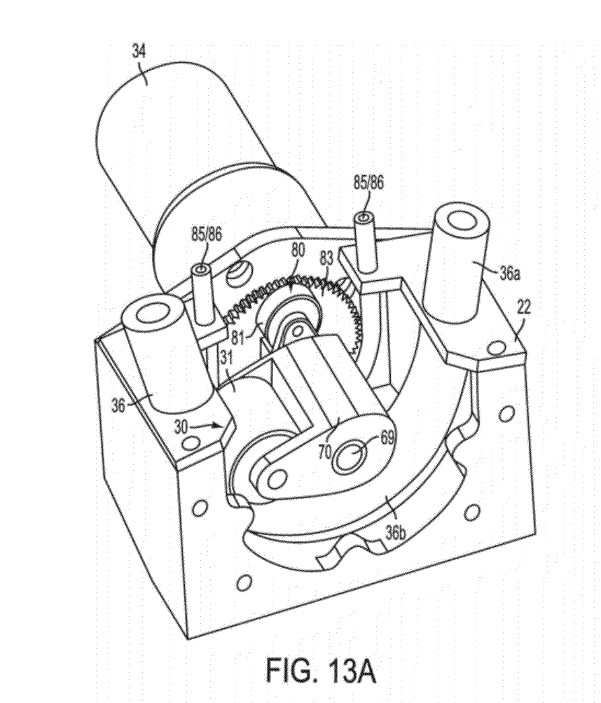

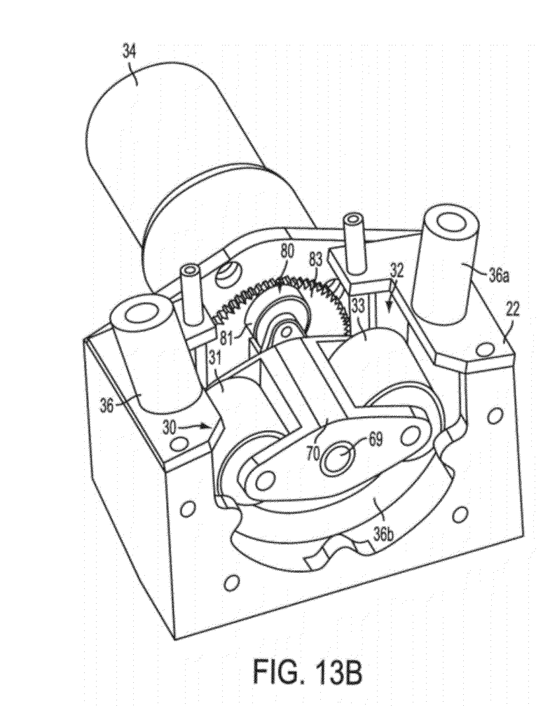

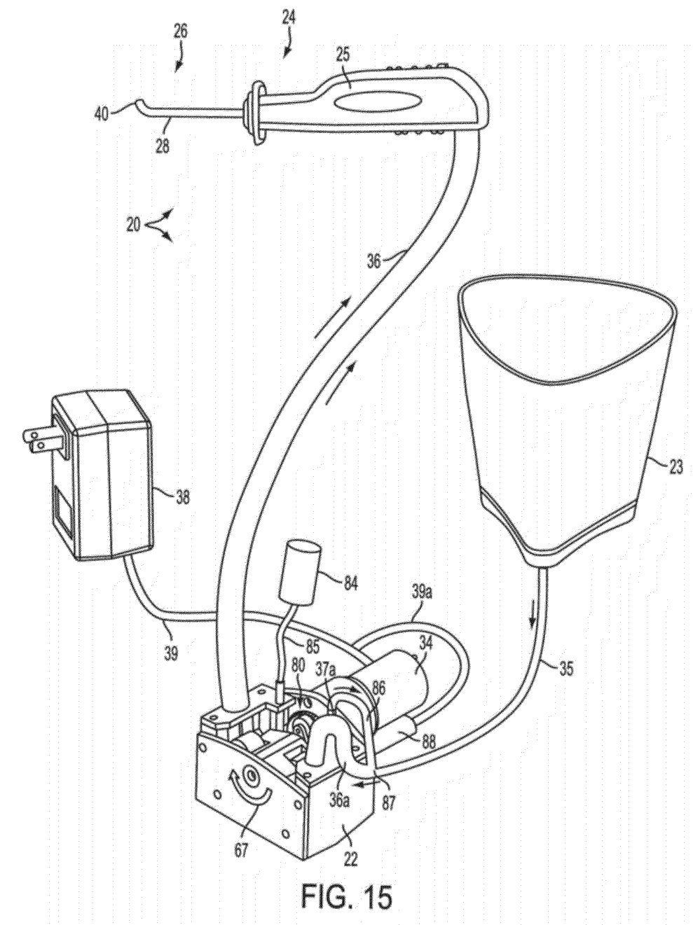

Example pump modules 22 for such implementations of FIGS. 10 and 11 (though not limited hereto) are shown in more detail in FIGS. 13A and 13B. A single roller 31 implementation is depicted in FIG. 13A and a dual roller implementation in FIG. 13B. Thus, pulsing jets would more likely result from use of a single roller pump assembly 30 as in FIG. 13A and more stream-like or streaming would result from the dual pump 30, 32 implementation of FIG. 13B. Note, a further (second/third/dentifrice) pump 80 is also shown in FIGS. 13A and 13B as such could be used with any of the implementations herein described. This pump 80 may be like that described in detail above (see FIGS. 6, 7 and 8, e.g.), and will also be addressed in some more detail with respect to FIGS. 14 and 15, below.

As shown in FIGS. 14 and 15, a handle 25 having one or more nozzles 40 (only one shown here) may be connected via a tubing line 36 to a pump module 22 having one or more pump rollers (see e.g., FIGS. 13A and 13B). The pump module may then be fed by a feed line 35 fed by a source 23 (as generally described above), such that a fluid disposed in and/or from the source 23 can then be communicated to the pump and thence to the handle and the nozzle(s) (note, one or more splits in or adjacent the handle could be used to feed more nozzles as described herein). If a dentifrice or other fluid is desired to injected into the main line 35, a further pump 80 can be used to take such fluid from a injection container 84, via an inlet line 85 pumped via one or more rollers 81, 82 to and through an outlet line 86 to an injection connection 87 to line 35. As before, this further pump assembly 80 can be run off the main motor 34 (via a gearing arrangement, usually to gear down the speed ratio) as shown by FIG. 14, or it could be run off a second motor 88 (FIG. 15) driving a gear 83 (FIGS. 13A and 13B). In either case, power can be provided to the motor 34 from the power supply 38 via power cord 39 (with the additional branch cord 39a for the second motor 88) which are shown schematically in FIGS. 14 and 15.

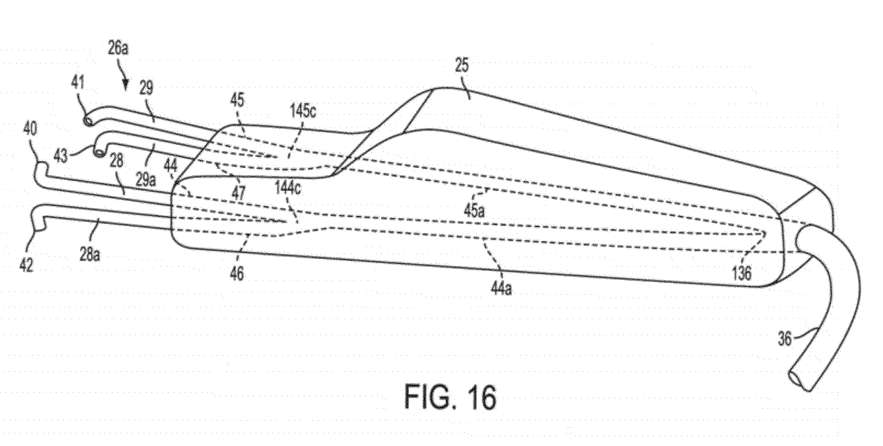

Note also that though not shown, an injection pump (see e.g., FIGS. 7, 8 and 9) or other pumping mechanisms (not shown) could also alternatively be used herein for pumping to one or more cleaning nozzles, e.g., nozzles 40 and/or 41 and/or 42 and/or 43. Moreover, one or more branch connections like connection 136 (FIGS. 10, 11 and 16) may be used. For a further example, as shown in FIG. 16, one feed line 36 can be broken into two supply lines 44a, 45a by a branch connection 136, and these supply lines can be further broken down into further supply lines such as lines 44, 46 by connection 144c in line 44a, and/or lines 45, 47 by connection 145c in line 45a. Thus, multiple nozzles can be fed by one (or more) original lines 36 (or the like). Here as above, nozzles 40 and 41 can be used for either sides of the upper teeth while substantially simultaneously, nozzles 42 and 43 can be used for the lower teeth. Note further that any or all of these branching connections 136, 144c, and/or 145c can be as shown, disposed in the handle 25 or they may be disposed outside the handle 25 (not shown) adjacent thereto, or even disparate therefrom, and yet not depart from the principles of the present developments.

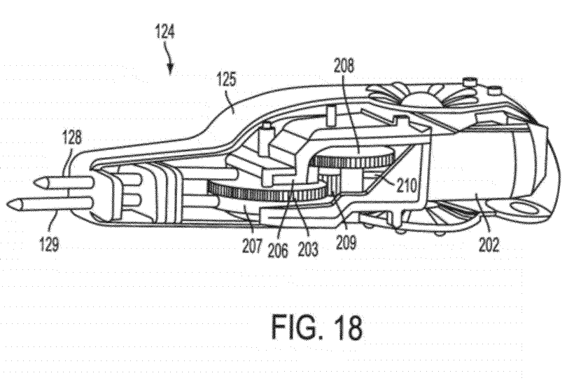

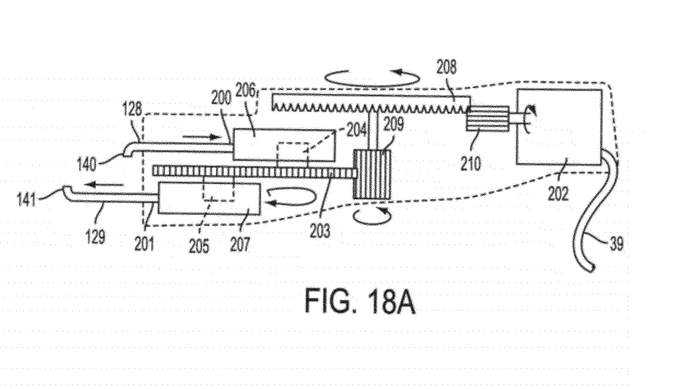

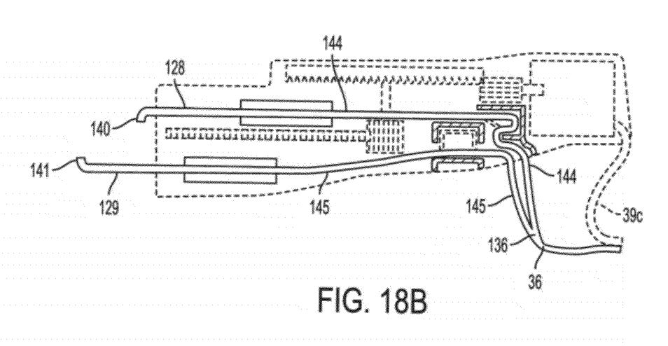

In a further set of implementations, moving shafts for moving cleaning arms/heads will be shown and described. For example, in FIGS. 17 and 18, there is a depiction of an isometric cut-away view of a handle 125 of an irrigation unit 124 which includes mechanisms for moving one or more cleaning arms 128, 129 (two shown here) of an irrigation assembly 126. More particularly, one or more structural shafts 200, 201 may be disposed in reciprocal motive disposition in and relative to the control handle 125. Shafts 200, 201 may, as shown be relatively contiguous with or otherwise connectable to arms 128, 129. One or more nozzles 140, 141 (again, two shown here) can thence be contiguous with arms 128, 129, as shown, or detachably attachable to the ends of the structural shafts/arms 200/128, 201/129. When the nozzle(s) 140, 141 are installed in/on respective shafts 200, 201, the respective water tubes 144, 145 (shown schematically), connect to and/or pass through respective holes or hollow portions of the shafts 200, 201 to communicate fluid therethrough to the respective nozzles 140, 141.

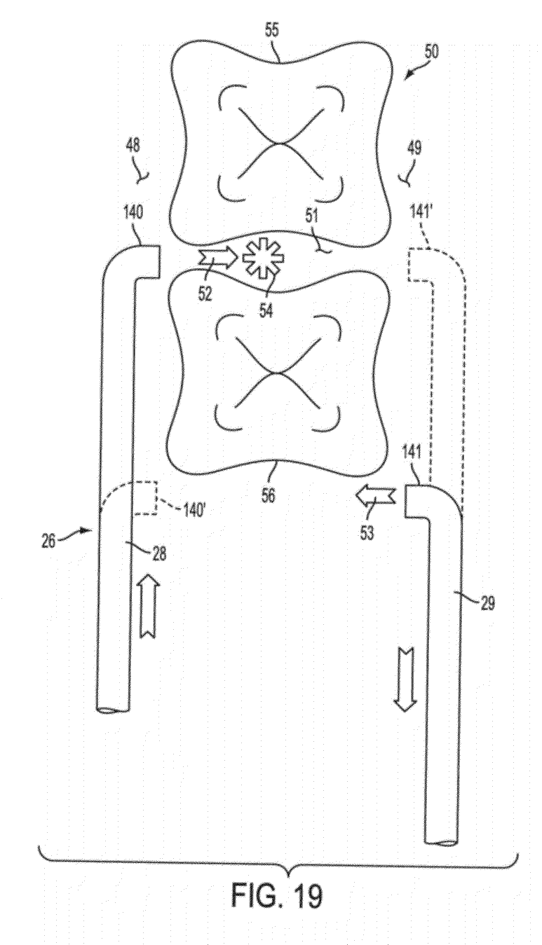

Inside the control handle 125 may be a direct current (DC) motor 202 that may provide primary power to reciprocate the nozzle heads 140, 141. The heart of the double reciprocal/opposing movement described and shown here may be a gear 203 with respective cams 204, 205 one each on opposite sides of the gear 203 (see FIG. 18A). The upper cam 204, the spur gear 203, and lower cam 205 may all be combined as one piece. Structural shafts/arms 200/128 and 201/129 may be attached to cam followers 206, 207 within the power handle 125. As shown in FIGS. 17, 18, and 18A, a system of gears may be used, in some implementations, to ultimately move the cleaning heads 140, 141. The system may include, as shown, a crown gear 208 connected by a shaft to a reduction spur gear 209 which communicates in gear meshing relationship with the double cam gear 203. A motor gear or pinion may be disposed in operative gear meshing relationship with the crown gear 208. Thus, when the DC motor 202 runs, its pinion gear 210 turns the crown gear 208 which may be attached to small spur gear 209 which in turn may be in contact with the double-cam big spur gear 203 which may thus by contact move the two cam followers 206, 207 to move in and out the arms/nozzles 128/140, 129/141 relative to the power handle 125. Thus, this causes the structural shafts 200, 201 to reciprocate in opposing directions and thereby provide for alternating dispositions of the nozzle heads 140, 141 as shown in FIG. 19, for example, the positions being reversible such that at one moment, the heads are as shown, and then they may be reciprocated such that they switch relative distances inside the mouth. The switched position is shown in FIG. 19 in dashed lines with a relatively lower, more outward nozzle 140′ shown relative to the relatively raised, more inward nozzle 141′.

The result is a simplification such that only one inlet tube, e.g., tube 36 may be used to provide a good alternating pulsatile action, alternating in that only one jet pulse will be directed at a piece of debris 54 at a time even though the pulses will be delivered to and leave the nozzles at substantially the same time. Then, the potentially simplest one roller peristaltic pump implementation (see e.g., FIGS. 10 and 13A) may be used to yet provide alternating pulses. Moreover, the moving jet heads make the pulsing water more active in the user's mouth, particularly when compared to the stationary nozzle implementations where the user must move the handle to move the jet heads. If the user does not move that implementation actively, then the jets will be less active relative to the entire mouth area, and the jets could even be substantially stagnant in acting in limited or only in the places that the user specifically directs their use. This can then aid in reducing if not eliminating human error.

Note, in the tubes/conduits 144, 145 may preferably be relatively flexible or resilient at least in a portion of their location within the handle 125 at or near their respective connection areas 214, 215. Thus, the tubes or hoses 144, 145 may at or in the connection areas 214, 215 be flexibly disposed such that each has enough clearance to allow the nozzle head 140, 141 to reciprocate in and out of the handle 125 and relatively fold into and alternately extend out of their respective areas 214, 215 as shown in FIG. 18B. The respective rolling in and extending out are shown in dashed lines.

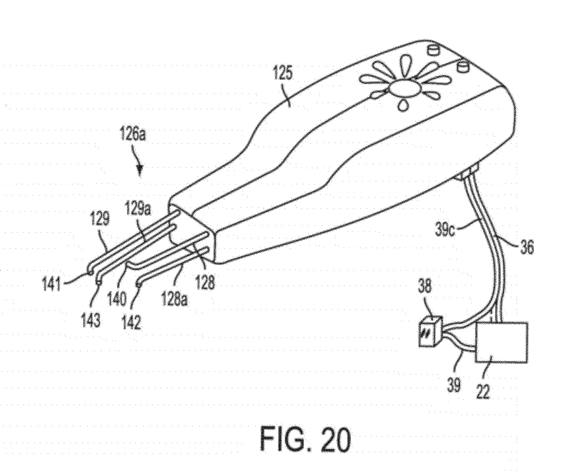

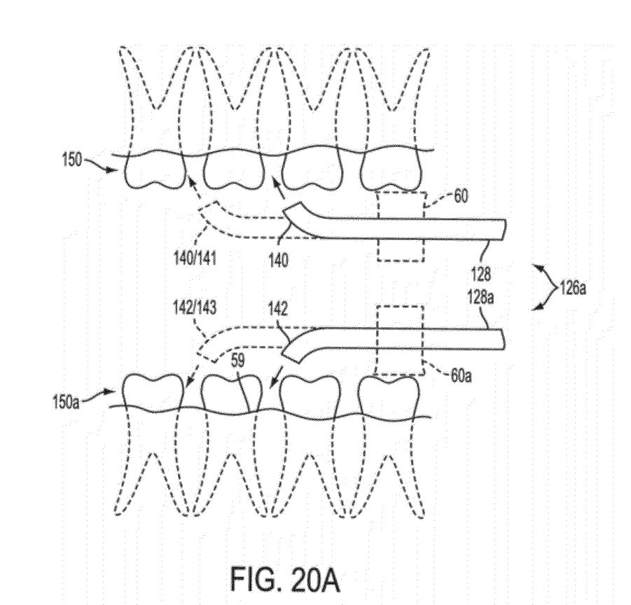

A similar alternative implementation is shown in FIG. 20, wherein a handle 125 has a further distinctive irrigation assembly 126a which has four nozzles 140, 141, 142 and 143 on four shafts/arms 128, 128a, 129 and 129a. These nozzles may be alternately reciprocable in a fashion like that described for FIGS. 17-19, although here it may be that first side nozzles 140, 142 may be reciprocated together either substantially simultaneously, yet potentially separately. However, in some implementations, they may be reciprocated as connected to the same cam follower, e.g., follower 206 (see FIGS. 17-19), and second-side nozzles 141, 143 could then also be reciprocated together in opposing relationship to the first side nozzles 140, 142. Thus, nozzles 141, 143 may be moved separately yet substantially simultaneously and/or may similarly be both connected to the same follower, e.g. follower 207 (FIGS. 17-19). The side view of FIG. 20A shows a version of how this might work. In particular, nozzles 140, 142 are shown spraying jets of water at respective top and bottom rows of teeth 150, 150a at substantially the same penetration into the mouth area. A dashed line representation of nozzles 140/141, 142/143 can represent either the reciprocated further penetration of the nozzles 140, 142, or could represent the opposing side nozzles 141, 143 as reciprocating at alternate depths relative to the primarily shown nozzles 140, 142. Note, also shown in dashed lines are optional guide members 60, 60a which could be used to set the relative spacing of the teeth (here, top to bottom) to better orient the nozzles so they are accurately directed at the gum lines (see e.g., gum line 59). Lateral guide members (not shown) could also be used, as could toothbrush members (see below) for this or a like purpose.

Note, different combinations (not shown) may also be had where for example the two top nozzle heads 140, 141 may be reciprocated together and the other, lower two heads 142, 143 may be reciprocated together in opposed relationship to the upper heads. Note, also shown in FIG. 20 is a schematic representation of a pump module 22 with a power unit 38 and a power cable 39 connected thereto, and also, emanating from module 22 is a supply conduit 36 and a power cable 39c which may as shown in dashed lines also emanate from module 22 or may come more directly from the power unit 38.

It may be preferable in various of these reciprocal moving part implementations to have respective opposing parts moving contrary to each other to provide balance to the overall device. As an example, in any two opposed nozzle orientations (see FIGS. 10, 11 and 17, 18, inter alia), the opposing nozzles may preferably move in opposite directions, one out while the other is moving in and vice versa. Also in four nozzle implementations, though two such nozzles may move together, it may be preferable to have two move one way while the other two move contrary thereto. This would likely hold true for contrary side versus side movements, as well as it would for relative top and bottom movements.

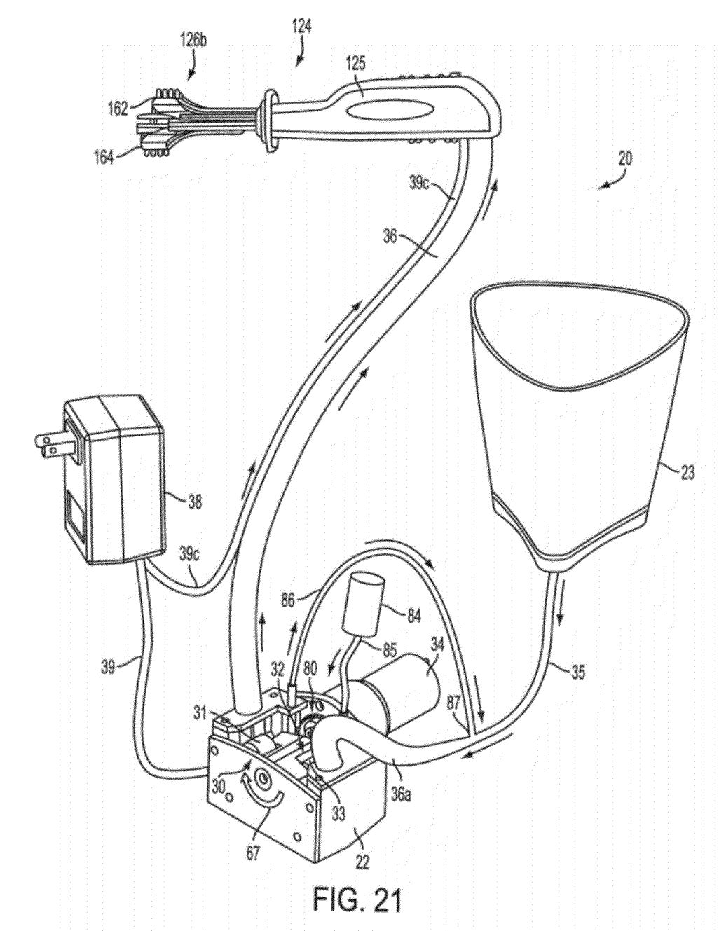

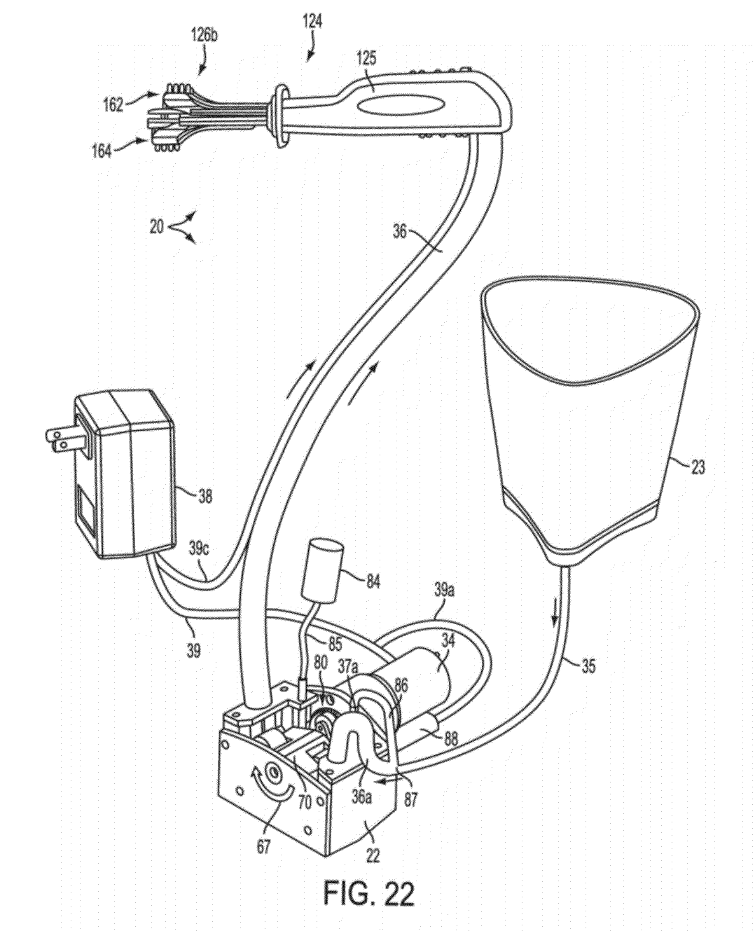

FIGS. 21 and 22 show further variations of these types of combinations with a singular supply line 36 combined with a power line 39c running to the handle 125. FIG. 21 includes a dentifrice pump mechanism 80 run in relative tandem (even if stepped down) with the main pump motor 34, whereas FIG. 22 shows the separate dentifrice pump 88 in fashion as described hereinabove. Note, various pump alternatives might be used herewith as well, such as piston driven injection pumps (see FIGS. 7-8, though utilizing only one chamber, or having both chambers feed one delivery line 36). Further note however, that two alternative brush head assemblies 162, 164 are also shown in FIGS. 21, 22, which could, as described below, be used with any of the herein described oral irrigation alternatives.

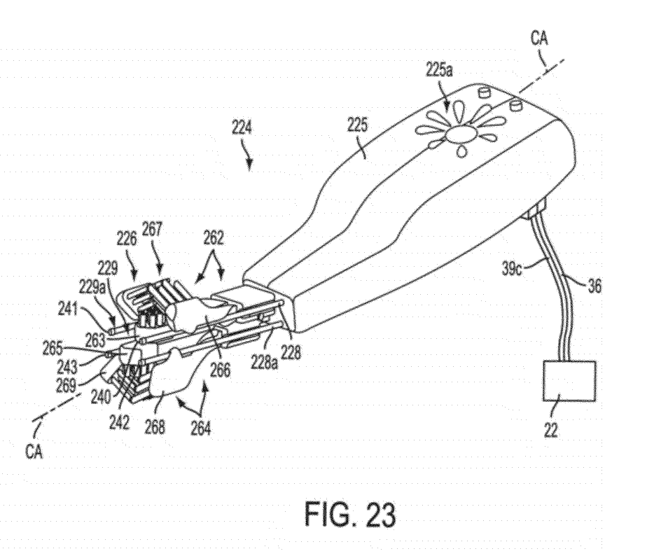

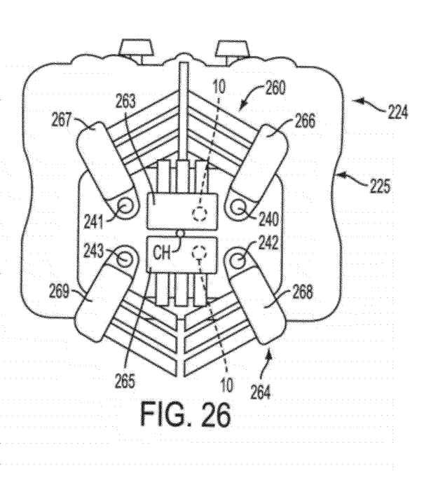

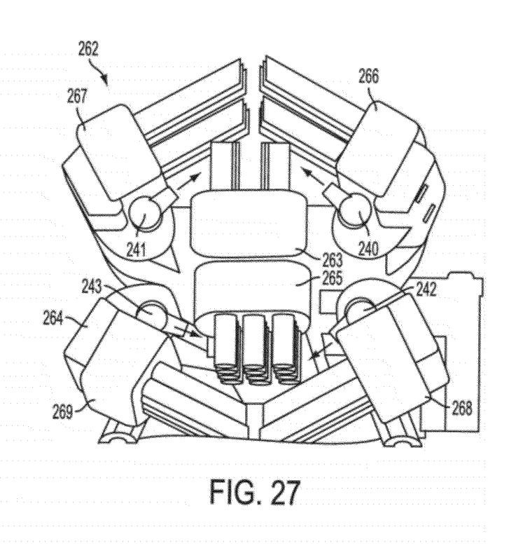

More particularly, also disclosed herein are various toothbrush alternatives (powered and stationary) with and without oral irrigation alternatives. In a first example, shown generally in FIGS. 23 through 28, a brush and/or irrigation assembly 224 may include a handle 225 extending along a central axis (CA) and including therealong: a rearwardly positioned control portion 225a of the handle 225; and a forwardly positioned brushing assembly 226 including at least one, and preferably two tripartite brushing heads 262, 264 spaced in opposing above and below directions away from said central axis. Each of said tripartite brush head assemblies 262, 264 may respectively headwise include respective principal crown surface brush heads 263, 265 and optionally also pairs of laterally opposed brush heads 266, 267 and 268, 269 for brushing lingual and bucal surfaces and occlussional surfaces of a row of teeth. In many implementations, the control handle 225 may be provided with conduit means (see e.g., supply conduit 36 from pump module 22) adapted to deliver irrigation water adjacent or into and/or through said one or two or more stationary or longitudinally movable cleaning head assemblies (see below). Jet ports 240, 241, 242 and/or 243 may thus also be provided on arms 228, 228a, 229, and/or 229a for oral irrigation. As introduced, the control handle may in some implementations be provided with powering means (see e.g., power line 39c in FIG. 23) for providing reciprocating longitudinal movement in synchronization of the nozzle assemblies of ports 240, 241, 242 and/or 243 and/or the tripartite brushing head assemblies 262, 264.

An assembly such as this may be adequate for twin cooperative goals of efficaciously brushing the occlusial and lingual-bucal surfaces (including gaps therebetween) while also simultaneously irrigating the aforementioned surfaces and also the underlying teeth gums. An aspect hereof may thus be the provision of improved powered toothbrush augmented with oral irrigation for simultaneously efficaciously brushing the occlusial and the lingual bucal surfaces including any gaps therebetween while simultaneously beneficially irrigating the teeth surfaces and also the underlying teeth gums, the latter benefit representing therapeutic prevention of periodontal problems.

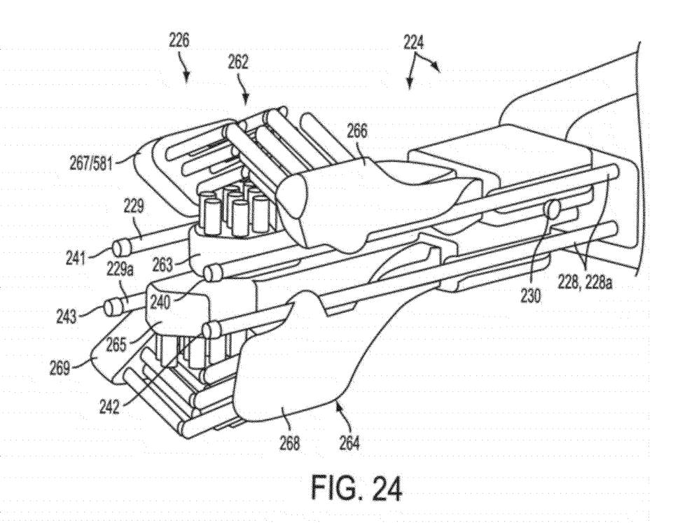

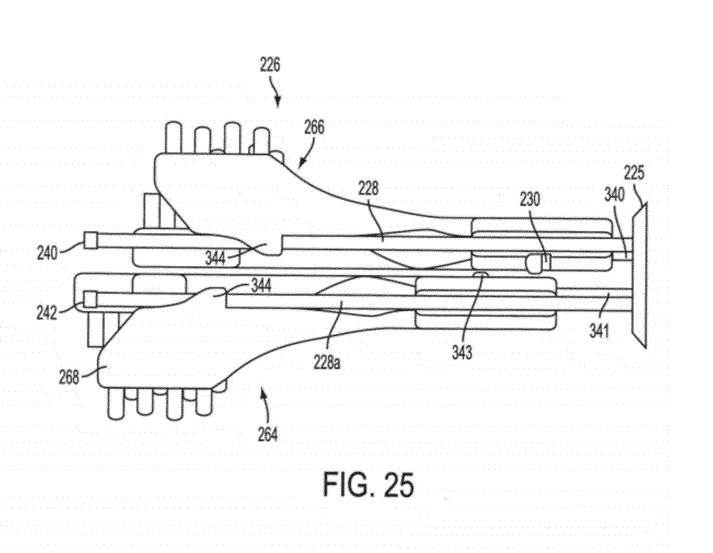

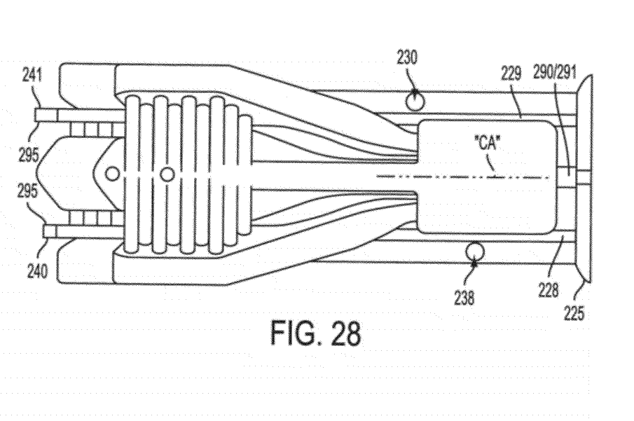

In a first of these alternative implementations, the one or more brush head assemblies 262 and/or 264 may be disposed in substantially stationary relationship relative to the handle 225, and the nozzles 240-243 may also be stationary. Or, in a next implementation, the brush head assemblies may be substantially stationary and the nozzles and arms 228, 228a, 229 and/or 229a may be made substantially reciprocal in any of several fashions such as some of those implementations described in more detail above (see FIGS. 17-19, inter alia). Particularly in an example such as those shown in FIGS. 23-28, the arms 228, 228a, 229 and/or 229a may be disposed outside and/or otherwise adjacent the brush head assemblies 262, 264 and thus reciprocate therealong. As shown in more detail in FIGS. 25 and 28, the arms 228, 228a, 229 and/or 229a may thus run along and/or may actually run in grooves or other structural manifestations in the brush bodies 343 and may thus be merely adjacent or actually be in some contact with the brush bodies 343. A clip 230 (see FIG. 24) may assist in securing this/these positioning(s). Note, as described thus far, the brush heads and bodies are substantially stationary and may be connected to the handle 225 by respective structural shafts 340, 341 (see FIGS. 25 and 28). One or more further structural wraparound catch(es) 344 (see FIGS. 24 and 25) may also optionally be used to position the shaft arms 228, 228a, 229 and/or 229a relative to the brush bodies 343 whether either is moving relative to the other.

In this and various of the other toothbrush examples herein, particularly with tripartite brushheads, the brushhead assembly or assemblies 262, 264 may be adapted to receive one or more teeth securely therein, and thereby position the device 224 such that the nozzles 240-243 may be very advantageously aimed at the teeth and/or gums in strategic position to provide maximal cleaning. An angle of such cleaning may be such as to point the nozzles at the gum line as suggested by various drawing figures herein, as for example FIG. 20A. Thus the brush heads could provide the service suggested for the guide members 60, and/or 60a therein.

Brush head assemblies could include one or more brush heads, as for example as shown wherein a tripartite assembly 262 could include a crown brush 263, and could optionally further include one or more laterally space heads 266, 267. Similarly, a lower tripartite assembly 264 could include a crown brush 265, and optional further lateral heads 268, 269. In such implementations, the brush head assemblies could provide very secure top to bottom and lateral, side to side positioning of the cleaning assembly 226 inside a user's mouth. All the user need do is bite down into the brush head assembly(ies), and thereby have the brushes and nozzles adequately and potentially very accurately positioned for maximal cleaning.

In another implementation also illustrated by the drawings of FIGS. 23-28, the arms and nozzles may be disposed in a substantially stationary disposition and the brush heads 262, 264 made to move in reciprocal in and out fashion. Generically, this would describe a power toothbrush with oral irrigation device 224 of the present developments which may be further described as extending along a longitudinal and in one implementation preferably horizontal central axis and include a rearwardly positioned control handle 225 extending along the central axis; and forwardly positioned of and in longitudinally reciprocatable relationship to said control handle, a cleaning head assembly 226 having at least one tripartite brushing head 262 that may be vertically spaced away from a central axis. The tripartite brushing head assembly 262 may include, as above, a first crown brush 263 for brushing the occlusial surfaces of a row of teeth and may also include lateral and opposed second and third angularly disposed brushes 266, 267 for brushing lingual and bucal surfaces of the row of teeth that may be interposable between the upright second brush and third brush. In the implementations wherein the brush assemblies are disposed in substantially horizontal orientation, the crown brush will be substantially horizontal, and the lateral brushes upright standing from the horizontal. The control handle 225 may here also be internally or externally provided with powering means for effecting a longitudinally reciprocatable relationship of the at least one tripartite brushing head; and the control handle may further be provided with internal and/or external conduit means adapted to deliver irrigation water into and/or adjacent said tripartite brushing head(s).

More particularly, the powered toothbrush with oral irrigation as hereabove described may be especially adaptable for simultaneously reliably brushing the user's upper row of teeth and the lower row of teeth and whereby there may be on opposite sides vertically from a central axis both an upper and also a lower tripartite brushing head assembly 262, 264; wherein the control-handle powering means may be adapted to cause such brushing heads to simultaneously longitudinally reciprocate in opposite directions; and wherein the control-handle conduit means is adapted to simultaneously deliver water into and/or adjacent both said tripartite brushing heads via the nozzles 240, 241, 242 and/or 243.

Thus as shown in the drawings, a representative implementation 224 of the present developments may include a powered toothbrush with oral irrigation and/or a powered oral irrigation device with a toothbrush. This device 224 extends longitudinally (and in one orientation, horizontally) along a central axis CA and has four main parts including: a rearwardly positioned control-handle 225; at least one forwardly positioned tripartite brushing head(s) 262 and/or 264 vertically spaced form the central axis CA and directionally longitudinally reciprocatably attached to the handle 225. Each such longitudinal reciprocatable tripartite brushing head includes a horizontal brush 263, 265 for brushing the occlusial surfaces of a row of teeth, and opposed upright second brushes 266, 267 and/or 268, 269 for respectively simultaneously brushing lingual and bucal surfaces of upright brushes surrounded teeth-row; the control handle 225 being internally or externally provided with powering means (see e.g., power cord 39c for external supply, an internal battery (not shown) could be alternated therefor), for effecting longitudinal reciprocation of at least one said brush head 262 and/or 264; and the control-handle 225 being provided with a conduit or conduits 36 for delivering irrigation water into one or both reciprocatable tripartite brushing heads 262 and/or 264.

In the detailed FIGS. 24-28 are shown isometric, side and front elevational and top plan views of the representative implementation 224. Referring now to these details, a control-handle 225 with two tripartite brush head assemblies 262, 264 reciprocatably attached thereto. Brush head assemblies 262, 264 can simultaneously brush an upper row of teeth and a lower row of teeth. The brush heads may in one implementation, reciprocate in and out about ¼ inch of movement. The upper brush head and lower brush head may preferably be made to move in opposite directions, i.e., when the upper brush head 262 is moving inward, the lower brush head 264 is moving outward. This is desirable in many implementations because when a user bites into the upper and lower brush heads at the same time, the opposing reciprocatable movement can provide a “balance” so that the power handle does not tend to move in and out as a result of contact with both the upper and lower brush head simultaneously.

One, two, or as shown in FIGS. 23-28, four (or any other practical number of) water delivery tubes or conduits 228, 228a, 229, and/or 229a may be rigidly or movably attached to the end of the handle 225. Again, as described in some implementations these tubes can be made to be non-reciprocatable. However, these may in alternative implementations be made movable for the alternative reasons further described relative to FIGS. 10-17 inter alia. Water jet spray nozzles/orifices 240, 241, 242 and 243 may be disposed at the respective ends of the tubes 228, 228a, 229 and/or 229a, and these nozzles/orifices may be directed toward the user's gum line and direct water jet flow between the teeth. One or two (or more) water tubes 36 (and/or 37, see FIGS. 1-9) may then be connected to the delivery tubes 228, 228a, 229 and/or 229a, directly or through respective Y-connections, and this/these tubes 36, 37 may then run from their attachment to the power handle down to the control module 22. As described, a water pump of one or more of a variety of types (peristaltic or piston or otherwise) may be used to pressurize water for delivery into and through the tube or tubes 36, 37 in either a pulsating or a relative continuous streaming fashion. In many implementations, this may include delivery into and through first one tube, then the other to provide alternating pulsating water jets.

Thus, either movable nozzles or movable brushes or both simultaneously reciprocating may be found in devices of the present development. Again, other guide members not involving brush heads (see FIG. 20A) whether of up and down guides or lateral guides or both may be included herein.

Moreover, the movements of the nozzles and/or brush heads may be forced by various mechanisms, but could include mechanisms such as those shown and described relative to FIGS. 17-18, inter alia. Thus, inside the control handle 225 maybe a direct current (DC) motor that may provide primary power to reciprocate the brush heads 262, 264. The heart of this double reciprocal/opposing movement could thus be a gear with a cam on both sides of the gear. The upper cam, spur gear, and lower cam could here also all be combined as one piece. The structural shafts may then be attached to the cam followers within the power handle 225. When the DC motor runs, its pinion gear could then turn a crown gear which may be attached to small spur gear which in turn may be in contact with the double-cam big spur gear. This double-cam spur gear could then move two cam followers in and out relative to the power handle thus causing the structural shafts to reciprocate in opposing directions.

The respective brush head assembly(ies) 262, 264 can also be detachably attached to the end of the respective structural brush shafts 340, 341. Detachability may be effected through use of depressible button 230 which can release a spring catch (not shown), and the respective brush head 262 (and/or 264) can then be removed or pulled therefrom. A similar disposition and action may be had with the nozzles (if so desired) and the corresponding structural shaft arms. In some implementations, the brush head(s) (or replaceable nozzles) may be installed onto corresponding shafts, until they go on to a point at which the button “snaps” and locks the brush head (or nozzle) in relation to the respective structural shaft.

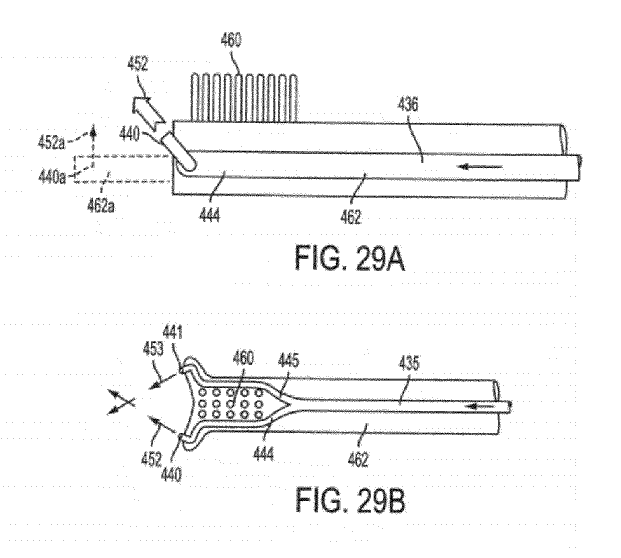

In the next FIGS. 29A and 29B, there is a depiction of a side view of a brush head 460 having the oral irrigation tube 436 disposed therein. The brush and nozzle(s) may be stationary or reciprocate as above, however, here they will reciprocate together. Top and bottom brushes (not shown) with or without lateral brushes (not shown) may also be used herewith. Tube 436 extends along and within the structural shaft 462 of brush 460, and then the tube splits into tube portions 444, 445 which ultimately deliver fluid to the nozzles 440, 441. The fluid jets 452, 453 may be directed angularly as shown. This may provide the pattern of jetting (or streaming) shown; however, this may be advantageous in that there will likely be no adverse interaction of the jets with the brush head as may have been the case with disparate jet nozzles and brush heads as shown in FIG. 29A by the dashed line version of nozzle 440a on structure 462a which issues a jet 452a which could interact with a moving brush 460. Again, one or more of these brushes may be disposed in reciprocal motive disposition in and relative to a control handle 125/225. Also, when, the water tubes pass through and/or emanate from the brush structure through a hole in or adjacent the brushes, the tube and/or nozzles have enough clearance to issue jets or streams without interacting or otherwise interfering with the brush head reciprocating along the user's tooth and/or gum line.

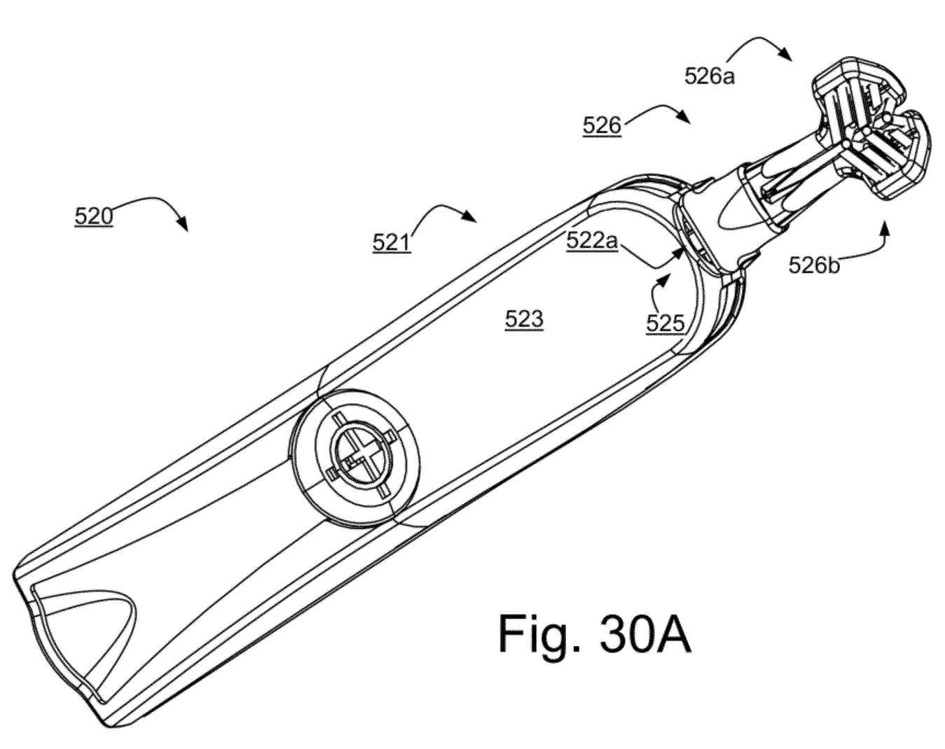

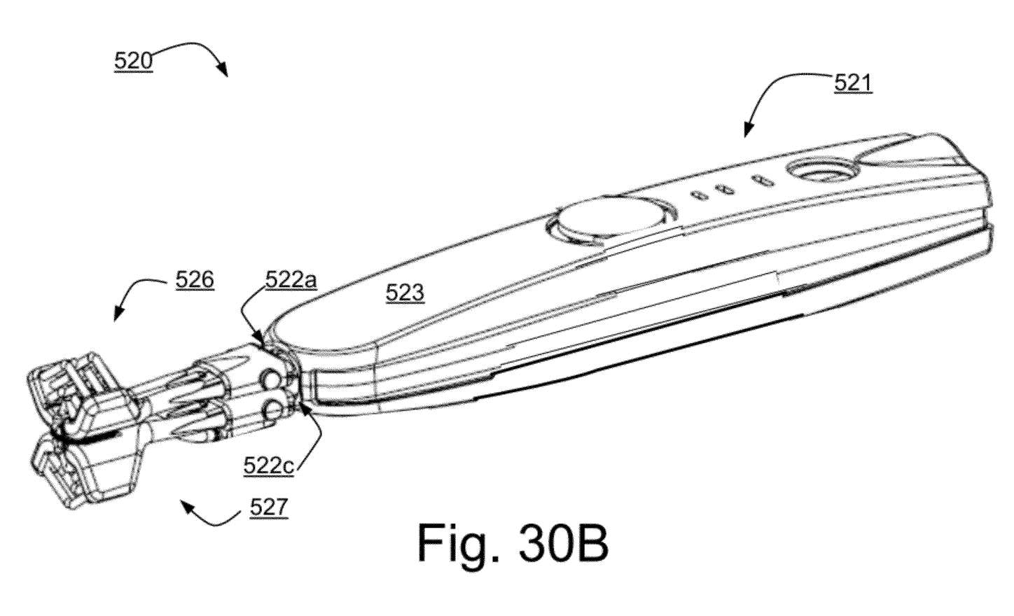

FIGS. 30-39 show some additional alternative oral care devices hereof generally at 500 and/or 520. Such a device may alternatively be referred to as an oral care device, or an oral cleansing device or a toothbrush 500 or 520 herein as well, though this is not intended to be limiting inasmuch as the device 500 or 520 may be, and often is adapted to provide oral care to other oral structures including but not limited to the gums; and/or may or may not include actual brushes or bristles—some instances being irrigation without brushing. Some operational effects of such a device or toothbrush, as described hereinafter, may include a significant cleansing effect produced by the bristles, reaching into interdental and subgingival regions, to bacterial plaque on the teeth. This effect may include an enhanced scrubbing effect produced by the motion of the bristles when they are in actual physical contact with the teeth to be cleaned.

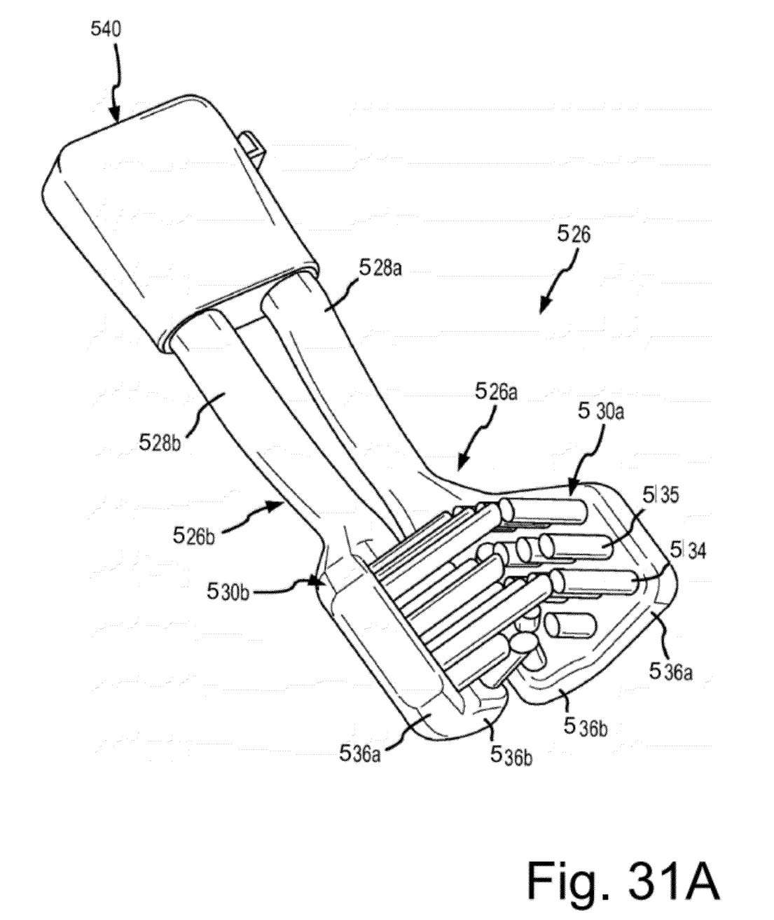

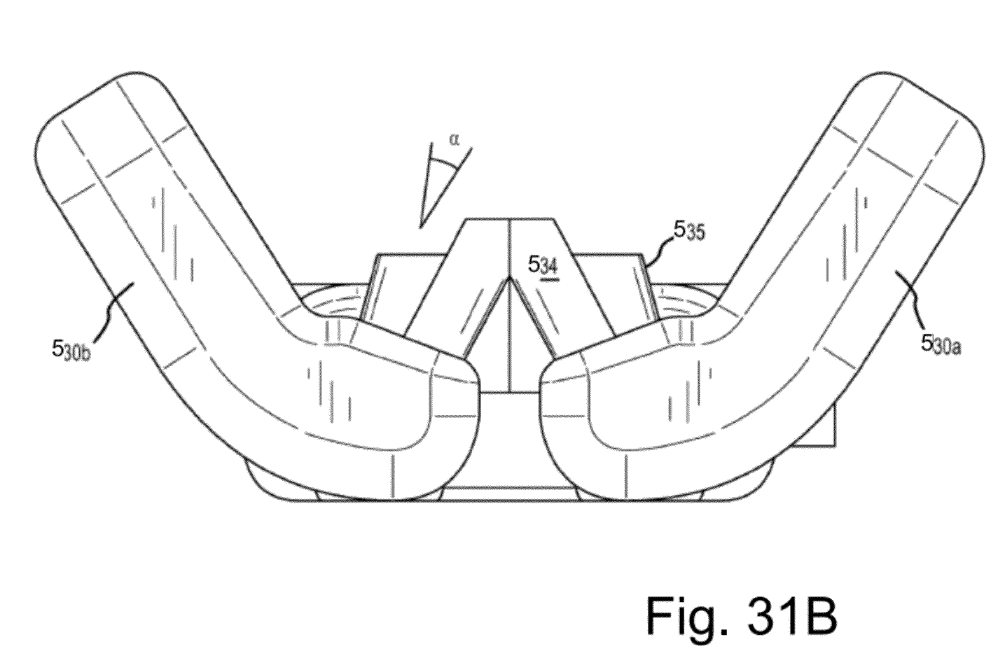

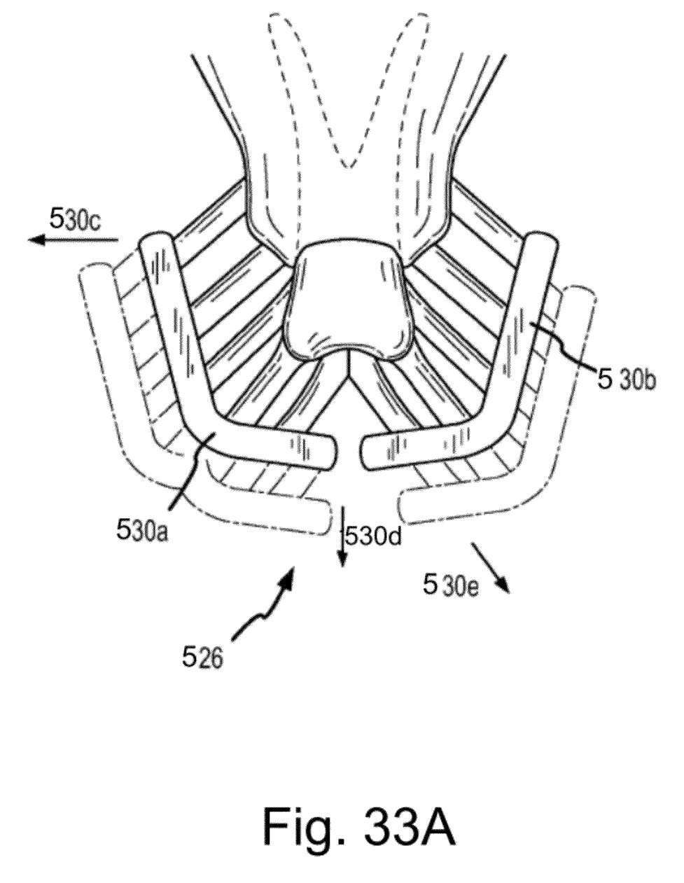

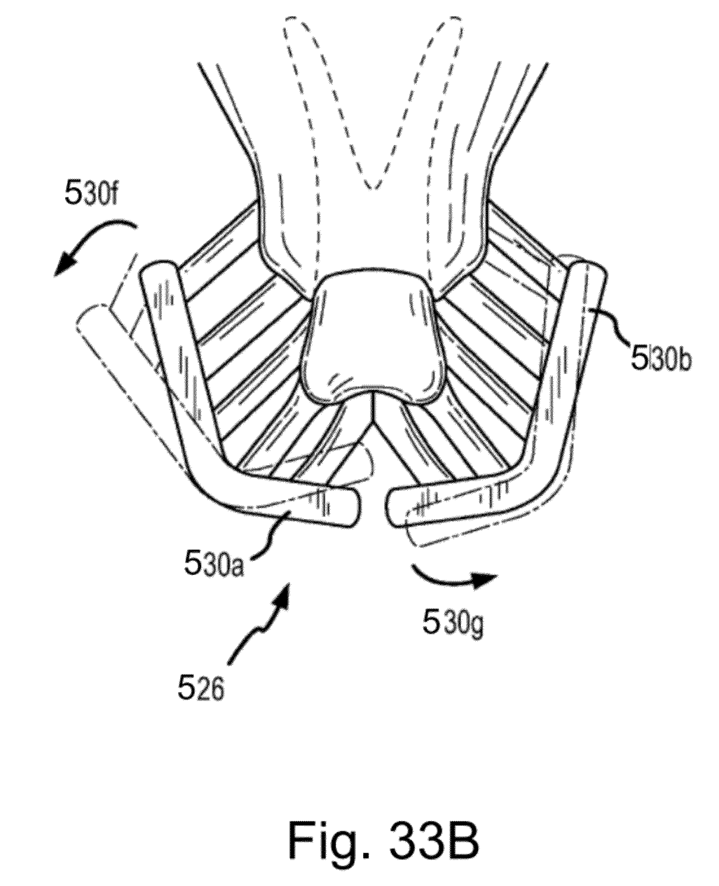

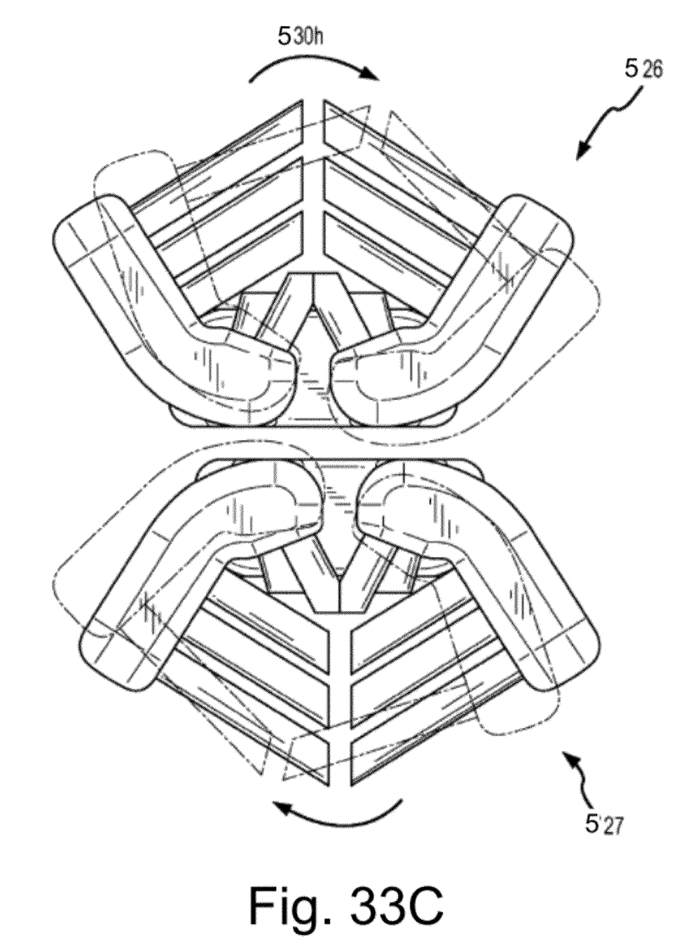

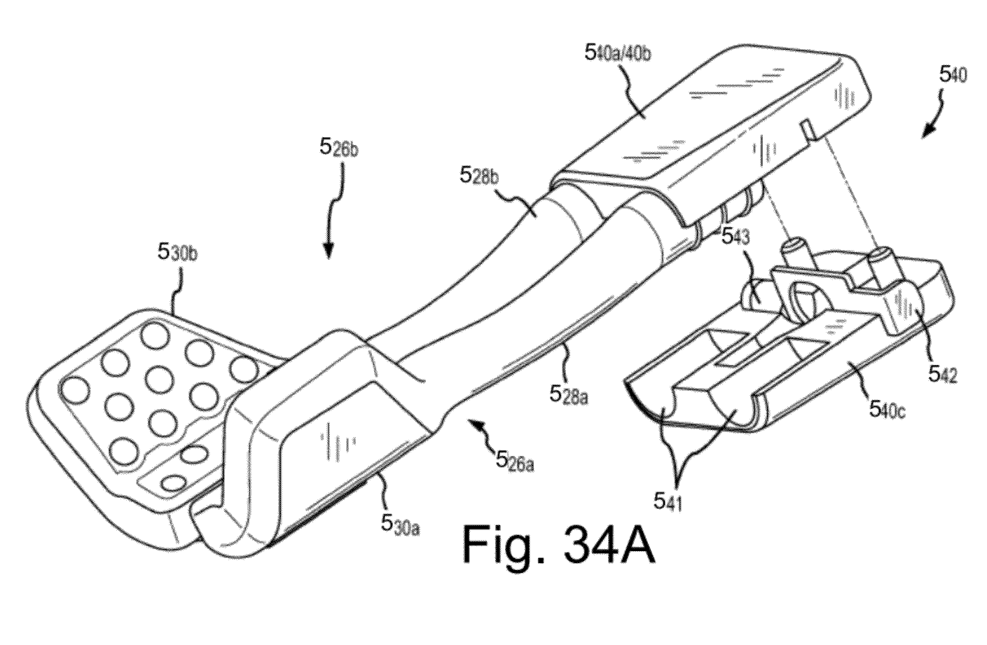

A device 500 or 520 hereof may include a general body or handle portion 521 which in turn includes a housing portion 523 as shown for example in FIGS. 30A and 30B. Now in more detail, though first in a relative macroscopic view; as shown at least initially in FIGS. 30A and 30B, an exemplary automated tooth and/or gum cleaning device 500 or 520 hereof may generally include a body or control handle or module 521 (FIGS. 30A and 30B) and one or more cleaning head arrangement(s), herein generally referred to as respective cleaning or brush head assemblies 526 (FIGS. 30A and 30B) (and/or optional additional assembly 527 (see FIG. 30B)); the brush head assembly(/ies) connected to the handle 521 via a connection sub-system/sub-assembly 525. These respective cleaning or brush head assemblies 526 and/or 527 are shown positioning respective brushes, e.g. brushes 526a, 526b (see FIGS. 30A and 30B and 33C, inter alia., described below) and the brush bristles 534, 535 (again, see FIGS. 31 and 32 and FIG. 33, inter alia, below) thereof in operative dispositions, typically in a multiple directional, multi-sided fashion as described further below. The control handle 521 may then also include one or more control assemblies 524 (see FIG. 30A) within its structural housing 523 to provide for either or both securely holding the brushes or for moving or driving a brush action to and/or through the brush head assemblies 526, 527) for cleaning and massaging of the user's teeth and gums. In use, the toothbrush assemblages 526, 527 hereof may provide a totality of brushing, cleaning and massaging of the user's teeth and gums.

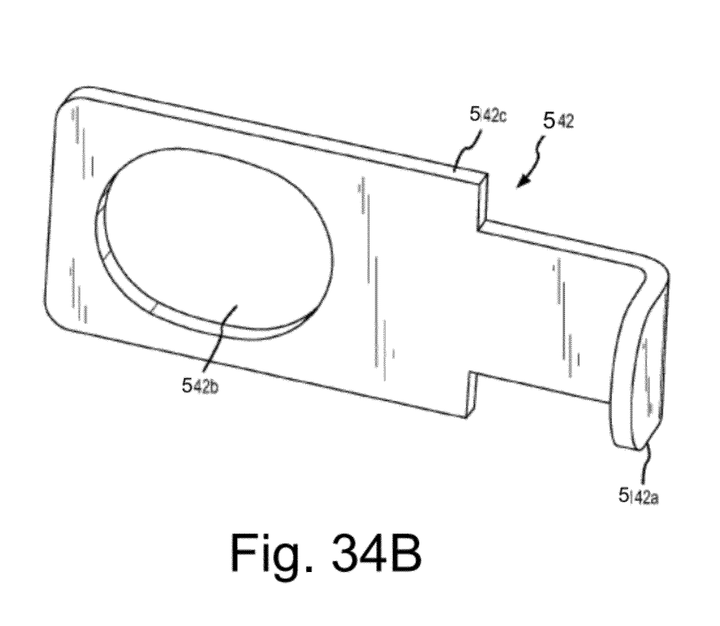

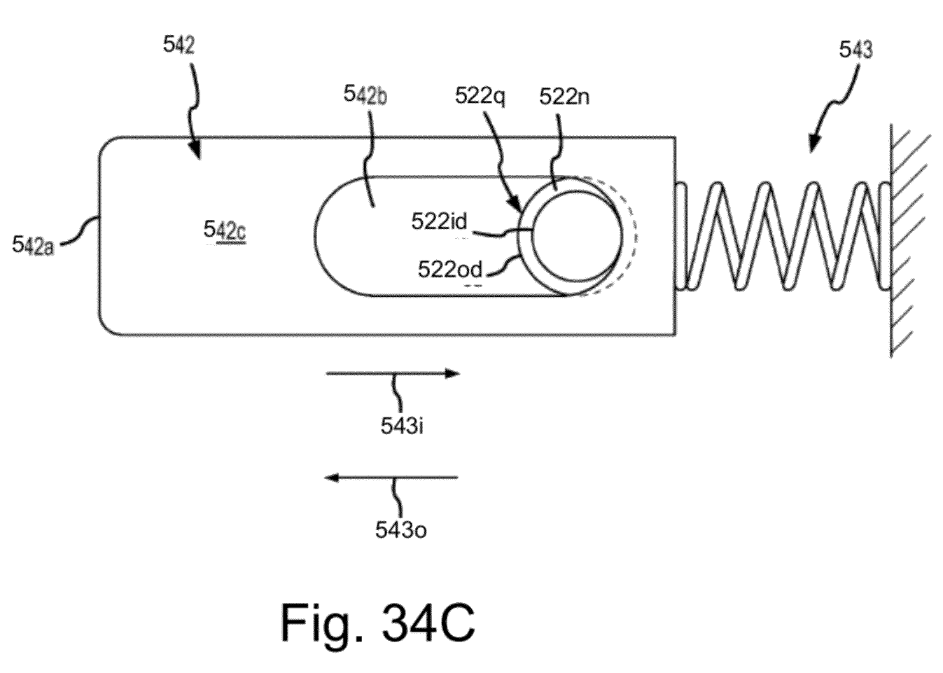

A handle 521 may then also include a connection configuration 525 which provides for connection of the one or more brush assemblies 526, 527 to the control handle 521. This connection may generally involve a shaft or shafts 522, one shaft being shown in FIG. 30A, namely, shaft 522a in the relative first position, and two shafts in FIG. 30B, the second shaft 522c in the relative second position; these shafts 522 stemming or emerging from the housing structure 523 of the handle 521, and then connecting or being adapted to connect to the brush assemblies 526, 527. Note, the relative first and second positions may be either top and bottom or side by side or any other orally useful position. Further details of brush mounting to/on a handle support assembly are shown and described below in particular relation to FIG. 34 (infra). Also as described in further detail below, the brushes may be made to be replaceable or interchangeable when and/or if desired and thus removably mountable on respective shaft(s) 522.

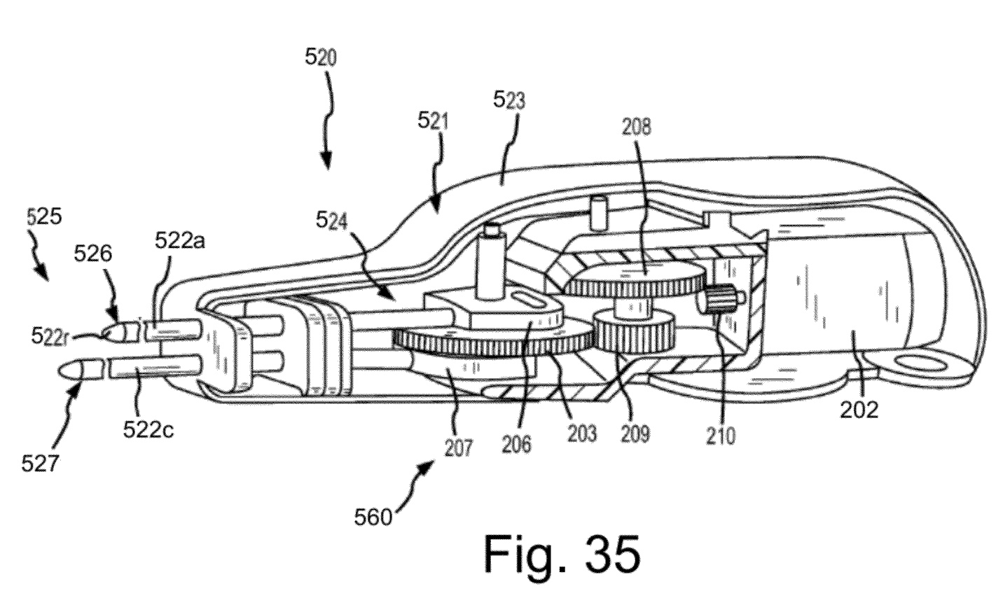

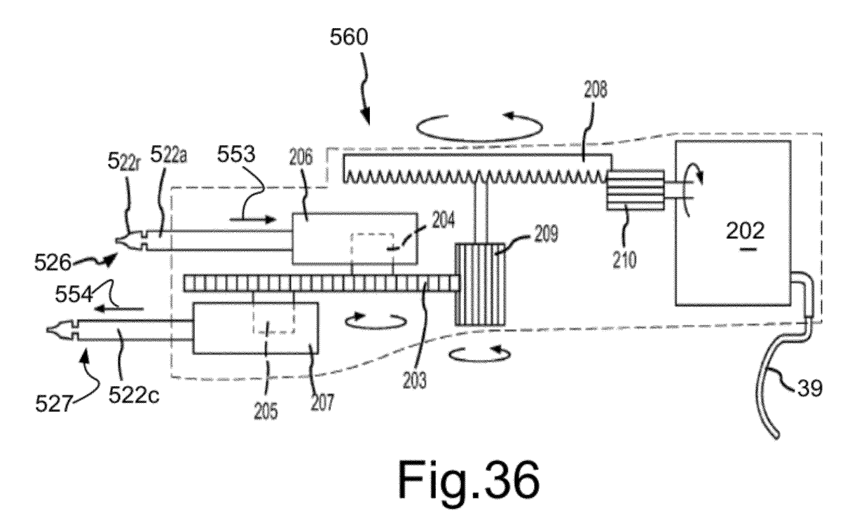

The action of the cleaning heads, or brushes or brush assemblies 526 and 527 may be manually maneuvered or activated, or as described further here, may more often and/or more generally be driven by a control assembly or assemblies 524, as by an mechanical sub-system 560 (see FIGS. 35, 36 (not unlike FIGS. 17 and 18)) and/or a motor (see motor 202 in FIGS. 35, 36 below, and 17 and 18 above). And, any one or more of these actions may be delivered with either a relatively fixed disposition of the brush arms and/or brush heads relative to each other, or as is further described herein for some implementations hereof, where as shown e.g., in FIGS. 35 and 36, the brush arms and/or heads may be reciprocated in a linear motion and/or in and out alternately and/or in opposition to each other (see FIGS. 35 and 36, inter alia)

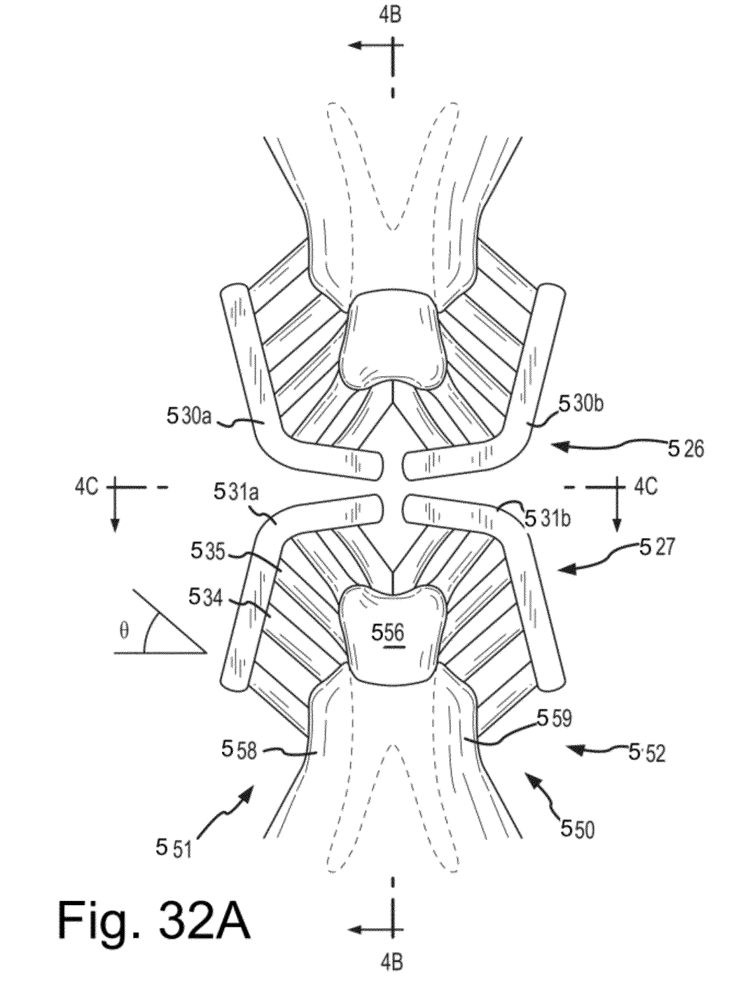

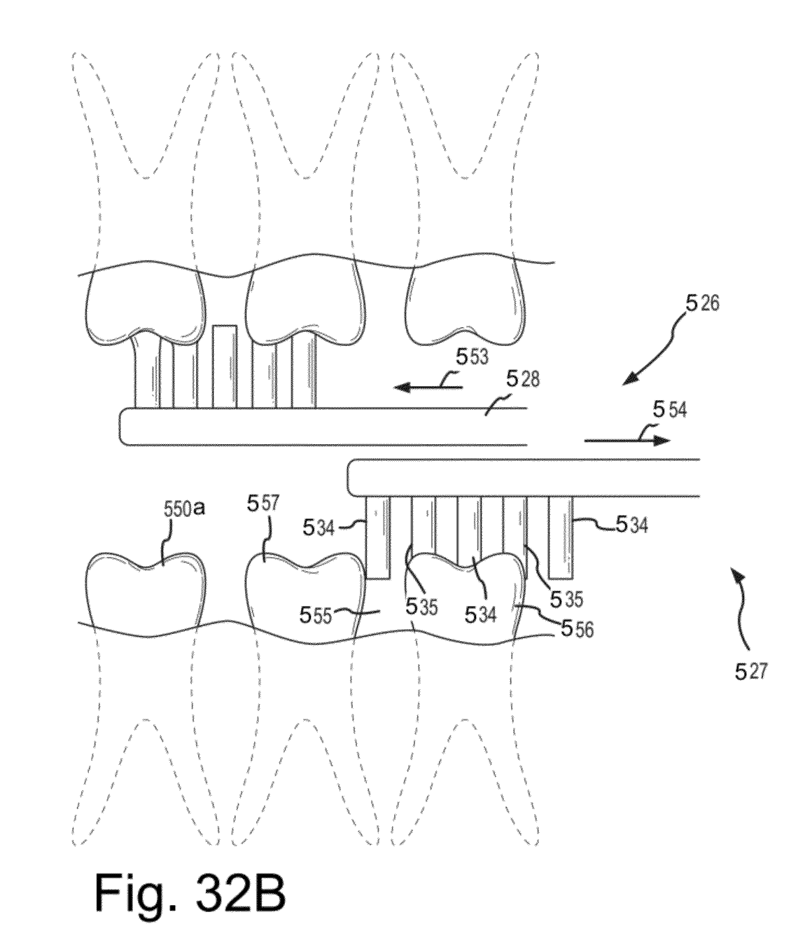

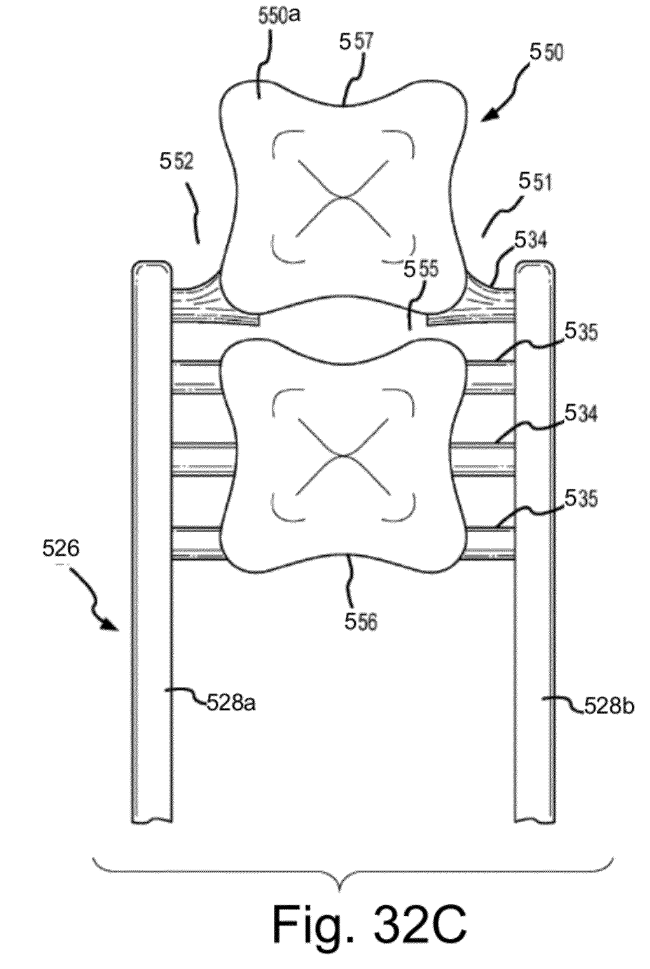

In any case, the brush heads may then be disposed to reach the teeth and gums in a desirable fashion as shown in and described relative to FIGS. 32A, 32B and 32C, below) to thereby brush away plaque and/or debris lodged in and/or between the teeth, and/or provide a vital massage of the gums, particularly adjacent the teeth. And as is further shown and described hereinbelow (see FIGS. 32 and 33), a motor 202 as described herein may be activated to provide movement, as for example a linear in and out movement as from FIGS. 35, 36 (like FIGS. 18, 19 and 20 above) via the shaft(s) 522, to the brush assemblies 526, 527 via mechanical system 560 which may in turn provide reciprocatable linear movement, see FIGS. 35 and 36. As mentioned above and as will be shown and described further below, the provision of reciprocatable linear movement into and out of the oral cavity may proficiently clean the teeth and/or gums and also provide for reaching the rear most teeth as well as all of those in between.

The brush heads 526, 527, which as shown in FIGS. 30-34, for one example has two brush arms 526a and 526b (similarly also for brush head 527). The bristles 534, 535 on the brush head 526 have the tips are formed into a multi-surface pattern, as shown most clearly in FIGS. 30-33. The bristles may be disposed such that the bristle tips fit into the interdental crevices even between teeth. In operation, the brush of FIGS. 30 and 31 may be moved back and forth in an approximate linear pattern, back and forth to clean the oral surfaces therewith they are in contact.

In actual use of the brush 500 or 520, and more particularly the head(s) 526 and/or 527, as shown representationally in FIGS. 30-34, the toothbrush is held so that the brush head 526 and/or 527 is approximately horizontal, with the tips of the bristles 534, 535 positioned against the side surfaces of the teeth 556, typically near the gum line. As indicated above, the bristles 534, 535 fit around the teeth, and into the portions of the interdental regions between teeth 556. The motion of the brush is in and out, i.e. linearly along the tooth or other oral surface FIG. 32, typically along the gumline.

The action of brushes or brush assemblies 526 and/or 527 may be manually maneuvered or activated, or may more often and/or more generally be driven by a control assembly or assemblies 524, as by a motor (see e.g., motor 202 in FIG. 17) and/or a mechanical system (see system 560, FIGS. 35 and 36). And, either of these actions may be delivered with either a relatively fixed disposition of the brush arms and/or brush heads relative to each other, or as is further described herein for the primary implementations hereof, where as shown e.g., in FIG. 30, the brush arms and/or heads may be reciprocated, as shown, such that the brush assemblies 526, 527 may be disposed so that one is adapted to move inward relative to the mouth while the other is adapted to move outwardly; also in FIG. 36, wherein, the brush 526 moves or is moving inwardly relative to the mouth (outward from the handle 521), see direction arrow 553, while the brush 527 moves outward relative to the mouth (inward toward the handle 521), see direction arrow 554. Then, in an opposite reciprocal movement, not directly shown, the brush 526 moves outward mouth-wise direction, while the brush 527 moves inwardly, in the opposing direction. Thus, the brush heads may then reach the teeth and gums in a desirable fashion as shown in and described relative to FIG. 35, above) to thereby brush away plaque and/or debris lodged in and/or between the teeth, and/or provide a vital massage of the gums, particularly adjacent the teeth. And as is further shown and described hereinbelow (see FIG. 35), a motor 202 as described herein may be activated to provide movement to a mechanical system 560 which in turn provides movement, via the shaft(s) 522, to the brush assemblies 526, and if used also, 527. As mentioned above and as will be shown and described further below, the provision of reciprocatable linear movement into and out of the oral cavity may proficiently clean the teeth and/or gums and also provides for reaching the rear most teeth as well as all of those in between.

As initially shown in FIG. 30, but, also in more detail in FIG. 32, each device 520 may include one or more brush or other cleaning head assemblies, here shown as brush assemblies 526, 527, assembly 27 being an alternative additional assembly like that shown in FIG. 30B, which each may include one or more brushes, here see the brushes 526a, 526b of a brush assembly 526 in FIG. 31-33, each such brush 526a, 526b having respective brush arms 528a, 528b and brush heads 530a, 530b. The brush heads, e.g., heads 530a, 530b, may then be disposed such that adjacent brushes or sets of bristles may be used simultaneously during a brushing action. Combining multiple sets of brushing actions may provide better simulation or replacement of interproximal brushing, flossing, and/or perio-picking and/or using proxy brushes. Moreover, it may be noted that the action shown and described relative to FIGS. 31-33 (including the sub-parts thereof) may be exemplary of attainment or simulation of either or both the Bass and ADA methods for tooth brushing technique. The brushes shown may be reciprocated with the substantially linear movement of FIG. 31-33, below, and may be limited in length of stroke of about tooth wide, or about 0.25 inches (in some implementations on the order of between about 0.18 and about 0.25 inches).

The brushes are, in many implementations hereof, see FIG. 31A, e.g., brushes 526a, 526b, disposed such that the brush heads, see e.g., heads 530a, 530b, may be disposed in or have portions thereof predisposed in a relatively/substantially preselected angular disposition to appropriately impact the teeth and gums, the intersection thereof and/or any gaps therebetween at a desirable location, height, and width thereof. As such, the heads 530a, 530b may have respective head portions, namely, side portions 536a, and crown portions 536b. These brushes 526a, 526b can then contact the teeth from one or all sides of an array of teeth 550 (see FIG. 32), see e.g. the outside or cheek or bucal side 551 toward the other side, e.g., the inside and/or tongue or lingual side 552 of an array of teeth 550 and/or the crown or occlusial side 550a as shown for example in FIGS. 32A, 32B and 32C.

The side portions 536a and crown portions 536b of the heads 530a, 530b may thus be disposed to have bristles 534, 535 (see discussion below) disposed in an angular disposition, see angle θ in FIG. 32A which may thereby provide a relative desirable cleaning action on the respective side surfaces of the teeth with which the tips of the bristles 534, 535 may more effectively come into contact. As shown in FIG. 32A, the bristles 534, 535 are shown angled downward to provide a potentially desirable impact of the bristles 534, 535 with the gum line intersection of respective gums 558, 559 with a tooth 556, for an example. This may include an angle θ at approximately a 45 degree angle (plus or minus) for the side bristles in accordance with the dental professional recommended Bass or modified Bass technique, moreover, also according to this technique, a quantity of bristles may be disposed on or impact with the teeth (as for example approximately one-half in some implementations) and another quantity of bristles on or in contact with the gums (in some cases as much as one-half the bristles). The crown bristles shown in FIGS. 31 and 32A may also be angularly disposed, though perhaps not at the approximate 45 degrees as those on the side (rather, more like a larger angle relative to the horizontal or smaller relative to the vertical orientation shown in the drawings).

It may also be desirable to provide an interaction of long bristles 534 of brushes such as brushes 526a, 526b particularly so as to substantially completely impact the deeper areas of teeth and between teeth, while having shorter bristles 535 impact the less deep, more prominent portions of teeth. For example, the long crown bristles 534 of adjacent brushes 526a, 526b may cover the interior depressed portion of the chewing or occlusial surface of the tooth, see e.g., tooth 556 in FIG. 32A, and the shorter crown bristles 535 (see FIGS. 31B and 32A) may impact the less deep extended tooth edges. Note the shorter bristles 535 may also be at a discrete angle, e.g. angle α in FIG. 31B, less pronounced than that of the longer crown bristles 534 (crown bristles 534 e.g., preferably, at something like about 5 to 20 degrees from the vertical, with the crown bristles 535 being less, from about 0 to 10). E.g., an angle α of about 14 or 15 degrees is shown and may be used. The shorter crown bristles 535 may thus be intended to impact and clean the higher, non-depressed, outer surfaces of the tooth. Moreover, it may be that the angle of the bristles on the crown portion 536b of the respective brush head 530a, 530b may be different, more or less than that of the side portion 536a bristles. Any combination of alternative angular dispositions may be used with the brushes of the present invention.

Other views of bristle dispositions are also shown, particularly of the side bristles 534, 535 in the isometric and elevational views of FIGS. 31A and 31B, as well as in the respective cross-sectional elevation and plan depictions of FIGS. 32B and 32C (as taken along respective lines 4B-4B and 4C-4C of FIG. 32A). Moreover, these uneven bristles, i.e. long bristles 534 and short bristles 535, as shown in FIGS. 31 and 32, provide bristle tip coverage of the uneven side surfaces of the tooth. For example, see the respective long and short bristles 534, 535 on the uneven side surfaces of FIG. 32A and on the uneven side surfaces of FIG. 32C. As indicated above, and as shown in FIG. 32A, these bristles may even be angled on the otherwise relatively flat crown or chewing surface of the tooth to get full coverage of the tooth surface.

In the use of angled uneven length bristles 534, 535, the bristles may first be brought into contact with the tooth, then movement of the brush and thus also of the bristles, thereby brings the different length bristles into contact with the various uneven portions of the tooth surface, at various points the long bristles are brought into contact with deeper surfaces or interproximal areas between teeth or between a tooth and gum, and the short bristles also at times being brought into contact with the less deep, more prominent surfaces, the bristle tips in both cases being brought to full, non-interfered-with usage on the respective surfaces of the teeth, the bristle tips rather than the respective sides of the bristles. The angled disposition assists by substantially simultaneously directing the bristle tips toward the surface-to-be-cleaned and resisting bending of the bristle which would lead to the bristle side coming into contact with the tooth surface rather than the bristle tip.

More particularly in a structural implementation, and, as initially shown in FIGS. 30, 31 and 32, each device 520 may include one or more brush or other cleaning head assemblies, here shown as brush assemblies 526, 527 (see FIGS. 30B, 32A, 32B and 33C for assembly 527), which each may include one or more brushes, here see the brushes 526a, 526b, of respective brush assemblies 526, 527, each such brush 526a, 526b having respective brush arms 528a, 528b and brush heads 530a, 530b (see FIG. 31A). The brush heads, e.g., heads 530a, 530b, may then be disposed such that adjacent brushes or sets of bristles may be used simultaneously during a brushing action. Combining multiple sets of brushing actions may provide better simulation or replacement of interproximal brushing, flossing, and/or perio picking and/or using proxy brushes.

Also directed to a maximal bristle cleaning activity may be an option of flexible, resilient brush arms, e.g., arms 528a, 528b, which can contribute to the preferred maintenance of the tips of the long and short bristles 534, 535 in contact with the respective deeper and shallower tooth portions by alternately flexing outwardly during an encounter with a wider tooth or shallower oral feature and then upon encountering a deeper or narrower feature, flexing or resiling inwardly to reach inwardly toward the deeper surfaces and/or the narrower teeth. This may be a part of providing for disposing the brushes in a preselected typically optimal brushing position. And, even the trim of the bristles may contribute to this maintenance of a desired bristle angle. As such, the trim at the tips of the bristles may be angled to be parallel to the tooth surfaces (see each of the views of FIG. 31). Moreover, the short and long trim of the bristles, which as otherwise described herein is primarily directed to reaching all the uneven surfaces of the teeth, including the interproximal areas, may also contribute to maximal cleaning because if all bristles were the same length, then upon reaching a raised area, the bristles would be deflected to present the sides of the bristles against the surfaces of the teeth and the sides of the bristles are not as capable of cleaning as the tips. Thus the bristle tips, as opposed to the bristle sides, are preferred to remain on or in contact with the enamel, with the long bristles also being adapted to reach into the interproximal areas without interference or with minimal interference or obstruction of the shorter bristles by long bristle sides on enamel surface. Note, long toothbrush heads, and/or overly voluminous bristle packing on a head can also yield problems like this, where rather less bristles may be better because the interference from adjacent bristles may be minimized. Rather accurate positioning (often very or ultra accurate positioning) of bristles is favored in the present implementations as opposed to the provision of an overabundance of bristles (such as is provided in some prior art brushes in an attempt or aspiration for hopefully some or any bristle(s) to hit the mark).

In some implementations, in order to effectively substantially eliminate human error, the present brushes may provide a relative “self-positioning” of the brush arms, brush heads and bristles relative to the teeth and gums. Self-positioning may involve disposition relative to an oral feature such as a tooth or teeth and gums, and/or may involve in and out positioning as well as swiveling heads. The in and out positioning may primarily be a result of resilient brush arms which allow for spreading of the heads away from each other when encountering a wide tooth and resiling back inwardly toward their original position when narrower surfaces are encountered. The width of the tooth can then limit the full amount of resiling, thus, the tooth determines the position; i.e., self-positioning the brushes. The heads may also have resilient characteristics, e.g. of the side relative to the crown and vice versa. The resilient arms and/or heads may thus provide for biting into the combination of brush heads, the resilience providing for applying substantially continuous force for the brush heads to continually close in on or appropriately squeeze toward the teeth large or small, spreading as necessary for the larger teeth. Note, the resiliency of the arms and/or heads may be selected so as to provide or apply a desirable, light yet operative pressure in the direction of bristles (maintaining the desirable angle, in some examples, about 45 degrees for the side bristles), not an overly aggressive or damaging force on the teeth and/or gums. Spreading is shown in FIG. 33A where a pair of brush heads 530a, 530b are shown as they might move outwardly (arrow 530c), downwardly (arrow 530d) or a combination of both (arrow 530e). Note also, this self-positioning particularly with resilient arms and/or heads may allow for smaller brushes to be used, where the user bites down and thereby moves the arms and gets a better fit around the tooth (a smaller brush perhaps also/alternatively being desirable due to the reduction of bristle volume and thus reduced bristle interference to maximize bristle tip effectiveness).

A swiveling positioning may include such resiliency, allowing relatively independent twisting or rotation of one or the other or both of the arms upon encountering an obstruction. This is shown in FIG. 33B (rotational arrows 530f and 530g). Moreover, a swivel positioning may include the swivel of the whole head assembly right and/or left, and if two heads are used then the swivel may be of both heads substantially simultaneously, see clockwise rotation/swivel 530h in FIG. 33C.

Rotation may thus be available for each of the head assemblies 526, 527 about the respective shaft ends 522a, 522c (FIGS. 30A and 30B) on and to which the assemblies are mounted. Self positioning of these sorts may thus provide for easily and substantially automatically obtaining and maintaining the Bass position for teeth and for simplifying use in manipulation of the handle 521 for the human user and reducing or eliminating human error.

In use with two or four wrap-around brushes, such as those shown in FIGS. 30-33, two brushes in the first brush assembly 526 which here may be for the top teeth and/or one or two in the second brush assembly 527 (see FIG. 30B) which here may be for the bottom teeth, the user may simply bite into the brushing heads 526, and/or 527, and self-positioning may be substantially automatic as the brushes position themselves or are otherwise positioned to substantially correctly contact tooth and gum surfaces (see FIGS. 32 and 33), deviations accounted for by the resilient arms and/or the swiveling heads (see FIG. 33, e.g.). Alternative side-to-side or other orally effective relationships of brushes 526, 527 may be used instead. Thus, the brushes can achieve the dental professional recommended Bass technique placement of bristles on teeth and gums, with the side contacts being at approximately a 45 degree angle (see FIG. 32A) or otherwise as may be desired. Each brush unit 526, 527, e.g., may have user specific dimensions, or may, due to the self-positioning described here, be fit for use in any user's mouth for bristle contact of every or substantially all to-be-cleaned surfaces of the user's teeth and gums and may provide interproximal, gingival and/or sub-gingival contact while assuring that the brushing action does not include an overly aggressive bristle force. Such self-positioning may be achieved substantially automatically with or without the user's knowledge, understanding or active participation, as it is the width of the tooth or teeth which, in limiting the amount of resiling of the brush arms and/or heads, is actually achieving the self-positioning.

Another part of the Bass techniques recommendation includes the alternative to reciprocate the brushes in short (e.g. tooth-wide or less than about 0.25 inches, or in some cases between about 0.18 and about 0.25 inches), quick, back and forth strokes while applying light pressure in the direction of bristles. Note, such short strokes avoid the sweeping scraping which can lead to trenching (up and down strokes were once taught in an effort to avoid trenching); but, further such linear in and out strokes provide better cleaning The bristles can bend and/or flex and move little, yet still bring sufficient action to bear upon and clean or dislodge debris. Accordingly, the device 500 or 520 hereof can, and in many preferred implementations will be adapted to provide a defined stroke that imparts either a single sided linear in-and-out or and an alternating side-to side or top and bottom brushing, as shown in FIGS. 35 and 36 (not unlike FIGS. 17, 18), for example, with a first stroke 553 in a first direction with a return in the opposite direction. And, in some implementations with alternating motions (FIGS. 35, 36, 17 and 18), one brush assembly, e.g., assembly 526 moving in the first direction 553 while a second brush head, e.g., assembly 527 is moving with a second stroke 554 in the other direction (see particularly FIG. 36). The alternating stroke (out-to-in of one assembly simultaneously with in-to-out of the other assembly) can be desirable for a variety of reasons, these reasons and exemplar sub-assemblies adapted to provide such strokes are described further below. It may be that approximately 650-850 strokes per minute may provide the most effective results. Such speeds can be highly desirable, particularly as the strokes provide enough time for the bristles and particularly the bristle tips to react resiliently to move from one location to another and then have their bristle tips strike at debris trapped in a space, e.g., interproximal space 555 between the teeth, see e.g., teeth 556, 557 (FIGS. 32B and 32C) which debris might then be trapped at or near the mid-point and thereby loosen the debris more efficiently with a back and forth action so that the debris may be cleared therefrom. Shorter strokes (less than or equal to about 0.25 inches) and slower speeds such as these (650-850 strokes per minute as compared with or opposed to 3 to 30 thousand (3-30 k) strokes per minute of some conventional power brushes, e.g., so-called sonic brushes) are also more gentle, providing massage-like contact as opposed to dental drill-like, high-impact speeds.

Note also, in some implementations, it may further be desirable to optionally though not necessarily include use of a dentifrice, tooth paste, flavor concentrate etc. To do this, the dentifrice may be delivered with, i.e., added to the brush or brush bristles in substantially conventional fashion and thus move with the brushes into the user's mouth and thereby be applied to the teeth and/or gums.

The respective brush assemblies 526, 527 introduced and shown above, may be unitary appliances (e.g., the one brush head 530 including the side and crown brush portions 536a, 536b), or may as shown in FIG. 31, be respective assemblies of one or more brushes, as for example the brushes 526a and 526b of FIG. 31. Each of these brushes may in turn, also as shown and described above, each include arms 528a, 528b and heads 530a, 530b. Note, as identified in FIG. 34A, it may be desirable to include a relief, reduction and/or other curvature feature in the arm(s) 528 to avoid less desirable impact of an arm 528 on/with the teeth in use. The heads 530a, 530b, may also have respective head portions 536a, 536b (side, crown) (see also FIG. 32) with respective drill holes (shown but not identified in FIG. 34A) (side, crown) to receive respective tufts (side, crown) of bristles 534, 535.

The respective brush assemblies 526, 527 may also include respective brush bases 540 (see the respective assembled base 540 in FIG. 31A as well as the parted components of bases 540 in FIGS. 34A, 34B and 34C) for connection of the respective brushes together, and/or for connection of the brush assemblies to the control handle 521 and/or shaft(s) 522. The bases 540 may be initially separate devices or may as shown in FIG. 34 be separate portions 540a, 540b and 540c formed as separate parts, portions 540a and 540b formed as integral parts of the respective brushes 526a and 526b and portion 540c as a separate base piece. A variety of connection features 541 (e.g., posts and/or receiving holes therefor) may be included within the various portions 540a, 540b and 540c to provide for the connection of the brush portions 540a, 540b and 540c together. These portions may then be connected by snap fit, snug fit, friction fit or welded, e.g. sonically-welded, or glued or otherwise adhesively or cohesively or otherwise put and held together.

As shown in FIGS. 34B, and 34C, a push-button device 542 may be included within the base 540 within its own slot defined in one or more of the base portions 540a, 540b and 540c. The push button 542 may preferably be spring-loaded counter the release direction, as by a spring 543 (shown schematically in FIG. 34C) adapted to be disposed in a spring feature 543 in the base 540. The push button device 542 may have a push button surface 542a to be disposed outside the base 540 and connected hereto, an internal structure 542c with a cutout feature or ring 542b here shown as a sort of elliptical cutout. As shown in FIG. 34C, the push button device 542 may be engagable with the quill end 522q of a shaft 522, e.g. shaft 522a (see FIGS. 30B, 35 and 36). The quill end 522q may have a slot or notch 522n with inner and outer diameters 522id and 522od (FIG. 34C) which together define the slot. Engagement as shown in FIG. 34C may then be had when the edge of the cutout feature 542b clips into the slot 522n, and the spring 543 resiles back in the direction 543o under its spring force.

Disengagement of the quill end slot 522n from the cutout feature 542b may be effected by pushing on the push-button surface 542a in the direction 543i against the bias of the spring 543 which then allows for the outer diameter 522od to enter and move through the cutout feature 542b thereby allowing for removal of housing 540 and brush assembly 526 (or 527) from the shaft 522. Opposite engagement may be had by pushing the housing 540 onto the shaft 522 such that the quill end thereof enters the cutout feature 542b and the ramp surface 522r of the quill end engages the cutout feature and causes movement thereof against the bias of and compressing or otherwise deforming the spring 543 as the edge of the cutout feature rides along the incline of the ramp until the slot 522n is reached at which point the spring 543 pushes back against the push-button device 542b to engage the edge of the cutout feature with the slot as shown in FIG. 34C.

The tooth brush assemblies 526, 527 may thus be removably mountable on the shaft(s) 522 and thereby replaceable if and/or as they may be spent, or the assemblies 526, 527 may be interchangeable so that each of a plurality of users may each also have his/her own brush heads for sanitary reasons. Alternative cleaning head assemblies may be interchangeably used herewith as well. Or, different sizes may be made available (for plural or singular users), e.g., smaller brushes can provide a better fit around particular teeth, or for particular users, smaller brushes perhaps being more comfortable as well, and/or providing fewer bristles and thus reduce bristle interference.

Moving shafts for moving the cleaning heads 526, 527 will now be described. For example, in FIGS. 35 and 36, are depictions of isometric cut-away views of alternative handles 521 of exemplary units 500 or 520 which each provide for moving one or more cleaning assemblies 526, 527) on respective shaft ends 522a, 522c of a connection assembly 525. More particularly, the structural shaft ends 522a, 522c may be disposed in reciprocal motive disposition in and emanating from the control handle 521. Note, the shaft ends 522a, 522c may be relatively integral or contiguous with or otherwise as shown and described above, may be connectable with brush assemblies 526, 527. More particularly, as shown, the brush assemblies 526, 527 may be disposed so that one is adapted to move inward relative to the mouth while the other is adapted to move outwardly. This is shown in FIG. 36, e.g., wherein, the brush 526 on end 522a moves or is moving inwardly relative to the mouth (outward from the handle 521), see direction arrow 553, while the brush 527 on end 522c moves outward relative to the mouth (inward toward the handle 521), see direction arrow 554. Then, in an opposite reciprocal movement, not directly shown, the brush 526 on 522a moves outward mouth-wise direction, while the brush 527 on end 522c moves inwardly, in the opposing direction.

Inside the control handle 521 may be one or more control assemblies 524 which may include conventional or unconventional reciprocation hardware. As a first example, a direct current (DC) motor 202 may be included to provide primary power to reciprocate the brush head assemblies 526, 527. The motor 202 may activate a mechanical system 560 such as a system of gears, to ultimately move the cleaning head assemblies 526, 527. The system 560 may be a double reciprocal/opposing movement like that described and shown in FIGS. 35, 36 which may include mechanisms like a crown gear 208 connected by a shaft to a reduction spur gear 209 which communicates in gear meshing relationship with a double cam gear 203 (see FIGS. 35 and 36). The DC motor 202 is adapted to directly turn a pinion gear 210 which in turn, turns the crown gear 208 and thence gear 209 is turned and turns the cam gear 203 which in FIGS. 35 and 36, is a double cam gear 203. The gear 203 may have one cam 204 in a single cam example (not shown here), or in a double cam example, respective cams 204, 205 one each on opposite sides of the gear 203 (see FIG. 36). The upper first side cam 204, the double cam gear 203, and second side cam 205 may be separate parts or may all be combined as one piece. Structural shafts/arms 522a and optionally also 522c may be attached to cam followers 206, 207. The single cam gear contacts and moves a single cam follower 206 to drive the single shaft 522a in FIGS. 35 and 36, and the double-cam big gear 203 which may thus by contact move the two cam followers 206, 207 to move in and out the shafts 522a, 522c in FIGS. 35 and 36 relative to the power handle 521. Thus, this causes either one or both the structural shafts 522a, 522c to reciprocate in opposing directions and thereby provide for alternating dispositions of the heads 526, 527, the positions and directions being substantially and reversibly in opposition such that at one moment, the heads are as shown, and then they may be reciprocated such that they switch relative positions inside the mouth. FIGS. 35 and 36 show one position where the shaft 522a is further retracted within the handle 521 while the other shaft 522c is extended. The shafts 522 thereby further provide this reciprocatable linear movement to the brush head assemblies 526, 527 to alternately move into and out of the oral cavity in order to desirably clean the teeth and/or gums.

Note, in some examples the brush assembly 526 may be reciprocated alone; however, in the two head example of FIGS. 35 and 36, the two top heads 530a, 530b (FIGS. 30-33) on the brush assembly 526 may as shown preferably be reciprocated together and the optional other, lower two heads 531a, 531b (FIG. 32A) of the brush assembly 527 may be reciprocated together in opposed relationship to the upper heads. In many cases with devices 500 or 520, such alternate reciprocal moving part implementations having respective opposing parts moving contrary to each other may provide balance to the overall device. In many implementations, the force balance of alternating reciprocation can provide for a static handle at the same time as the brushes are dynamically cleaning In any two opposed brush orientations, the opposing brushes may be moving substantially simultaneously in opposite directions, one out while the other is moving in and vice versa. Reciprocation of top and bottom (and/or side to side or other arrangement) in opposite directions may provide substantially simultaneous action and reaction in and out, and this force action and reaction can cancel each other out so that net motive force on the handle 521 is substantially zero and the handle 521 thereby remains stationary. The mechanical force counterforce, i.e., the force(s) tending to push the brush heads further in, or out of the mouth simultaneously provide at least a reduction of the overall forces felt by the user who may then be able to operate the device simply by and through the use of a simple/minimal grasp of the handle 521 with the thumb and forefinger. This overall action/reaction may also provide a further advantage in the self-positioning described above, overcoming the reciprocal brushing action to allow the brush head and bristle design to achieve and maintain the desirable self-position (FIGS. 31, 32 and 33) unforced away therefrom by the motor driven reciprocation. Also in these and/or other two (or more) brush implementations, though at least two such brushes may move in opposing reciprocation together, it may be possible to have contrary alternating movements whether for relative top and bottom movements contrary side versus side movements.

As mentioned above, the device 500 or 520 can provide alternating brushing, with, as shown in FIGS. 35 and 36, a first stroke 553 in a first direction with a second stroke 554 in the other direction. And, approximately 650-850 strokes per minute may provide the most effective results. Such alternating stroke speeds can be highly desirable as the strokes may have enough time for the bristles to react resiliently to move from one location to another and then strike at debris trapped in a space, e.g., interproximal space 555 between the teeth, see e.g., teeth 556, 557 (FIGS. 32B and 32C) which debris might then be trapped at or near the mid-point and thereby loosen the debris more efficiently with a back and forth action so that the debris may be cleared therefrom. Slower speeds such as these can be also more gentle, providing massage-like contact as opposed to dental drill-like, high-impact speeds. The slower speeds here rely on accurate bristle positioning to obtain effectiveness, and as a result, the brushes can reciprocate at a fraction of the speed of other products, resulting in user enjoyment of a comfortable massage with every use. Note, multiple or multi-speed options may alternatively be made available in these or other ranges of strokes per minute. In many cases, one speed is acceptable, but optionally one or more slower speeds can be offered particularly for beginners to become accustomed to the action. Faster speeds may also be offered.

An assembly such as this may be adequate for twin cooperative goals of efficaciously brushing the occlusial and lingual-bucal surfaces of the teeth and gums (including gaps between such surfaces and/or between the teeth and gums) while also simultaneously brushing the aforementioned surfaces and also the underlying gums. An aspect hereof may thus be the provision of an improved powered toothbrush for simultaneously efficaciously brushing the occlusial and the lingual bucal surfaces including any gaps therebetween while simultaneously beneficially brushing the teeth surfaces and also the underlying teeth/gums, the latter benefit representing therapeutical prevention of periodontal problems.

FIGS. 37-39 show alternative automated oral care or tooth and/or gum cleaning devices or assemblages 500 which may be integrated or unitary or substantially unitary devices or may be adaptable or adapted to be detachably attachable or integratable combinations of what may otherwise be a dry handle and cleaning head sub-assembly 520 (such as those shown and described in FIGS. 30-36) together with an irrigation assembly 620. These are particularly shown as connected in FIGS. 37A, 37B and 37C, and disconnected in 37D and in exploded views in FIGS. 37E and 37F. As mentioned, the cleaning head or brushing unit 520 may either be pre-attached or detachably attachable to or integratable with the irrigation unit 620, and/or it may be that the irrigation unit 620 is adapted to receive and/or otherwise be connected to the brushing unit 520. This may then create an integrated and/or portable, self-contained oral care device needing no outside surfaces or other structure for the use of the device. Herein, integrated, self-contained, portable or movable in use when used in reference to the combination cleaning assembly 520 and irrigation assembly 620 carries this meaning of a combination device needing no other structure (other than a human hand to hold to the oral cavity) for use. The connection may be effected by a strap or other connective structure 580 which may be adapted with a strap end 582 to engage one or more catches or other receiving/latching members 581 (see FIG. 37C, e.g.).

In the implementation of FIG. 37, the brushing device is/may be substantially similar to that which was shown and described relative to FIGS. 30-36 including generally a handle 521 with a housing 523 and a brushing head assembly or assemblies 526, 527 (these being shown in dashed lines in FIG. 37B). The irrigation assembly 620 includes a pump and reservoir module 622, and an irrigation/nozzle unit 640, which is interactive with and/or connected to either or both the brush head assembly/ies 526, 527 which may in one or more implementations also include an optional multiple directional brush head arrangement (herein generally referred to in any of these implementations as a “cleansing head assembly 526”), which positions the nozzles in operative disposition. The pump and reservoir module 622 then provides pumping of water for driving the jet action through the nozzle assembly 640 for cleaning and massaging of the user's teeth and gums. Note, in some implementations, the toothbrush heads may be optional and/or not included in favor of nozzles only; however, with the use of an optional toothbrush head assemblage, the present developments may further provide a totality of brushing, cleaning, massaging and irrigation or flushing of a user's teeth and gums.

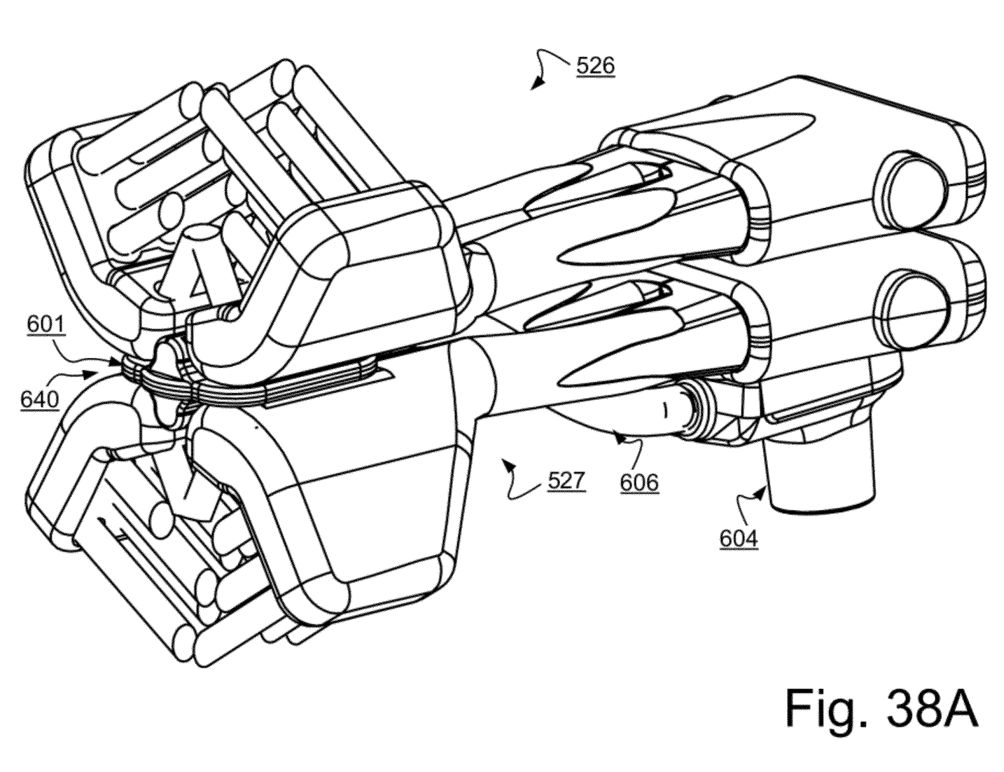

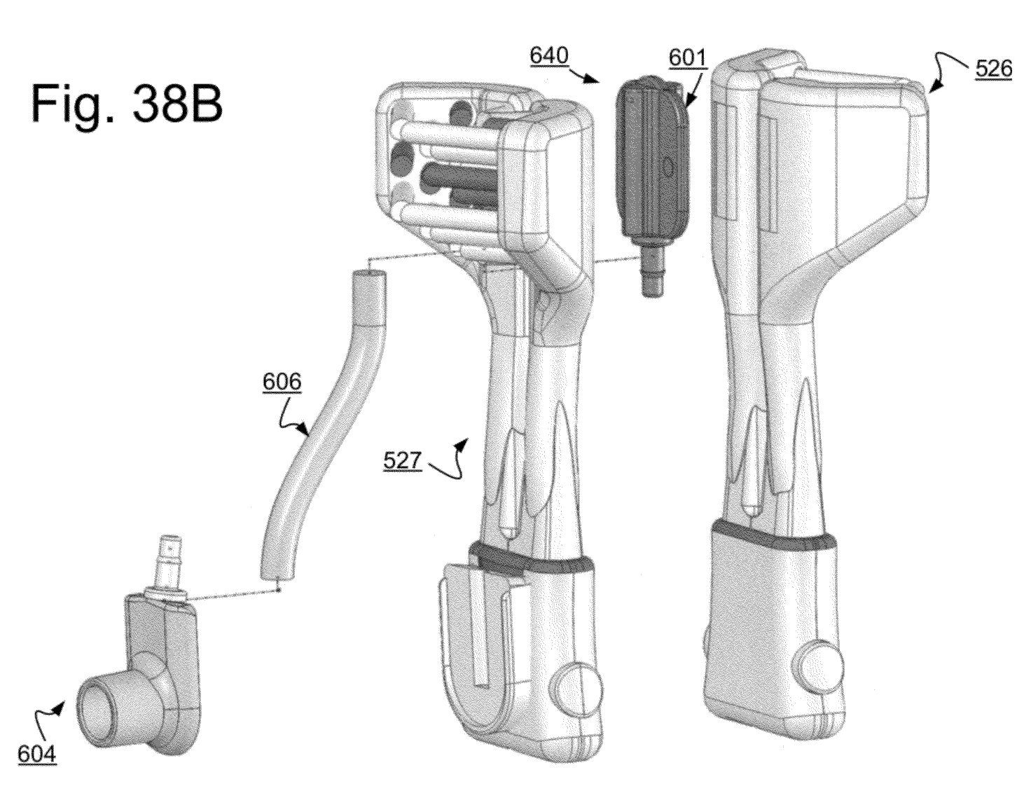

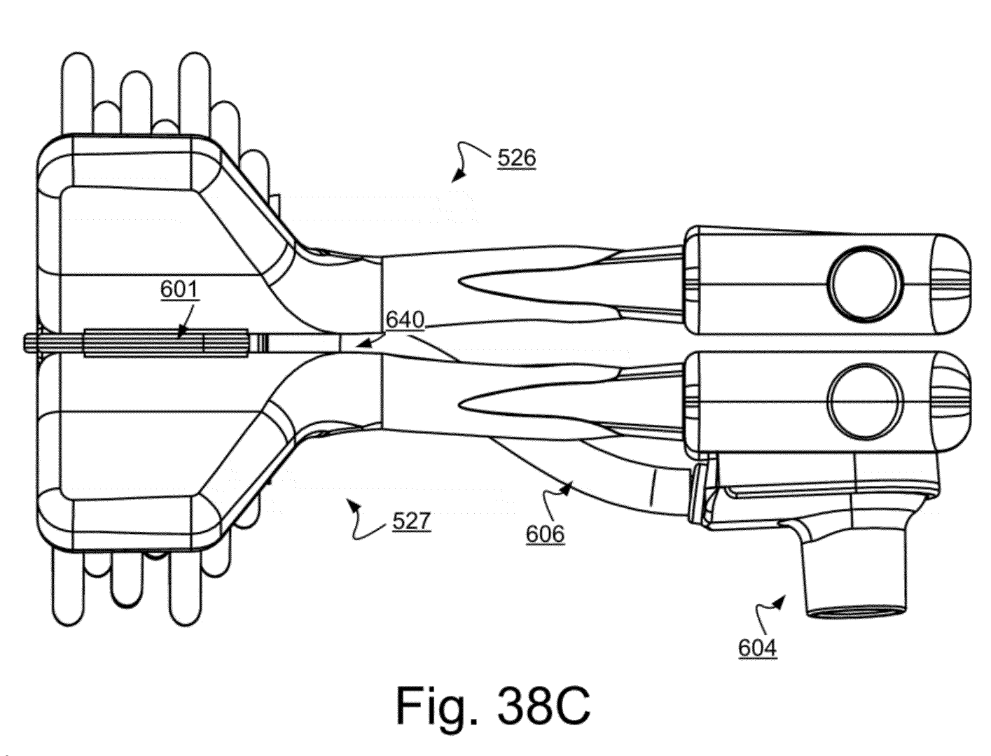

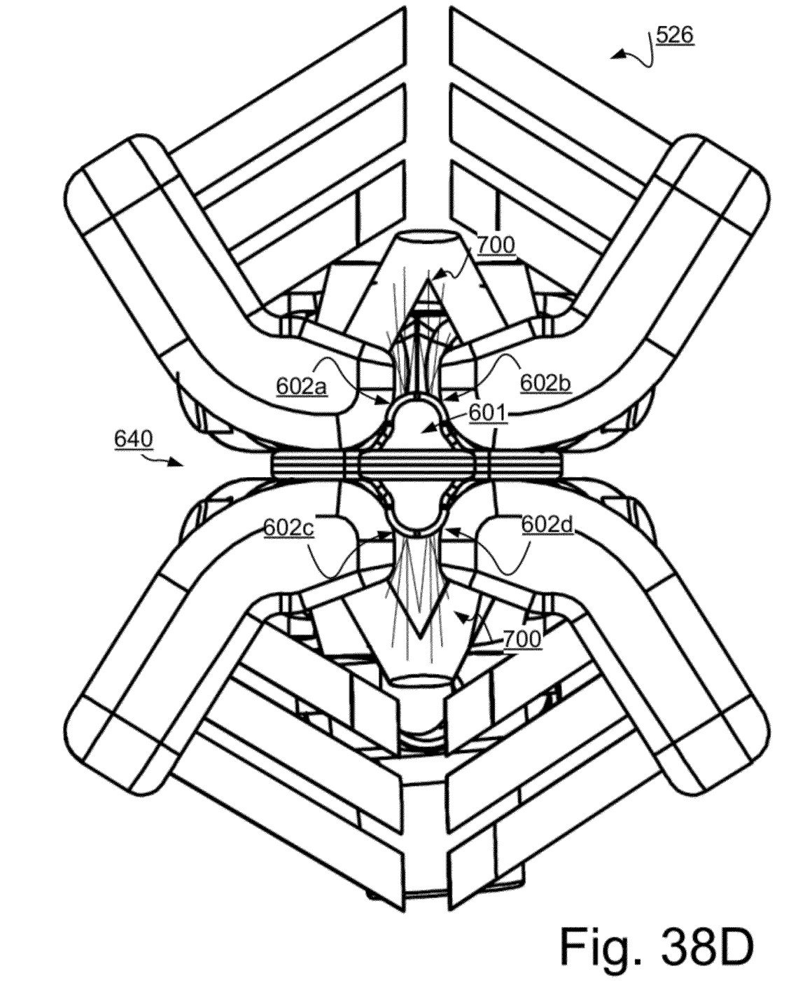

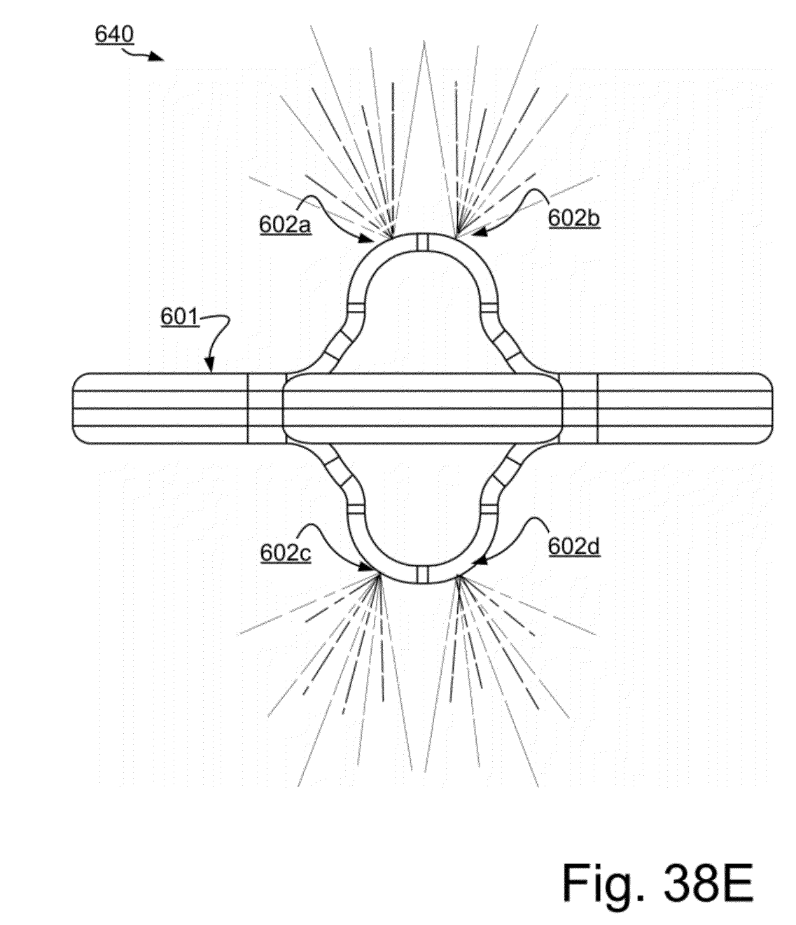

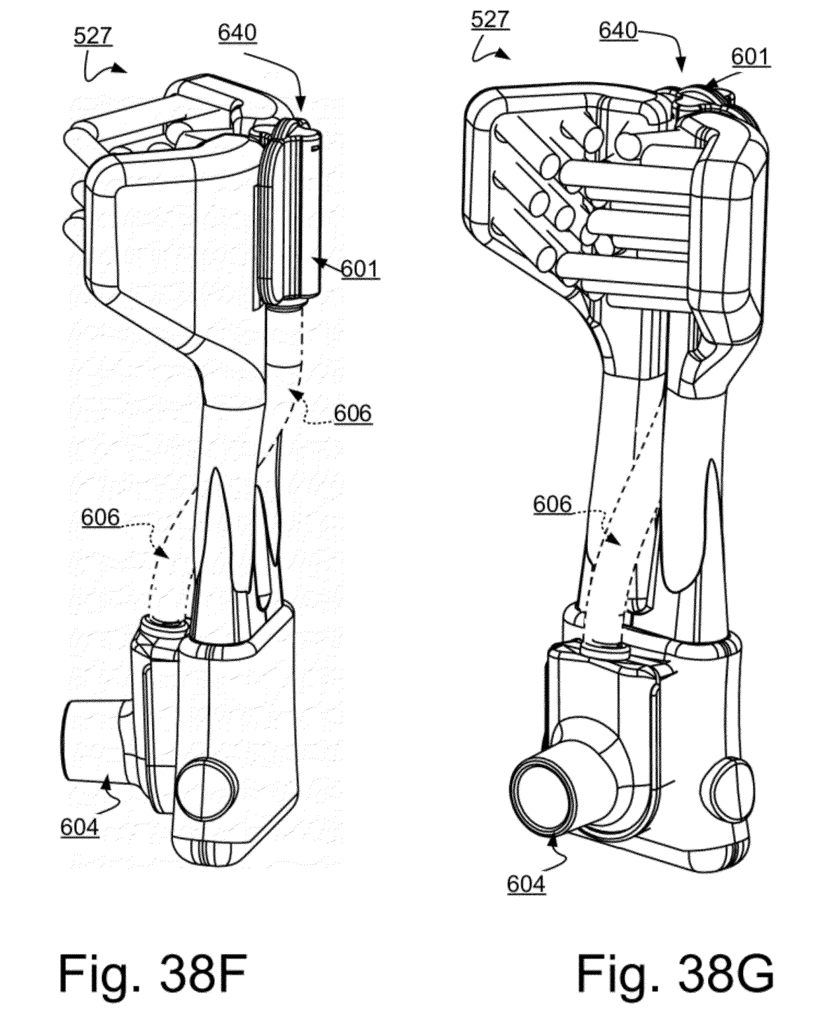

As will further appear from the below detailed description of the several sub-assemblies hereof in relation to the accompanying drawings, the device 500 may include a nozzle device 640, see more detail relative to FIG. 38, below, capable of having one or more nozzles. The details of the nozzle mounting are shown in FIG. 38, inter alia. The nozzles may be replaceable or interchangeable when and/or if desired.

The action of the nozzles may be pulsing or merely streaming, and either of these may be delivered from either a merely relatively stationary disposition of the nozzle device 640, or as the nozzle device 640 may be moved as is further described below in alternative implementations (see e.g., FIG. 38, inter alia) as for example could occur in conjunction with the brush heads of FIGS. 30-36 and 38, for example. A controlled water stream, whether streaming or pulsing may be delivered at room or tap temperature or alternatively heated to about 90 degrees Fahrenheit, for example (heating not shown). The stream or jets may then be provided to and through the nozzles (described further below), through the brush heads, to wash away the plaque and/or debris dislodged from and between the teeth by the operation of the device as well as providing vital pulsating (or streaming) massage of the gums, particularly between the teeth. If dentifrice is desired, it may be injected into and thus flow with the water stream or jets into the user's mouth. In addition, or in alternative, each user may also have his/her own nozzle device and/or brush heads for obvious sanitary reasons.

FIGS. 37D, 37E and 37F show more details of the irrigation sub-assembly 620, inter alia, sub-assembly 620 coming in some implementations integrated with, i.e., pre-connected and perhaps in some cases not disconnectable from a handle sub-assembly 520, but, in other implementations being a separate or separable entity which may be adapted to be attachable and/or detachably attachable to or otherwise integrateable with a handle sub-assembly 520.

The generation of the fluid flow, whether streaming or as pulsing jets are provided by a pump assembly, herein also identified generally as the pump and reservoir module 622 which may include conventional or unconventional pump hardware. When a pump, e.g., pump 630 (as shown in FIG. 37F) of module 622 is activated, it provides a water jet spray to the nozzle device 640 for the user for cleaning or irrigation of an oral feature (tooth, gum, space therebetween, or otherwise).

Each of the sub-assemblies will now be described in more detail. Referring again to the drawings, an exemplary oral hygiene device utilizing features of the present developments are shown in FIG. 37 and is identified by the general reference numeral 500 therein. As introduced above, an overall oral care device 500 may generally include an irrigation sub-assembly 620 which itself includes a pump and reservoir module 622, an oral irrigation unit 640 disposed on or adjacent an oral cleansing assembly 526 or assembly 527. The total assemblage 620 further includes connected to the control module 622, a fluid source or reservoir 623, pump 630, a drive motor 634, fluid conduit or conduits 636 and a power source 638, inter alia. A reservoir rear cover 623c seals the back end of the reservoir, and a filling portion 623a allows alternately for opening for fluid filling and sealing for ultimate oral care use. A rear pump module cap 622c and a front module cap 622a coact to seal the constituent operating members within the module 622. A pair of braces 621a and 621b may be attached to the front cap 622a and used to receive and connect to the brush handle device 520 via the strap 580, e.g.

A reservoir source 623, here shown (e.g., FIGS. 37E and 37F and 37G) generally as connected with the pump 630, can be used to provide water or other fluid for feeding to the pump 630. The water or other fluid can be flowed to or sucked by the pump, which then pumps the fluid into tube portion 636 as shown in FIG. 37. More particularly, as shown in FIG. 37F, the fluid flow may proceed from the reservoir 623 out an outlet 623o (aperture or the like) thereof, into and through a connecting conduit 623f (schematically represented here) to the pump inlet 630i. The pump 630, here a peristaltic pump example moves the flow around the circumference of the pump housing to and out outlet 630o. A connecting flow conduit 630f receives and allows for transmittal of the flow up through the cap 622a to and through outlet aperture 622o for connection to conduit or tube 636. When tube 636 receives a pulse of water from the pump 630 of module 622, it is delivered through the tube 636 that then feeds to and through the nozzle device 640 (described further below). This water or fluid stream or pulse can then spray, as indicated schematically at 700, through or adjacent the oral irrigation assembly 527 as shown for example in FIG. 37F. More details of an exemplar hereof are set forth below.

Note, the schematic representations of conduits 623f and 630f are not intended to be limiting, particularly inasmuch as when in fully assembled state, see e.g., FIG. 37G, a reverse view of the reservoir 623, the schematically shown motor 634 and power pack 638, as represented by the three batteries here, are disposed in the hollow portion 623h of reservoir 623, then the pump 630 would be adjacent the reservoir 623 (not as far away as shown in FIG. 37F), and a mere elbow fitting (not shown) may be used to connect the reservoir outlet 623o with the pump inlet 630i. Note also, also shown in FIG. 37G, are an uncovered fill aperture 623a, and the fluid reservoir area 623r in which the fluid to be pumped is stored. The open area 623h remains dry throughout the use of the irrigation unit 620.

As a further alternative implementation of the present developments, a nozzle device 640 is shown in FIG. 38 (including sub-parts 38A-38G) which here has four water jet nozzles 602a, 602b, 602c and 602d (see more particularly FIGS. 38D and 38E), other alternative numbers also being viable, that are fed initially by the tube 636 (not shown in FIG. 38, but see FIG. 37, described above). As shown most particularly in FIGS. 38A, 38B, 38C, 38F and 38G, the nozzle assemblage 640 includes an inlet portion 604 which is disposed in some implementations on a brush assembly, here assembly 527 (in some implementations, no brushes are used, and/or the nozzles may alternatively be otherwise dissociated from the brush head assembly or assemblies). Assemblage 640 also includes a conduit 606 and a nozzle manifold 601, in which are the nozzles 602a, 602b, 602c and 602d, these latter nozzles being shown more particularly in FIGS. 38D and 38E In use, the inlet portion 604 is communicative with tube 636, where tube 636 receives water or other fluid from the pump module 622 in substantially the fashion as shown and described hereinabove (see e.g., FIG. 37F, though the feed to the nozzle assemblage 640 is not shown in FIG. 38). When supply tube 636 receives a pulse or stream of water from its respective pump 630 of module 622 (see FIG. 37 above), the water or other fluid is delivered up to the base 604 of the nozzle sub-assembly 640, as shown in FIG. 38, where it is then delivered to and fed through the tube 606, and may then be delivered to the water jet nozzles 602a, 602b, 602c and 602d through the manifold portion 601. As shown in FIG. 38, two of the water jet nozzles, i.e. 602a and 602b (see more particularly FIGS. 38D and 38E), would deliver water or other fluid to the one set of teeth, e.g., an upper set of teeth, and the other two water jet nozzles, i.e. 602c and 602d (see more particularly FIGS. 38D and 38E) would deliver water or other fluid to the user's other set of teeth i.e. the lower set of teeth. These water jet nozzles 602a, 602b, 602c and 602d could thus deliver water or other fluid, see spray 700, either substantially simultaneously or non-simultaneously to the user's teeth or other oral features.

In one alternative, either a combination of water jet nozzles 602a, 602b, or a combination of water jet nozzles 602c and 602d could be used independently of the other set of water jet nozzles to provide controlled jet action for top and bottom teeth. In another alternative, either a combination of water jet nozzles 602a, 602c, or a combination of water jet nozzles 602b and 502d could be used independently of the other set of water jet nozzles to provide controlled jet action for inside or outside teeth, with alternation available from the first side to the other side as desired. Thus, an effective implementation using a subset of water jet nozzles is available.

As mentioned above, the irrigation nozzle assemblage 640 may be dissociated and independent from or may be physically connected or related to or coactive with one or more toothbrush assemblies 526, 527. Exemplary brush assemblies for use in alternative implementations like those shown here may be like those disclosed in U.S. patent application Ser. No. 60/385,366, filed Jun. 3, 2002, by the same inventor(s) as the present case. The disclosure of that application Ser. No. 60/385,366 is hereby incorporated herein by reference as if fully set forth here. Brushes like these can be used for brushing the teeth substantially simultaneously with the oral irrigation process, but may also be used to position the water jet nozzles in operative position and guide the nozzles throughout the oral cavity for efficient usage; such positioning and guidance may be enhanced where the nozzle assembly is directly attached to one or another of the brush assemblies 526, 527 (see e.g., the relative connective relationship intimated of nozzle assemblage 640 to brush head 527 as in FIG. 38). Positioning the nozzle device properly relative to the teeth may be provided by one or more brushes themselves that lock around the teeth and correctly position the jets of the nozzle device 640. In such a case, one or more brush heads could then be disposed for brushing the crowns and sides of the teeth, while also providing an irrigation action. The inclusion of one or more brush heads cooperatively arranged with the nozzle device 640 the jets may provide for injection of water adjacent and/or through the bristles during a brushing action. Combining brushing and oral irrigation may provide better simulation or replacement of interproximal brushing, flossing, and/or perio picking and/or using proxy brushes.

One type of pump for this application of providing one or more water jets for oral use may be a peristaltic pump, such as the pump 630 shown in FIG. 37. Peristaltic pumps have also been known in various fields of art, however, the use of peristaltic pumps in oral irrigation devices has apparently heretofore been unknown. Peristaltic pumps operate under the principle that a roller pinches or obstructs a flexible tube filled with fluid and then rolls the pinch or obstruction along the tube to thereby drive fluid through the tube. Commonly, peristaltic pumps are of rotational types. Thus, basically in a peristaltic pump, such as either of pump 630 in FIG. 37 for a more schematic view; a respective single flexible tube may be contained in such a manner that when one or more rollers, not directly shown in FIG. 37, is in rotational contact with the contained portion of the tube, the roller squeezes the tube, and in doing so, any liquid caught within the tube in front of or downstream of the roller may be pushed forward by the roller when the roller is moved in a rotational path. The fluid within the tube is then moved or pumped inside and along the tube until the fluid is delivered to its destination, here e.g., to and through the water jet nozzles 602a, 602b, 602c and 602d. Other alternative pumps may also be used here. For example, though not shown here, an injection pump or other pumping mechanisms not shown could also alternatively be used herein for pumping fluid through the tube 636 to the to one or more 602a-d. The tubes/conduits 636 and 606 may preferably be relatively flexible or resilient at least in a portion of their location between the pump module 622 at or near their respective connection areas between 604 and 601. Note, a one or a two roller pump might be used as described above, particularly if pulsing action is desired; or, in some instances, a three roller pump might be used, particularly if the raceway is about or more than about 240 or 270 degrees, such that a relative continuous obstruction is maintained by one or two rollers at all times; i.e., contact may be maintained by at least one roller always to provide a relatively continuous flow, if desired.

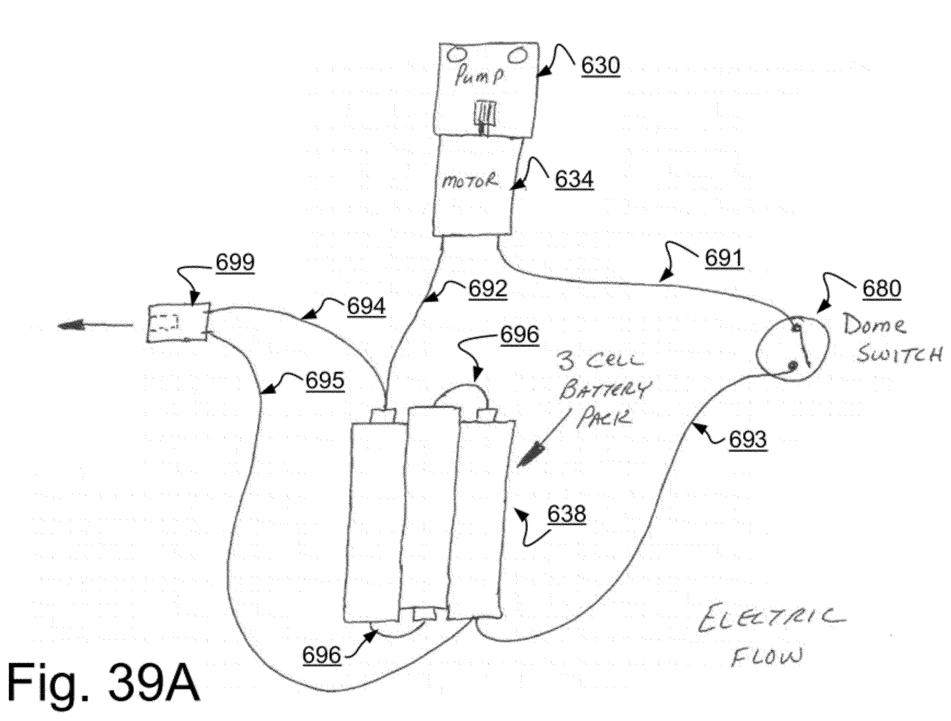

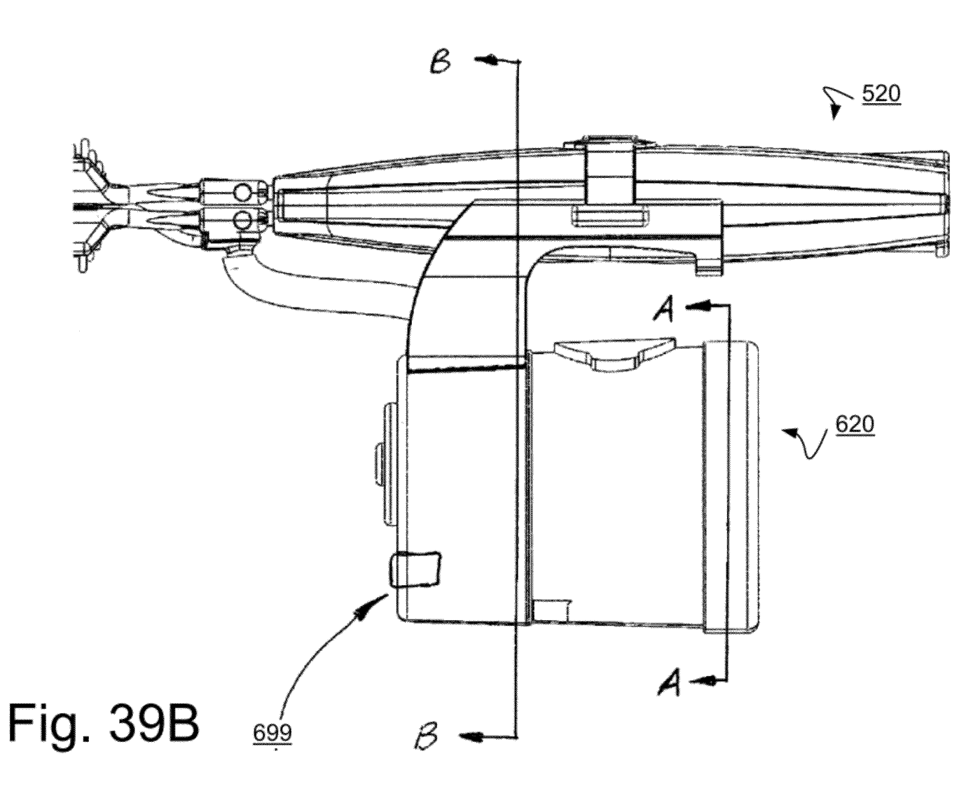

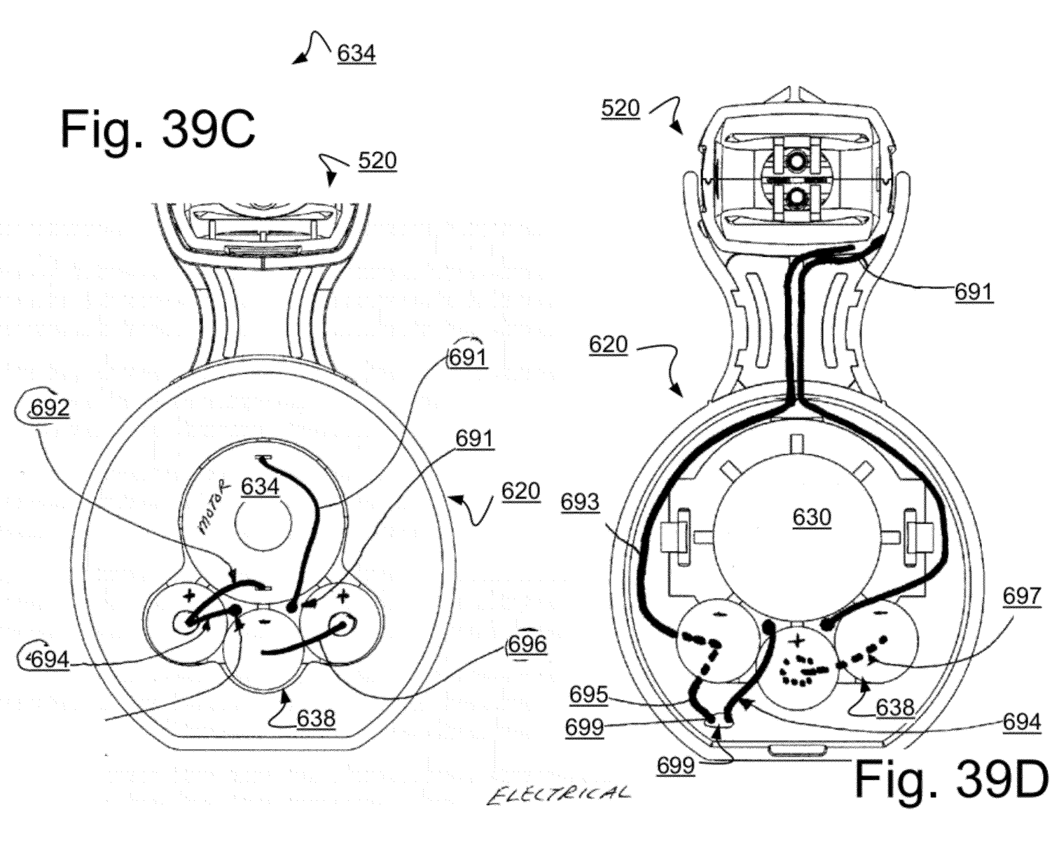

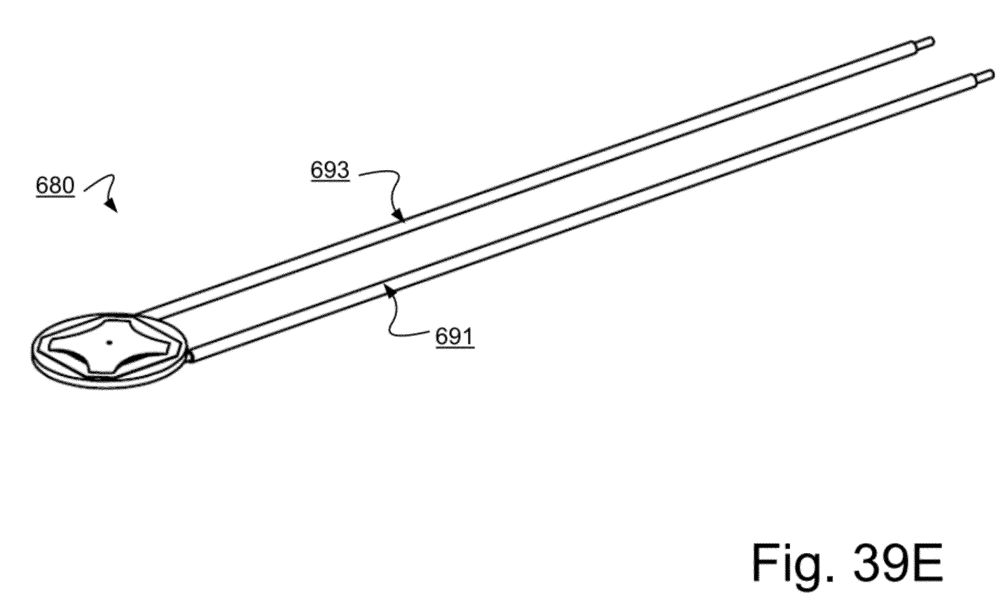

The reservoir 623 may be of a capacity, for example, at or about a 50 milliliter capacity, to allow for a sufficient amount of water or other fluid suitable for a single cleaning of the user's teeth. The pump 630 may be disposed adjacent to the motor 634 and the battery unit 638. The irrigation device 620 may also include within a endcap 622c, a wiring area or repository 701, see e.g., FIG. 39 described here. As shown in FIG. 39, the device 620 may also include a dome switch device 680 within the elastic securing member 580 securing the dome switch to the handle 523 (an exemplar dome switch 680 is also shown for example in FIG. 39E). The dome switch may be of a suitable dimension, such as 30/1000 of an inch, to fit and operate within the device 620. The pressing of the dome switch 680 by the user would close a circuit, illustrated further in FIG. 39A, to allow for user control of the operation of the device 620. The dome switch 680 may be pressed by the user to close the circuit and commence operation of the device 620, and then either released in some implementations, or in a toggle switch situation, re-depressed by the user to toggle open the circuit and cease operation of the device 620. Alternately, the user's pressing of the dome switch 680 may initiate a preprogrammed brushing time, such as, for example, 30 seconds, or any other suitable time for a tooth brushing and irrigating routine.

As shown in more detail in FIG. 39A, the dome switch 680 may be connected to the motor 634, see e.g., wire 691, to allow for turning on or off the motor 634. The motor 634 would then rotate a spindle connected to the pump 630 and thereby cause the pump 630 to rotate (if peristaltic) and thereby pump fluid. The motor and the dome switch would also be connected to the power pack 638, see e.g., wires 692 and 693, an exemplar connection being shown in FIG. 39A. The power pack 638 may optionally also be re-chargeable and/or otherwise connectable to outside power supply as by a DC power jack 699 as shown in FIG. 39A, see e.g., wires 694 and 695. Two wires, 696 and 697, for connecting the batteries of the power pack 638 together are also shown. This wiring is also shown in the cut views of FIGS. 39B, 39C and 39D. An alternative position for a DC power jack 699 is shown in FIG. 39B, as are the two further cut-view locations, lines A-A and B-B of FIG. 39B for FIGS. 39C and 39D respectively. Note, the wires 691 and 694 are routed in the gap between the batteries, wire 691 for connection to the dome switch 680, and wire 694 for connection to the DC jack 699 (see FIGS. 39C and 39D).

As shown in FIG. 39, the electric flow may be commenced by the user closing the circuit by pressing the dome switch 680. The battery assembly 638 would power the motor 634 coupled to the pump 630, and flow the water or fluid through the tubes 636 and 606 to the nozzle device 640 (see FIG. 37). Alternately, a DC power jack 699 could be provided, and plugged into a charger (not shown) as necessary, to provide additional power to the device 620.

Each device may further include a further pump for injecting a flavored dentifrice, medicine or the like into the pulsing jet water stream to enhance the effectiveness of the cleaning and health development and maintenance process.

Further, as introduced above, each device may also include one or more brush heads cooperatively arranged with the nozzle device 640. Different combinations (not shown) may also be had where for one set of brush heads 526 may be reciprocated together and the other set of brush heads 527 may be reciprocated together in opposed relationship to the brush heads 526. Various toothbrush alternatives (powered and stationary) may be included with and without oral irrigation alternatives. In one example, shown generally in FIGS. 37 through 39, a brush and/or irrigation assembly 500 may include a handle 523 and including therealong the two brushing heads 526, 527 spaced in opposing above and below directions away from said central axis. Each of said brush head assemblies 526, 527 may respectively headwise include respective principal crown surface brush bristles and optionally also pairs of laterally opposed brush heads side surface bristles for brushing lingual and bucal surfaces and occlussional surfaces of a row of teeth. In many implementations, the brush head assembly 526 and/or 527 may be provided with conduit means (see e.g., supply conduit 636 from pump module 620) adapted to deliver irrigation water through said one or two or more stationary or longitudinally movable cleaning head assemblies (see below). Water or fluid jet nozzles 602a, 602b, 602c and 602d may thus also be provided for oral irrigation. As introduced, the control handle 520 may in some implementations be provided with powering means (see FIGS. 35, 36, incorporated herein by reference) for providing reciprocating longitudinal movement in synchronization of the nozzle assemblies of ports 602 and/or the brushing head assemblies 526, 527.

An assembly such as this may be adequate for twin cooperative goals of efficaciously brushing the occlusial and lingual-bucal surfaces (including gaps therebetween) while also simultaneously irrigating the aforementioned surfaces and also the underlying teeth gums. An aspect hereof may thus be the provision of improved powered toothbrush augmented with oral irrigation for simultaneously efficaciously brushing the occlusial and the lingual bucal surfaces including any gaps therebetween while simultaneously beneficially irrigating the teeth surfaces and also the underlying teeth gums, the latter benefit representing therapeutic prevention of periodontal problems.

In a first of these alternative implementations, the one or more brush head assemblies 526 and/or 527 may be disposed in substantially stationary relationship relative to the handle 520, and the water jet nozzles 602a, 602b, 602c and 602d may also be stationary. Or, in a next implementation, one or the other or both of the brush head assemblies 526, 527 may be substantially reciprocal and the water jet nozzles 602a, 602b, 602c and 602d may be made substantially stationary. As shown in more detail in FIG. 38, the nozzle device 640 may be fixed to the brush head assembly 527, such that during reciprocal motion of the brush head assemblies 526 and 527 during operation of the apparatus 500 the nozzle device moves with the motion of the brush head assembly 527. The brush heads and bodies may be substantially stationary and may be connected to the handle 520 by structural shafts 522.

In this and various of the other toothbrush examples herein, the brushhead assembly or assemblies 526, 527 may be adapted to receive one or more teeth securely therein, and thereby position the device 500 such that the jet nozzles 602a, 602b, 602c and 602d may be very advantageously aimed at the teeth and/or gums in strategic position to provide maximal cleaning.

In another implementation the jet nozzles 602a, 602b, 602c and 602d may be disposed in a substantially stationary disposition in relation to brush head 527, or brush head 526, and the brush heads 526, 527 made to move in reciprocal in and out fashion. Generically, this would describe a power toothbrush with oral irrigation device 620 of the present developments which may be further described as extending along a longitudinal and in one implementation preferably horizontal central axis and include a rearwardly positioned control handle 520 extending along the central axis; and forwardly positioned of and in longitudinally reciprocatable relationship to said control handle, a cleaning head assembly 526 having at least one brushing head that may be vertically spaced away from a central axis. The brushing head assembly 526 may include, as above, a first set of crown bristles for brushing the occlusial surfaces of a row of teeth and may also include lateral and opposed second and third angularly disposed bristles for brushing lingual and bucal surfaces of the row of teeth that may be interposable between the upright second and third sets of bristles. The control handle 520 may here also be internally or externally provided with powering means for effecting a longitudinally reciprocatable relationship of the at least one brushing head.

More particularly, the powered toothbrush with oral irrigation as hereabove described may be especially adaptable for simultaneously reliably brushing the user's upper row of teeth and the lower row of teeth and whereby there may be on opposite sides vertically from a central axis both an upper and also a lower brushing head assembly 526, 527; wherein the control-handle powering means may be adapted to cause such brushing heads to simultaneously longitudinally reciprocate in opposite directions; and wherein the control-handle conduit means is adapted to simultaneously deliver water into and/or adjacent both said brushing heads via the nozzles 602a, 602b, 602c and 602d.

Thus as shown in the drawings, a representative implementation 500 of the present developments may include a powered toothbrush with oral irrigation and/or a powered oral irrigation device with a toothbrush. This device 500 extends longitudinally (and in one orientation, horizontally) along a central axis and has four main parts including: a rearwardly positioned control-handle 521; at least one forwardly positioned brushing head(s) 526 and/or 527 vertically spaced form the central axis and directionally longitudinally reciprocatably attached to the handle 521. Each such longitudinal reciprocatable brushing head includes bristles for brushing the occlusial surfaces of a row of teeth, and opposed second and/or third sets of bristles for respectively simultaneously brushing lingual and bucal surfaces surrounding the teeth; the control handle 521 being internally or externally provided with power, or an internal battery or batteries, for effecting longitudinal reciprocation of at least one said brush head 526 and/or 527; and the overall device 500 being provided with a conduit or conduits 636 for delivering irrigation water via the nozzles 602a, 602b, 602c and 602d through or proximate to one or both reciprocatable brushing heads 526 and/or 527. Also, when, the water tubes pass through and/or emanate from the brush structure through a hole in or adjacent the brushes, the tube and/or nozzles have enough clearance to issue jets or streams without interacting or otherwise interfering with the brush head reciprocating along the user's tooth and/or gum line.

In the detailed FIGS. 30-39 are shown isometric, side and top plan views of the representative implementation 520. Referring now to these details, a control-handle 520 with two brush head assemblies 526, 527 reciprocably attached thereto. Brush head assemblies 526, 527 can simultaneously brush an upper row of teeth and a lower row of teeth. The brush heads may in one implementation, reciprocate in and out about ¼ inch of movement. The upper brush head and lower brush head may preferably be made to move in opposite directions, i.e., when the upper brush head 526 is moving inward, the lower brush head 527 is moving outward. This is desirable in many implementations because when a user bites into the upper and lower brush heads at the same time, the opposing reciprocatable movement can provide a “balance” so that the power handle does not tend to move in and out as a result of contact with both the upper and lower brush head simultaneously.

From the foregoing, it is readily apparent that new and useful implementations of the present developments have been herein described and illustrated which may fulfill one or numerous desiderata in remarkably unexpected fashions. It is, of course, understood that such modifications, alterations and adaptations as may readily occur to the artisan confronted with this disclosure are intended within the spirit of this disclosure which is limited only by the scope of the claims appended hereto.

What is claimed is:

1. An integrated device for oral care comprising:
an oral cleansing device including a handle, and one or more cleaning head assemblies;
a fluid irrigation assembly attached or attachable to the oral cleansing device to yield a combination integrated oral care device; the fluid irrigation unit comprising:
a fluid source;
a pump having an inlet and an outlet, the inlet fluidly connected to the fluid source;
a nozzle device fluidly connected to the outlet of the pump;
whereby said pump is adapted to take fluid from the fluid source and push said fluid from the pump to and through the nozzle device.

2. A device according to claim 1, in which said oral cleansing device has an arrangement of one or more tooth brushes connected to one or more of the one or more cleaning head assemblies.

3. A device according to claim 2, in which said nozzle device further comprises one or more discrete nozzles, adapted to be disposed between at least two tooth brushes.

4. A device according to claim 3, in which the nozzles are disposed at a discrete angle relative to an oral cavity feature.

5. A device according to claim 3, in which the nozzles are disposed at a discrete angle relative to each other.

6. A device according to claim 4, in which said oral cavity feature is a gum line intersection of a tooth and gums.

7. A device according to claim 1 wherein the nozzle device is connected to one or more of the one or more cleaning head assemblies.

8. A device according to claim 3, in which said arrangement of one or more tooth brushes is linearly movable with said one or more nozzles.

9. A device according to claim 3, in which said arrangement of one or more tooth brushes is linearly movable contrary to said nozzles.

10. A device according to claim 3 wherein there are two cleaning head assemblies, each with at least one brush attached thereto, the two cleaning head assemblies being linearly movable contrary to each other to provide a force balance.

11. A device according to claim 1, wherein the pump module further comprises one or more of a piston pump or a peristaltic pump.

12. A device according to claim 1, wherein the pump module is powered by an integral battery assembly.

13. A device according to claim 3, in which there are four nozzles disposed to dispense fluid through the arrangement of tooth brushes.

14. A fluid irrigation assembly that is attached or attachable to the oral cleansing device having a handle and a cleaning head assembly to yield a combination integrated oral care device; the fluid irrigation unit comprising:
a fluid source;
a pump having an inlet and an outlet, the inlet fluidly connected to the fluid source;
a nozzle device fluidly connected to the outlet of the pump;
whereby said pump is adapted to take fluid from the fluid source and push said fluid from the pump to and through the nozzle device.

15. A device according to claim 14 wherein the fluid source and pump are part of a pump and reservoir module.

16. A device according to claim 14 further comprising a motor and power pack the power pack connected to the motor and the motor connected to the pump.

17. A device according to claim 16 further including a dc connection connected to the power pack.

18. A device according to claim 16, the fluid source having a hollow portion for containing the motor and power pack.

19. A device according to claim 16 wherein the nozzle device is adapted to be connected to a cleaning head assembly of an oral cleansing device.

20. A method for oral care comprising:
obtaining an integrated or combined oral cleaning device including a handle, and one or more cleaning head assemblies and a fluid irrigation assembly attached or attachable to the oral cleaning device;
using the oral cleaning device by inserting in an oral cavity and cleaning an oral feature.
